(19) United States
(12) Patent Application Publication
(10) Pub. No.: US 2026/0359733 A1
(43) Pub. Date: Nov. 12, 2026

(54) APPARATUS AND METHOD FOR CONTROLLING A PLURALITY OF AI MODELS OF AN AI-SYSTEM

(71) Applicant: Rene KIESSIG, Leipzig (DE)

(72) Inventor: Rene KIESSIG, Leipzig (DE)

(21) Appl. No.: 19/201,975

(22) Filed: May 8, 2025

(51) Int. Cl. G06N 20/20

(52) U.S. Cl. CPC G06N 20/20

(57) ABSTRACT

Provided is an apparatus comprising interface circuitry, machine-readable instructions and processing circuitry to execute the machine-readable instructions to receive at least one of sensor data from one or more sensors or computation data from one or more of the plurality of AI models. The plurality of AI models are operated within the AI-system and at least partially utilize shared computing resources of the AI-system. The processing circuitry is further to execute the machine-readable instructions to generate fused data; provide the fused data to the plurality of AI models; generate a plurality of control options for the AI-system based on the fused data; determine an execution order of the plurality of generated control options based on decision data; and adapt a usage of the shared computing resources for an execution of the plurality of AI models based on received computing resource data of the AI-system.

### FIELD

The present disclosure relates to an apparatus and a method, in particular to an apparatus and a method for controlling a plurality of AI models of an AI-system.

### BACKGROUND

Artificial intelligence (AI) systems are increasingly integrated into complex cyber-physical environments such as autonomous vehicles, robots, smart cities, medical platforms and the like. These AI-systems may comprise multiple AI models operating in parallel, each specialized for tasks such as perception, prediction, decision-making, control, or fault detection. A challenge in such AI-systems may be to coordinate the execution of these AI models based on dynamically changing sensor inputs, decision constraints, computing resource availability, and application-specific performance goals. Traditional approaches often treat each AI model as an isolated entity.

Therefore, there is a need for an improved technique for operating a plurality of AI models in an AI-system.

### SUMMARY

An example relates to an apparatus for controlling a plurality of AI models of an AI-system. The apparatus may comprise interface circuitry, machine-readable instructions and processing circuitry to execute the machine-readable instructions to receive at least one of sensor data from one or more sensors or computation data from one or more of the plurality of AI models. The plurality of AI models are operated within the AI-system and at least partially utilize shared computing resources of the AI-system. The processing circuitry is further to execute the machine-readable instructions to generate fused data based on at least one of the received sensor data or computation data. The processing circuitry is further to execute the machine-readable instructions to provide the fused data to the plurality of AI models. The processing circuitry is further to execute the machine-readable instructions to generate a plurality of control options for the AI-system by the plurality of AI models based on the fused data. The processing circuitry is further to execute the machine-readable instructions to determine an execution order of the plurality of generated control options based on decision data. The processing circuitry is further to execute the machine-readable instructions to adapt a usage of the shared computing resources for an execution of the plurality of AI models based on received computing resource data of the AI-system.

An example relates to method for controlling a plurality of AI models of an AI-system. The method comprises receiving at least one of sensor data from one or more sensors or computation data from one or more of the plurality of AI models. The plurality of AI models are operated within the AI-system and at least partially utilize shared computing resources of the AI-system. The method further comprises generating fused data based on at least one of the received sensor data or computation data. The method further comprises providing the fused data to the plurality of AI models. The method further comprises generating a plurality of control options for the AI-system by the plurality of AI models based on the fused data. The method further comprises determining an execution order of the plurality of generated control options based on decision data. The method further comprises adapting a usage of the shared computing resources for an execution of the plurality of AI models based on received computing resource data of the AI-system.

### BRIEF DESCRIPTION OF THE FIGURES

Some examples of apparatuses and/or methods will be described in the following by way of example only, and with reference to the accompanying figures, in which

FIG. 1 illustrates a block diagram of an example of an apparatus for controlling a plurality of AI models of an AI-system or device for controlling a plurality of AI models of an AI-system;

FIG. 2 illustrates an example of the AI-system configured to control a robot as target system;

FIG. 3 illustrates an example of the AI-system configured to control a vehicle as the target system;

FIG. 4 illustrates an example of the AI-system configured to control a medical system as the target system;

FIG. 5 illustrates an example of the AI-system configured to control a smart city as the target system; and

FIG. 6 illustrates a flowchart of an example of a method for controlling a plurality of AI models of an AI-system.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

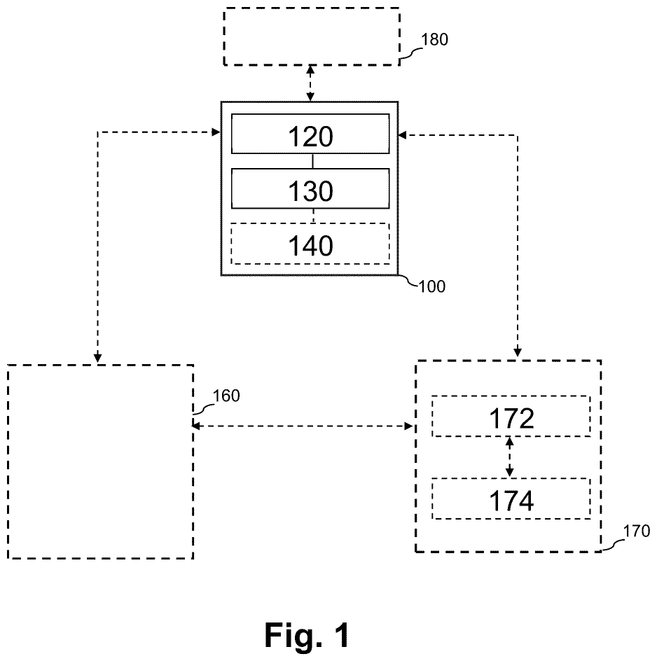

FIG. 1 illustrates a block diagram of an example of an apparatus 100 for controlling a plurality of AI models of an AI-system or device for controlling a plurality of AI models of an AI-system 100. The apparatus 100 comprises circuitry that is configured to provide the functionality of the apparatus 100. For example, the apparatus 100 of FIG. 1 comprises interface circuitry 120, processing circuitry 130 and (optional) storage circuitry 140. For example, the processing circuitry 130 may be coupled with the interface circuitry 120 and optionally with the storage circuitry 140.

For example, the processing circuitry 130 may be configured to provide the functionality of the apparatus 100, in conjunction with the interface circuitry 120. For example, the interface circuitry 120 is configured to exchange information, e.g., with other components inside or outside the apparatus 100 and the storage circuitry 140. Likewise, the device 100 may comprise means that is/are configured to provide the functionality of the device 100.

The components of the device 100 are defined as component means, which may correspond to, or implemented by, the respective structural components of the apparatus 100. For example, the device 100 of FIG. 1 comprises means for processing 130, which may correspond to or be implemented by the processing circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

In general, the functionality of the processing circuitry 130 or means for processing 130 may be implemented by the processing circuitry 130 or means for processing 130 executing ma-chine-readable instructions. Accordingly, any feature ascribed to the processing circuitry 130 or means for processing 130 may be defined by one or more instructions of a plurality of ma-chine-readable instructions. The apparatus 100 or device 100 may comprise the machine-readable instructions, e.g., within the storage circuitry 140 or means for storing information 140.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may comprise circuitry configured to receive and/or transmit information.

For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components. Such hardware components may comprise a general-purpose processor, a Digital Signal Processor (DSP), a micro-controller, etc.

For example, the storage circuitry 140 or means for storing information 140 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage. For example, the storage circuitry 140 may store a (UEFI) BIOS.

The terms “processing circuitry”, “interface circuitry”, and “storage circuitry”′ as used herein are not intended to invoke 35 U.S.C. § 112(f). These terms are intended to broadly cover any suitable combination of hardware, software, firmware, or any combination thereof, configured to perform the respective described functions, without being limited to any specific structure or implementation.

The interface circuitry 120 is configured to receive at least one of sensor data from one or more sensors 160 or computation data from one or more of the plurality of AI models. The plurality of AI models 172 are operated within the AI-system 170 and at least partially utilize shared computing resources 174 of the AI-system 170.

In some examples, the AI-system 170 may be a computational system comprising the plurality of AI models 172 and computing resources 174 that are configured to support the execution of the plurality of AI models 172. In some examples, the computing resources 174 of the AI-system may be hardware and/or software-based system components configured to perform, manage, or support the execution of operations by the plurality of AI models 172. In some examples, the computing resources 174 may comprise one or more processing circuitries such as CPUs, GPUs, or specialized AI accelerators that provide processing circuitry capacity to execute machine learning inference or training tasks. The computing resources of the AI-system 174 may further comprise one or more memory circuitries for temporary or persistent data storage, including RAM, VRAM, or non-volatile memory. The computing resources of the AI-system 174 may comprise communication infrastructure, such as data buses or network interfaces, enabling data transfer between AI models 172 or between the AI-system 170 and other components. For example, the computing resources 174 may also comprise one or more power supply units or energy regulation components used to power sensors, processing circuitries, or actuators of the AI-system 170.

In some examples, the AI-system 170 may be configured to control or influence a target system 180. The target system 180 may be a physical device, a group of cooperating components, or an operational environment. In some examples, the AI-system 170 may be integrated into the target system 180, for example when the AI-system 170 is part of a robot, a vehicle, or a medical apparatus, and the plurality of AI models 172 may generate outputs to directly control internal subsystems such as actuators, motors, sensors, or diagnostic routines. In other examples, the AI-system 170 may be external to the target system 180 and configured to control one or more components or agents distributed within the target system 180, for example in a smart city where traffic lights, autonomous vehicles, surveillance units, infrastructure sensors etc. may be controlled by the AI-system 170. The target system may comprise the one or more sensors.

In some examples, the AI-system 170 comprising the plurality of AI models 172 may be implemented either as a part of the apparatus 100. In some examples, the AI-system 170 comprising the plurality of AI models 172 may be implemented as a system external to the apparatus 100 and operatively connected to the apparatus 100 for example via the interface circuitry 120. When the AI-system 170 is external, communication between the interface circuitry 120 of the apparatus 100 and the AI system may occur through wired or wireless interfaces, such as data buses, network links, or dedicated communication channels. In this case, for example, the AI system may reside on cloud-based platforms, distributed edge computing nodes, or separate embedded controllers or the like.

In some examples, the one or more sensors 160 providing the sensor data may be part of the apparatus 100. In some examples, the one or more sensors 160 providing the sensor data may be part of the AI-system 170. In some examples, the one or more sensors 160 providing the sensor data may be a system external to the apparatus 100, and/or external to the AI-system 170. For example, different sensors of the one or more sensors 160 may be embedded into different external systems and each provide their sensor data to the apparatus 100. For example, if the one or more sensors 160 are embedded in the apparatus 100, the interface circuitry 120 may directly access raw and/or preprocessed sensor data. When the one or more sensors 160 are external to the apparatus 100 the data may be transmitted to the interface circuitry 120 of the apparatus 100 via standard communication interfaces or protocols. In all cases, the interface circuitry 120 may be configured to support compatible protocols and formats to ensure reliable and timely data acquisition from the various sources.

In some examples, to receive at least one of sensor data from one or more sensors or computation data from one or more of the plurality of AI models may refer to the act of acquiring, retrieving, or obtaining the respective data signals or digital values for further processing by the apparatus 100. The act of receiving may be implemented as a data flow, data transfer, or read operation performed by the interface circuitry 120 of the apparatus 100. In some examples, the received data may be in the form of structured or unstructured digital information packets, raw binary streams, time-stamped sensor events, or standardized data frames formatted according to protocol specifications. In some examples, the data may be received from internal components of the apparatus 100, such as from a local memory 140 or directly from embedded sensors or on-board AI models through the interface circuitry 120. In other examples, the data may be received from external sources via the interface circuitry 120, such as from externally located AI models of the AI-system or from external sensors or sensor platforms. The reception process may utilize wired or wireless transmission techniques and may include protocol conversion, synchronization, or buffering. In all cases, the interface circuitry 120 and/or associated software layers may be configured to handle various data types, communication standards, and quality-of-service constraints to ensure robust and timely data intake.

In some examples, the AI-system 170 may be distributed across a hybrid cloud-edge infrastructure. In some examples, at least a subset of the plurality of AI models 172 are operated on a shared local computing resource platform. In some examples, the AI-system 170 may be distributed across a hybrid cloud-edge infrastructure. This may mean that the plurality of AI models 172 are operated across a combination of edge devices (e.g., embedded systems, local controllers, or mobile platforms) and cloud-based platforms (e.g., remote servers, cloud data centers). In such configurations, at least a subset of the AI models 172 may be executed locally within the apparatus 100 or a co-located edge unit, thereby utilizing the shared computing resources 174 as previously described. These local AI models may share processing circuitry capacity, memory, communication interfaces, and power supply units, and may be subject to resource adaptation mechanisms described herein. Additional AI models, which may be less latency-sensitive or used for background analysis, may be operated remotely in the cloud. These cloud-executed AI models may be communicatively linked to the apparatus 100 via the interface circuitry 120, for example through wireless or networked channels. The hybrid setup may enable flexible partitioning of AI workloads, where time-critical decision-making occurs on shared local computing resources, while high-capacity or data-intensive tasks are offloaded to the cloud.

The computing resources 174 of the AI-system are at least partially shared among the plurality of AI models 172. In some examples, the shared computing resources 174 of the AI system may be computing resources of the AI-system that are accessible by two or more of the plurality of AI models 172 to support their concurrent or coordinated execution. In some examples, the computing resources 174 of the AI-system may be shared among the plurality of AI models 172 in a manner that allows multiple AI models 172 to access, utilize, or compete for the same underlying hardware or software components during their operation. Such shared usage may enable efficient allocation of system capacity, dynamic resource balancing, or coordinated model execution, particularly in scenarios where computational constraints or task prioritization require adaptive resource management.

In some examples, the shared computing resources comprise at least one of the following resources: processing circuitry capacity of one or more processing circuitries of the AI-system, memory usage of one or more memories of the AI-system, usage of one or more data bus and communication interfaces of the AI-system, or power supply of AI-system components. In some examples, the processing circuitry capacity of one or more CPUs, GPUs, or AI accelerators may be shared among the plurality of AI models 172, such that the AI models execute their respective operations using the same processing units either in parallel on separate cores or in a time-sliced manner. For instance, a reinforcement learning model and a perception model may both utilize an AI accelerator to run their respective neural networks, with the accelerator handling alternating inference passes under the control of a shared execution schedule. Further, memory usage may be shared by allowing multiple AI models 172 to read from or write to common regions of temporary or persistent data storage, such as for storing shared input data, temporary results, or serialized model parameters. In some examples, the communication infrastructure comprising data buses or network interfaces may be shared by the plurality of AI models to transfer intermediate results, control signals, or sensor information between AI-models 172 or to external components. For example, a manipulation model and a control optimization model may both utilize the same internal data bus to exchange state vectors and torque commands. Further, the power supply units or energy regulation circuits may likewise be shared, with multiple AI models 172 relying on a common power infrastructure for energizing their associated processing circuitries, memory, or actuators. This shared use of energy resources may support coordinated load balancing or prioritized energy allocation under power-limited conditions.

In some examples, the shared computing resources 174 of the AI-system 170 may be managed by the circuitry 130 that monitors the current utilization, availability, and operational priorities of the hardware and software resources of the shared computing resources 174 of the AI-system 170. The management may involve evaluating the execution requirements of the plurality of AI models 172, such as computational complexity, latency sensitivity, or model priority, and scheduling the allocation of processing circuitry capacity, memory usage, data bus bandwidth, or power supply accordingly. In some examples, the control mechanism may operate dynamically, allowing the adaptation, for example redistribution or reassignment, of shared computing resources in response to changes in task loads, environmental inputs, or execution deadlines (see below). This may ensure that critical or high-priority AI models receive sufficient resources while optimizing the overall efficiency of the AI-system 170.

In some examples, the allocation of the shared computing resources 174 may be based on an evaluation of computing resource data associated with the AI-system 170, which may include real-time information such as processing circuitry load, memory availability, bus contention levels, or energy consumption states. Based on this computing resource data, the control mechanism may assign or throttle processing power, distribute memory buffers, regulate access to communication channels, or balance power usage across active AI models. By continuously adapting the allocation scheme based on up-to-date computing resource data, the AI-system may maintain stable operation under varying workloads and dynamically adapt to internal or external changes.

In some examples, adapting the usage of the shared computing resources may also comprise dynamically adjusting resource domains that are shared between the AI-system 170 and the target system 180. For instance, when the AI-system 170 is integrated within a vehicle or robot, the power supply infrastructure may be jointly utilized by AI models executing on embedded processors and by actuators or sensors of the target system 180. In such cases, the processing circuitry 130 may regulate the distribution of power across both AI-system components and target system elements, such as electric motors, braking units, steering actuators, or robotic joints, based on the computing resource data of the AI-system. This coordinated adaptation ensures that critical AI model operations receive sufficient computational resources while also maintaining safe and efficient actuation of the target system under dynamic resource constraints. For example, when battery state or overall system load is limited, power allocation to certain actuators may be reduced to reserve energy for high-priority AI inference tasks, or vice versa, allowing for balanced performance between computation and physical interaction. This extension of resource adaptation reflects the tightly coupled nature of control and computation in modern embedded AI-systems operating in resource-constrained environments.

In some examples, an AI model of the plurality of AI models may be a computational model configured to process input data and generate outputs based on learned or programmed relationships, using machine learning (also referred to artificial intelligence) techniques. An AI model of the plurality of AI models may perform a specific function within the AI-system of multiple AI-models, and may be implemented in software, hardware, or a combination thereof. The AI-models may have different architectures. In some examples, an architecture of an AI model of the plurality of AI models may refer to the structural and computational design of the AI model, including the organization of its internal components such as layers, activation functions, connectivity patterns, and the flow of data and gradients during inference and training. The architecture may determine the AI model's capacity to learn, generalize, adapt, and perform specific tasks, and may be selected or optimized based on application requirements such as accuracy, latency, energy efficiency, or interpretability. The architecture may also define how the AI model interfaces with sensor data, other models, or shared computing resources, and how it manages internal memory or attention mechanisms. In some examples, the architecture of the AI model may include various well-known structures. For example, for visual perception and sensor fusion, a Convolutional Neural Network (CNN) architecture may be used. For example, for sequential data and temporal reasoning, architectures such as Recurrent Neural Networks (RNNs) or Long Short-Term Memory (LSTM) models may be applied. For example, for multimodal processing or hierarchical attention, Transformer-based architectures may be utilized. For example, in graph-structured environments or systems with interdependent components, Graph Neural Networks (GNNs) or Graph Attention Networks (GATs) may be used. For example, in low-power or neuromorphic systems, Spiking Neural Networks (SNNs) may offer biologically inspired, event-driven processing. For example, for optimization tasks under complex constraints, models employing Quantum-Inspired or Quantum-Assisted Optimization architectures may be implemented. For example, Neural Evolution architectures may be applied to dynamically adapt model topologies over time through evolutionary strategies. In some examples, the architectures mentioned—such as Convolutional Neural Networks, Recurrent Neural Networks, Transformer models, Graph Neural Networks, Spiking Neural Networks, Neural Evolution architectures, or Quantum-Assisted models-may also be applied beyond the exemplary use cases outlined.

In some examples, the AI-system may also support the integration of future artificial intelligence (AI) architectures, including but not limited to liquid-state machines, evolvable neural networks, or biologically inspired network models that extend beyond currently prevalent neural network structures.

In some examples, the AI models of the plurality of AI models may be configured through a training process in which model parameters are optimized to perform a specific computational task. The training may involve supervised learning, unsupervised learning, reinforcement learning, or hybrid approaches depending on the architecture and application domain. For example, Convolutional Neural Networks may be trained using labeled datasets of images through backpropagation and gradient descent methods. Recurrent Neural Networks or Transformer architectures may be trained on sequential or time-series data, such as sensor streams or language inputs, using large corpora and attention mechanisms. Reinforcement learning models may be trained through interaction with a simulated or real environment, optimizing behavior over time based on reward signals. Graph Neural Networks may be trained using graph-structured datasets with node- or edge-specific objectives, while Neural Evolution approaches may iteratively evolve model structures without gradient-based optimization. The training process may occur offline during a model development phase or online as part of a continuous adaptation mechanism integrated within the AI-system.

In some examples, the AI models may be trained and deployed for tasks across a wide range of domains. In the context of robotics, AI models may perform object recognition, trajectory planning, or grasp optimization based on multimodal sensor data. In autonomous vehicles, AI models may handle lane detection, obstacle avoidance, path prediction, or vehicle control under real-time constraints. Within smart city infrastructures, AI models may coordinate public transport, optimize energy distribution, or process surveillance data for situational awareness. In medical technology, AI models may perform diagnostic classification from imaging or biosignal data, monitor patient conditions in real time, or recommend personalized therapy plans. These examples illustrate that the AI models of the AI-system may be adapted to various complex environments, each characterized by distinct input modalities, operational goals, and constraints on computing resources (also see below).

In some examples, the computation data from the one or more of the plurality of AI models may be information generated by the execution of the one or more AI models of the AI-system. This information may represent intermediate or final outputs, predictions, decision proposals, feature representations, and/or statistical evaluations resulting from internal AI-model computations. In some examples, the computation data may comprise class probabilities generated by a visual classification model such as a CNN. In some examples, the computation data may comprise predicted trajectories or positional estimates output by a Recurrent Neural Network or LSTM-based navigation model. In some examples, the computation data may comprise semantic segmentation masks, object bounding boxes, or depth estimations produced by Transformer-based sensor fusion models. In some examples, the computation data may comprise control signals or reinforcement feedback values generated by a reinforcement learning model. In some examples, the computation data may comprise node embeddings, relational weights, or graph-level scores obtained from a Graph Neural Network. In some examples, the computation data may comprise dynamic connectivity parameters or evolved hyperparameters produced by a Neural Evolution model. It may include optimization results generated by a Quantum-Assisted Optimization model. In some examples, the computation data be structured in various data formats, including tensors, vectors, matrices, lists, or graphs. In some examples, the computation data may be used for subsequent decision-making, coordination between models, or feedback for learning and adaptation. Depending on the application scenario, such as robotics, autonomous driving, medical systems, or smart city infrastructure, the computation data may be tailored to task-specific inference outputs. For example, the computation data may represent object grasp points, braking decisions, energy load predictions, or diagnostic risk scores.

In some examples, if a primary inference path fails or confidence drops below threshold, a fallback microservice may be triggered via token-authenticated REST call. This may guarantee fail-safe decision chains.

In some examples, the sensor data may refer to any form of data generated by the one or more sensors. In some examples, sensor data may refer to one or more data signals, data packets, or data streams representing physical measurements or observations that are captured or generated by one or more sensors and made available for further processing by one or more components of the apparatus. The sensor data may comprise raw, partially processed, or fully preprocessed information depending on the capabilities of the sensing unit or the upstream signal processing chain. For example, the sensor data may include uncompressed or encoded image data, point clouds, amplitude values, temperature readings, vibration waveforms, or binary signals indicating discrete events. The sensor data may be represented in a variety of formats such as digital numerical values, multidimensional matrices, time-stamped logs, feature vectors, compressed bitstreams, or structured protocol messages. In some examples, the sensor data may be formatted as arrays, tensors, or serialized payloads compatible with hardware drivers or AI model input specifications. The data may further be annotated with metadata including sensor identity, measurement accuracy, units, or timestamp information to support temporal alignment, calibration, or quality assessment.

For example, the one or more sensors may comprise, a camera, a LIDAR unit, a radar sensor, or a temperature sensor or the like. These sensors may be integrated into the apparatus, attached externally, or operatively connected via a network interface. In some examples, the sensor data comprises at least one of camera data, Light Detection and Ranging (LIDAR) data, radar signals, or temperature sensor data. In some examples, camera data may refer to digital image or video data captured by one or more optical cameras, which may include RGB cameras, infrared cameras, or depth cameras. The camera data may comprise pixel arrays representing visual scenes, intensity maps, or motion vectors, and may be encoded in formats such as JPEG, RAW, or video streams. This data may be used for perception tasks such as object recognition, tracking, or scene understanding.

In some examples, LIDAR data may refer to distance measurements captured by a LIDAR sensor, often represented as a point cloud. The point cloud may encode three-dimensional spatial information about surrounding objects and surfaces and may include reflectivity or intensity values. The LIDAR data may be structured as 3D coordinate lists, depth images, or voxel grids, and may be used for mapping, localization, or obstacle detection. In some examples, radar signals may refer to measurements derived from radio-frequency electromagnetic waves emitted and reflected by a radar sensor. The radar signals may include data such as range, velocity, and angle of detected objects, often used in low-visibility environments or for motion estimation. The data may be expressed as raw echo signals, Doppler profiles, or object-level abstractions derived from signal processing algorithms. In some examples, temperature sensor data may refer to analog or digital readings from temperature sensing components such as thermocouples, thermistors, or infrared sensors. The temperature sensor data may be used to monitor the thermal state of system components, surrounding environments, or biological tissue, and may be expressed in absolute temperature units or in differential thermal maps. This data may be used to trigger thermal management, adjust AI model behavior, or enhance multimodal perception.

The processing circuitry 130 is further configured to generate fused data based on at least one of the received sensor data or computation data. In some examples, generating fused data comprise combining two or more heterogeneous or homogeneous data inputs to form a unified or enriched data representation. In some examples, the fused data may be generated based on a combination of sensor data from two or more sensors. In some examples, the fused data may be generated based on computation data two or more AI models. In some examples, the fused data may be generated based on a combination of sensor data and computation data. The fusion may thereby integrate raw sensor measurements, preprocessed feature maps, intermediate model outputs, or symbolic predictions, depending on the system configuration and data availability. The fusion may be performed by the processing circuitry 130 based on algorithmic, statistical, or learned methods. In some examples, fusion techniques may include statistical data fusion, weighted averaging, Kalman filtering, rule-based integration, or neural network-based fusion architectures (see below). For example, a CNN may fuse RGB camera input and depth information to produce a spatial representation of a scene. For example, a transformer-based model may fuse a time series of sensor observations and model outputs for temporal forecasting. For example, a graph-based structure may combine multiple heterogeneous signals, such as sensor nodes and AI-generated features, into a unified graph representation used for downstream decision-making.

The processing circuitry 130 is further configured to provide the fused data to the plurality of AI models. In some examples, providing the fused data to the plurality of AI models may comprise a data distribution operation in which the processing circuitry 130 makes the fused data accessible to one or more of the AI models for further computational processing, for example via the interface circuitry 120. The fused data may be formatted, preprocessed, and routed such that it complies with the input requirements of each of the receiving AI models 172. For example, the fused data may be received and distributed by the AI-system 170 and each of the AI models 172 through the shared computing resources 174 such as shared memory, internal data buses, inter-process communication, or transmission over wired or wireless interfaces.

For example, if the plurality of AI models 172 may be implemented as a system external to the apparatus 100, the fused data may be packetized and transmitted via network protocols or through serialization mechanisms. In some examples, each AI model may receive a full or partial subset of the fused data depending on its processing role or task specialization. In some examples, an AI model may receive the fused data as structured input in the form of tensors, sequences, graphs, or other machine-readable formats that are aligned with the internal data representation of the AI model architecture. For example, a perception model may receive fused spatial sensor data as a dense tensor, whereas a decision-making model may receive a structured feature vector derived from sensor and computation fusion. In some configurations, fused data may include outputs previously generated by one or more AI models, which are then combined with sensor data or outputs of other models to create new fused data representations. This enables recursive or iterative data flow, where AI model outputs are re-integrated into the processing pipeline to refine predictions, enhance contextual understanding, or enable coordination across AI modules. For example, the output of a localization model may be fused with real-time sensor input and then re-fed into a trajectory planning model.

The processing circuitry 130 is further configured to generate a plurality of control options for the AI-system by the plurality of AI models based on the fused data. In some examples, a control option may be a proposed control command generated by one or more of the plurality of AI models 172 for controlling the target system 180 or a part of the target system 180. For example, a control option may be a proposed control command influencing the operational state, behavior, or configuration of the target system 180. A control option may be generated by an AI-model 172 which received the fused data as input and generates the control option as described above. In some examples, a control option may be a fully defined and executable control command that is ready to be transmitted to the target system 180. In other examples, a control option may be a higher-level directive proposed control command that requires further computation by one or more of the plurality of AI models 172 before a control signal can be generated and executed by the target system 180. For example, a control option may be a trajectory plan for a robot, a throttle adjustment for a vehicle, a power-saving mode for a medical device, or a signal pattern for a traffic light system of a smart city. For example, a control option may suggest initiating an evasive maneuver, but the detailed trajectory planning and motor control sequencing may be performed only after this control option has been selected for execution. A control option may be provided as a discrete control command or a parametrized control signal, and may be formatted to be interpretable by actuators or controllers of the target system 180 operatively connected to the AI-system 170. In some examples, the plurality of control options may be generated by the plurality of AI models 172, each of which may specialize in a different function or domain within the AI-system 170. The plurality of control options may include complementary, redundant, or even conflicting proposed control commands for influencing the target system 180. For example, one AI model may prioritize energy efficiency, while another may optimize for responsiveness or safety, resulting in different or opposing control suggestions for the same component or scenario. The generation of a plurality of control options may enable downstream processes to assess trade-offs, resolve conflicts, or determine an optimal or prioritized execution path.

The processing circuitry 130 is further configured to determine an execution order of the plurality of generated control options based on decision data. In some examples, the execution order of the plurality of control options may define a temporal or logical sequence in which the generated control options are to be executed by the AI-system 170 and/or by the target system 180 controlled by the AI-system 170. The execution order may resolve conflicts, redundancies, and/or interdependencies between concurrently proposed control options and may determine which control options are to be executed immediately, delayed, omitted, or composed with others. The execution order may serve either to trigger the direct transmission of already fully formed control commands of the control options to the target system 180, or to initiate further processing by one or more of the plurality of AI models 172 in order to transform an abstract or preliminary control option into a detailed control command. For example, an AI model may propose a control option indicating that an evasive maneuver should be performed, and after this control option is selected for execution, the same or another AI model may compute a precise driving trajectory, motor control sequence, or actuator command sequence. In other cases, the control options may already include such low-level execution data and the execution order may determine the order in which these actions are performed by the target system 180 or subsystems thereof.

In some examples, the decision data may be input data for the processing circuitry 130 used to evaluate the plurality of generated control options in order to determine an execution order for those control options. The decision data may serve as a contextual basis for determining the execution order of the plurality of generated control options. The processing circuitry 130 may utilize the decision data to assess which of the control options should be executed first, which may be delayed, and which may be discarded or re-evaluated. The evaluation may consider environmental or system-specific factors, resource constraints, learned behavior patterns, or a combination thereof. The decision data may reflect the current state of the target system 180, environmental context, available computational resources, and/or historical performance of the AI-system 170.

In some examples, determining the execution order based on the decision data may comprise evaluating each control option against one or more criteria derived from the decision data. These criteria may include, for example, the estimated effectiveness, risk level, timing requirements, resource feasibility associated with executing a given control option, the expected utility, safety, efficiency, or goal-alignment of each control option under the given circumstances. For example, a robotic control system may prioritize a control option that requires less actuator energy if the battery level is low, or a vehicle control system may prioritize a braking maneuver over acceleration if obstacle proximity is detected. In another example, a smart city infrastructure controller may elevate a traffic signal override over scheduled routines during emergency conditions inferred from sensor data.

The processing circuitry 130 may apply deterministic or probabilistic selection strategies to determine the execution order. These strategies may comprise rule-based scoring systems, decision trees, cost-benefit analysis engines, priority queues, or predictive modeling. In some examples, adaptive techniques such as reinforcement learning models may be employed to learn prioritization strategies over time, while in other examples, probabilistic inference methods such as Bayesian networks may be used to evaluate the relative likelihood of success or failure of each control option under uncertain or incomplete information. This may enable the apparatus 100 to determine a dynamic, context-sensitive execution order for the plurality of control options.

In some examples, the decision data may comprise at least one of the following data: sensor data, computing resource data, historical data from plurality of AI models or predetermined preference data. Sensor data may be data from the one or more sensors 160. For example, the sensor data may be real-time measurements from the one or more sensors 160. In some examples, the sensor data may provide real-time or near-real-time measurements from the one or more sensors 160, representing the external or internal state of the target system or its operational environment. Sensor data may include, for example, proximity measurements, temperature readings, visual input, radar signals, or LIDAR profiles. The processing circuitry 130 may determine the execution order by correlating the content of each control option with the sensor data. For instance, if sensor data indicates the presence of a nearby obstacle, a control option that initiates braking may be prioritized over one proposing acceleration. In another example, sensor data indicating overheating of a system component may trigger prioritization of cooling-related commands.

In some examples, the computing resource data may represent the current status of the shared computing resources within the AI-system. For example, the current status of the shared computing resources within the AI-system indicates the availability, status, or load profile of the shared computing resources within the AI-system. The computing resource data may comprise an available processing power, a current computational load, a memory usage, latency, a sampling rate of a sensor of the AI-system, a data processing rate, a sensor utilization rate, or an energy consumption of an AI-system component. Based on the computing resource data, the processing circuitry 130 may prioritize control options that can be executed within the existing resource limits. For example, if computational resources are limited, a less complex control option with lower memory and processing requirements may be prioritized. Alternatively, a control option with real-time constraints may be prioritized even under resource scarcity if its successful execution is time-critical.

In some examples, the historical data from the plurality of AI models may comprise logs, performance metrics, previous decision outcomes, or reinforcement learning feedback associated with earlier control decisions. The processing circuitry 130 may determine the execution order by evaluating how similar control options have performed under comparable conditions in the past. For example, if a particular trajectory-planning strategy has previously led to successful collision avoidance in similar scenarios, the corresponding control option may be elevated in the execution order. Historical data may also include long-term objectives, model confidence levels, or trends in success and failure patterns.

In some examples, the decision data may further comprise predetermined preference data. The predetermined preference data may include fixed prioritization rules, configuration profiles, or system-specific policies that define preferred behaviors, response patterns, or control priorities under certain conditions. This data may be set by a system designer, administrator, or user in advance and may serve as a weighting or constraint input in the determination of the execution order. For example, a safety-critical control option may always be prioritized over performance-optimizing commands. In another example, an emergency override policy may stipulate that all current control options be suspended in favor of a predefined shutdown or alert response.

In some examples, two or more of the aforementioned types of decision data may be combined to derive a more holistic evaluation. For example, a control option may be prioritized if historical data supports its effectiveness, sensor data confirms its relevance to the current situation, and computing resource data indicates that its execution is feasible without overloading the system. In another example, a dynamic trade-off may be computed where sensor urgency overrides resource constraints, or where long-term learning-based optimization outweighs short-term gain. This integrated approach allows the apparatus to determine a context-sensitive and resource-aware execution order for complex environments involving multiple AI models and competing control objectives.

As explained above, the decision data may be further used to derive one or more criteria against which each control option is evaluated in order to determine the execution order.

The processing circuitry 130 is further configured to adapt a usage of the shared computing resources for an execution of the plurality of AI models based on received computing resource data of the AI-system. In some examples, the computing resource data of the AI-system may refer to information that describes the internal resource state of the AI-system 170 at a given point in time. The computing resource data may be continuously monitored or sampled at predefined intervals, and may be used by the apparatus 100 to make informed decisions regarding how shared computing resources are allocated among the plurality of AI models.

In some examples, to adapt the usage of the shared computing resources may refer to a dynamic modification of hardware and/or software-based computing infrastructure within the AI-system 170 that is at least partially shared among the plurality of AI models 172 based on the computing resource data received from within the AI-system 170. The received computing resource data may reflect the current state of resource utilization, such as available processing capacity, memory load, interface congestion, or energy consumption metrics. By analyzing this computing resource data, the processing circuitry 130 may adjust the resource allocation strategy to optimize performance, maintain stability, or fulfill predefined operational goals, such as maintaining real-time response, maximizing energy efficiency, or safeguarding critical operations.

In some examples, adapting the usage of the shared computing resources may further comprise adapting computing resources that are shared between the AI-system 170 and the target system 180, such as a common power supply infrastructure. In configurations where the AI-system and the target system operate on a shared energy source or a unified power distribution network, the computing resource data may include information describing power demands, consumption trends, or load profiles of both AI models and target system components. For instance, in robotic platforms, the power required by AI accelerators executing control models may compete with the power needed to actuate motors or operate end-effectors. Similarly, in vehicular applications, a shared battery system may be used to supply energy to both the AI-system's inference engines and the drivetrain or braking components of the vehicle. Based on this data, the processing circuitry 130 may adapt power allocation strategies by throttling or rescheduling energy-intensive AI models when actuator loads peak, or by prioritizing AI processing when mechanical subsystems are idle. This adaptive coordination enables dynamic trade-offs between computational performance and mechanical responsiveness, ensuring safe and efficient operation under variable energy constraints. In some examples, the processing circuitry 130 may temporarily reduce the processing frequency of non-critical AI models, lower voltage levels of inactive cores, or suspend background learning tasks in response to increased energy demand from the target system's actuators, as indicated by the received computing resource data.

The processing circuitry 130 may evaluate the computing resource data to determine whether current resource allocations are optimal or require adjustment. In some examples, adapting the usage of the shared computing resources may comprise dynamically adjusting the processing circuitry capacity allocated to different AI models based on their current execution demands and the available processing power indicated in the computing resource data. For instance, more computationally intensive models may receive greater CPU or accelerator access when required, while lightweight or background models may be throttled. Similarly, memory buffers may be reassigned in response to observed memory usage fluctuations, allowing models with growing data queues or expanded temporary storage needs to continue processing without interruption. In another example, data buses or communication interfaces may be prioritized or rate-limited based on measured data transfer rates or contention levels. Additionally, power supply units may adapt energy distribution according to sensor utilization rates or energy consumption profiles provided in the computing resource data, such as by downscaling power to non-critical components during peak load.

By continuously referencing up-to-date computing resource data, the system may iteratively refine its allocation and scheduling of shared computing resources, thereby optimizing the performance, responsiveness, and energy efficiency of the AI-system 170. For example, if computing resource data indicates low sampling rates on peripheral sensors and minimal memory consumption by certain AI models, resources may be reassigned to prioritize high-resolution data processing or real-time decision-making for critical control options. Conversely, during periods of heavy load or constrained energy budgets, adaptation may involve disabling low-priority models or consolidating processes to reduce resource overhead.

In some examples, the computing resource data comprises at least one of available processing power, current computational load, memory usage, latency, a sampling rate of a sensor of the AI-system, a data processing rate, a sensor utilization rate, or an energy consumption of an AI-system component. In some examples, available processing power may refer to the remaining or unallocated processing capacity of one or more processing circuitries of the AI-system 170, such as CPUs, GPUs, or AI accelerators. For instance, if the available processing power of a GPU falls below a certain threshold, the processing circuitry 130 may defer or reschedule a non-critical AI model task to avoid overloading. In such cases, the usage of shared processing circuitry capacity may be adapted by prioritizing real-time inference models over background learning models.

In some examples, current computational load may denote the degree to which the AI-system's 170 processing circuitries are actively engaged in executing tasks, which may include utilization percentages, thread occupancy, or task queue length. If the computational load is high, execution of lower-priority AI models 172 may be throttled or paused, thus adapting the processing circuitry usage of the shared computing resources.

In some examples, memory usage may refer to the extent to which the memory of the AI-system 170 is occupied by active processes, intermediate data, or model parameters. Memory usage may be monitored to prevent overflows or swapping delays. When memory usage is elevated, the processing circuitry 130 may adapt memory allocation policies, for example by offloading or compressing data used by lower-importance AI models, or by limiting buffer sizes for less urgent computations.

In some examples, latency may indicate a delay between a request and a response within a component or communication path of the AI-system 170. Increased latency may suggest congestion in the data buses or communication interfaces, which are part of the shared computing resources. To address this, the processing circuitry 130 may reprioritize communication for critical AI models or reduce inter-model data transfers.

In some examples, the sampling rate of a sensor of the AI-system 170 may be included in the computing resource data. The sampling rate may be adjusted to reduce computation frequency and conserve processing circuitry or memory resources. For example, if available processing circuitry capacity is limited, the sampling rate of a low-priority environmental sensor may be reduced.

In some examples, the data processing rate may describe the speed at which input data is ingested and transformed by the AI-system 170. When the data processing rate slows down due to high memory or compute usage, the processing circuitry 130 may temporarily disable non-critical data processing tasks or reduce the resolution of processed data to adapt memory usage or processing circuitry workload.

In some examples, the sensor utilization rate may represent the proportion of time a sensor is actively producing data that is being processed by AI models. A high sensor utilization rate combined with low available computing capacity may trigger an adaptation such as pausing or downscaling the use of that sensor's data.

In some examples, energy consumption of an AI-system component may be used to infer battery status, overheating risks, or power supply limitations. If energy consumption is high, the processing circuitry 130 may disable or reduce the activity of AI models requiring high computational throughput, reallocate execution to more energy-efficient cores, or reduce power-hungry communication tasks over the shared data bus.

In some examples, a operation sequence of the apparatus 100 may comprise one or more of the following steps: receiving sensor data, for example camera images, LIDAR point clouds, and temperature measurements; fusing the sensor data using an adaptive filter or a Graph Neural Network (GNN); generating a plurality of control options based on the fused data using at least one of the AI models; selecting one or more control options based on decision data using a reinforcement learning model; and adapting the usage of the shared computing resources by dynamically assigning processor cores or memory regions based on current resource data of the AI-system.

The above described technique provides a flexible and adaptive mechanism for controlling the plurality of AI models 172 within an AI-system 170, by enabling the reception and fusion of heterogeneous data sources, such as sensor data and AI model computation data, and using the fused data to derive multiple control options. Through the provision of a structured execution order based on decision data the apparatus 100 enables a coordinated and context-sensitive control flow among the AI models. This allows for more robust, goal-aligned decision making and can resolve conflicting or redundant control options from independently operating AI models in real time. The above described technique further enables efficient utilization of limited computational resources in complex AI-driven environments by incorporating adaptive control over the shared computing resources of the AI-system based on real-time computing resource data. The apparatus can dynamically allocate processing power, memory, communication bandwidth, or energy to AI models based on their task relevance, urgency, or performance demands. This not only enhances the scalability and responsiveness of the AI-system under fluctuating workloads, but also allows for the deployment of AI-controlled apparatuses in constrained settings such as mobile robotics, autonomous vehicles, or embedded medical systems, where efficient resource management is crucial for reliable and energy-aware operation.

### Execution Order

Coming back to determining the execution order. In some examples, determining the execution order of the plurality of control options may comprise determining a probability of future events based on the decision data. The probability of future events may be a criterium derived from the decision data and may represent a quantified likelihood that a specific event or condition will occur during or after the potential execution of a control option. In some examples, a future event may be an anticipated occurrence, condition, or system state that has not yet been realized at the time the execution order is determined but may influence the outcome, safety, efficiency, or success of executing a given control option. In some examples, the probability of future events may be a criterium derived from the decision data and may represent a quantified likelihood that a specific event or condition will occur during or after the potential execution of a control option. The probability of future events may be determined by the processing circuitry 130 using statistical inference models, predictive machine learning algorithms, temporal data analysis, or pattern recognition techniques. Once determined, the probability values may be associated with each control option to estimate which control options are more or less likely to result in beneficial, neutral, or adverse outcomes. The probability of a future event may thus serve as a predictive utility metric that feeds directly into the prioritization used to determine the execution order of the control options.

In some examples, the processing circuitry 130 may use the computed probability of future events to prioritize control options associated with lower-risk, higher-success, or mission-critical outcomes. For example, if the probability of a collision is high under a control option that maintains a current trajectory, and the probability of successful avoidance is higher under an alternative trajectory, the latter control option may be ranked earlier in the execution order. In another example, if a future event such as system overheating is predicted with a high probability following execution of a high-performance computation task, then control options that reduce load or switch to energy-saving modes may be elevated in priority. The execution order may therefore be determined by a forward-looking evaluation of the likely consequences of the control options, as inferred through the probability of future events derived from the decision data. This enables the circuitry 130 to behave in a risk-aware, predictive manner, and to dynamically determine and execute control options that are best aligned with favorable operational trajectories.

For example, the processing circuitry 130 may use decision data indicating the approach speed of an obstacle and the vehicle's own trajectory to compute the probability that a collision will occur if a given control option, such as maintaining course, is executed. If the probability of collision is high, the circuitry 130 may determine to prioritize a different control option, such as an evasive maneuver, in the execution order. In another example, a smart city controller may calculate the probability that a public transit vehicle will arrive at an intersection within a certain time window, based on current traffic flow data and historical transit timings, and may prioritize control options that adjust traffic signals accordingly. These probabilities may guide the selection and ordering of control options to avoid undesirable outcomes or to exploit anticipated opportunities.

In some examples, determining the execution order of the plurality of control options may comprise determining an expected impact of an execution of at least one control option on the behavior of a target system which is controlled by the AI-system based on the decision data. In some examples, the behavior of a target system which is controlled by the AI-system may refer to the observable or measurable operational state, activity, or response characteristics of the target system 180 during its intended function. The behavior of the target system may include physical actions, control outputs, response times, movement patterns, energy consumption, or any system-relevant performance indicators. The target system 180 may be a robot, a vehicle, a medical device, or a smart city infrastructure component, as described previously, and its behavior may be shaped or influenced by commands or control signals issued by the AI-system 170. For instance, in the case of a robotic target system, the behavior may comprise navigation patterns, grasping motions, or manipulation sequences. In the case of a smart city traffic system, the behavior may include changes in signal patterns, energy flow adjustments, or emergency response activations. The behavior may be assessed over time or in response to environmental stimuli and is typically influenced by the execution of control options generated by the plurality of AI models of the AI-system.

In some examples, an expected impact of an execution of at least one control option on the behavior of the target system 180 may be a predicted or estimated effect that executing the respective control option is anticipated to have on the performance, safety, efficiency, or stability of the target system 180. The expected impact may serve as a criterium derived from the decision data, and may be determined by evaluating the control option against one or more attributes of the current operational context of the target system as reflected in the decision data. For instance, the decision data may include sensor readings, historical system responses, or predefined target system models that allow the AI-system to predict how the target system would react if a particular control option were executed. The expected impact may be quantified (e.g., in terms of energy saved, distance traveled, time to goal, risk reduction) or qualified (e.g., as high, medium, or low relevance). In some examples, the expected impact may be computed using simulation environments, digital twins, or prediction models embedded within the AI-system, and may consider temporal evolution, safety margins, or mission goals.

In some examples, determining the execution order of the plurality of control options based on the expected impact may comprise prioritizing or ranking the control options according to their predicted influence on the behavior of the target system. Control options expected to produce beneficial, efficient, or safe behaviors in the target system 180 may be ranked higher and selected for execution before others. For example, in a robot with limited power, a control option that minimizes actuator strain and preserves battery life while achieving a movement goal may be prioritized over one that achieves the goal faster but consumes more energy. In another example, in a smart city system, a control option that reroutes autonomous vehicles to reduce traffic congestion may be selected over an option that offers minimal behavioral change. In some examples, the expected impact may be combined with other criteria such as resource constraints or historical outcomes to form a composite score, enabling the apparatus to determine a balanced, context-aware execution order across multiple AI models and control options.

In some examples, the execution order of the plurality control options may be determined by a reinforcement learning model and/or a Bayesian network. In some examples, the Bayesian network may be a probabilistic graphical model that may represent a set of variables and their conditional dependencies using a directed acyclic graph. Each node in the Bayesian network may represent a probabilistic variable, and each directed edge may represent a causal or conditional relationship between the variables. The Bayesian network may enable probabilistic inference, allowing unknown or future states to be estimated based on known inputs and the network structure. In the context of determining the execution order of the plurality of control options, the Bayesian network may be used to model uncertainties, correlations, and probabilistic dependencies within the decision data that influence control decisions. In some examples, the Bayesian network may receive decision data as input, wherein the decision data may include sensor data, computing resource data, historical control outcomes, or predetermined preference data, as previously described. Each control option may be associated with one or more decision nodes in the Bayesian network that reflect its relevance, safety, efficiency, or feasibility under current conditions. The Bayesian network may then infer posterior probabilities or expected outcomes for the execution of each control option, given the present state of the decision data. The probabilistic outputs may express how likely a given control option is to succeed, be beneficial, or fulfill a predefined objective, conditioned on the current decision context. For example, a Bayesian network may infer that control option A has an 85% probability of leading to safe obstacle avoidance, while option B has a 45% probability of doing so based on current sensor data and historical failure logs.

In some examples, the execution order may be determined by ranking or selecting control options based on the inferred probabilities or expected values calculated by the Bayesian network. For example, a control option associated with the highest probability of success or goal attainment may be executed first. In another example, the Bayesian network may compute a joint probability distribution across multiple control options and select an execution order that maximizes overall expected utility under uncertainty. This approach may be particularly beneficial in scenarios involving incomplete information, conflicting objectives, or dynamic environmental changes. For instance, in a medical device control system, a Bayesian network may prioritize a patient monitoring action over a routine data logging action if the inferred risk of patient instability is elevated, based on observed physiological sensor data.

In some examples, the reinforcement learning model may be a machine learning model that may learn optimal decision-making policies through trial-and-error interaction with an environment by maximizing a cumulative reward function. The reinforcement learning model may be composed of one or more components, such as a policy network, a value function estimator, and an environment simulator or feedback interface. In the context of determining the execution order of the plurality of control options, the reinforcement learning model may be trained to map decision data and candidate control options to optimal execution sequences that maximize long-term system performance or safety. In some examples, the reinforcement learning model may take as input the current decision data, including sensor data, computing resource data, or historical state transitions of the AI-system 170 or the target system 180. The model may represent each control option as an action within a discrete or continuous action space and may predict the expected cumulative reward for executing each action in a given order. The reward signal may be derived from previous evaluations, simulation feedback, or real-world execution outcomes, and may encode criteria such as safety, efficiency, task completion success, or energy usage. For example, if a navigation control option historically led to fewer collisions when executed before a manipulation control option, the reinforcement learning model may assign it a higher value and rank it earlier in the execution order.

In some examples, the execution order may be determined by the reinforcement learning model selecting the sequence of control options that maximizes the predicted reward. The model may use learned policies to assign priorities dynamically, adapting its decisions to the current context and evolving over time through ongoing feedback. For example, in a robot tasked with object retrieval and navigation, the reinforcement learning model may learn that executing an object classification control option before the grasping control option improves task success, especially when visual sensor reliability is low. In another example, a reinforcement learning model in a smart city controller may learn to prioritize energy reallocation commands during predicted peak load periods to minimize system strain. The ability to learn from past outcomes allows the reinforcement learning model to determine a highly adaptive, performance-optimized execution order that is aligned with long-term control goals.

In some examples, determining the execution order of the control options may further comprise allocating respective computing resources of the AI-system for executing the respective control options of the plurality of AI models. In some examples, allocating respective computing resources of the AI-system for executing the respective control options of the plurality of AI models may comprise distributing portions of the available shared computing resources 174 to the execution of individual control options that have been selected for execution. The shared computing resources 174 may include, for example, processing circuitry capacity, memory, data bandwidth, and power supply units, as described above. The allocation may be based on the execution order previously determined for the plurality of control options, such that higher-priority control options may be granted earlier, more, and/or exclusive access to critical computing resources. This may ensure that time-sensitive or safety-critical control options may be executed without delay, while lower-priority options may receive proportionally fewer resources or be deferred until additional resources become available.

In some examples, this allocation may be dynamically adapted in real time, considering the resource demands associated with each selected control option and the current state of the shared computing resources 174. For instance, the processing circuitry 130 may be configured to evaluate the execution order and assign processing circuitry time slots, memory buffers, and power budgets accordingly. A control option that requires extensive neural inference may be allocated access to a GPU, while another control option with minimal computational load may be assigned to a general-purpose CPU core. As another example, if a control option for a robotic actuator must be executed with high responsiveness, the required processing, communication bandwidth, and actuator power may be reserved and prioritized based on the control option's execution rank. This ensures coherent system behavior and resource efficiency across all concurrently executing AI models.

In some examples, the processing circuitry 130 may be further configured to perform preprocessing of the received at least one of sensor data using an adaptive Kalman filter. In some examples, an adaptive Kalman filter may be a recursive, model-based filtering algorithm that is configured to estimate the true state of a physical variable over time by fusing noisy and uncertain sensor data with a system prediction model. The adaptive Kalman filter may differ from the classical Kalman filter by dynamically adjusting its process and measurement noise covariance matrices based on statistical characteristics of incoming data, thereby improving estimation accuracy under non-stationary conditions. For example, the input to the adaptive Kalman filter may be received raw sensor data from the one or more sensors 160, for example position data from a GPS sensor, velocity measurements from an inertial measurement unit (IMU), or object distance measurements from a LIDAR sensor. The output of the adaptive Kalman filter may be a smoothed or corrected estimate of the underlying physical quantity measured by the one or more sensors 160. In some examples, the preprocessing of the received sensor data using the adaptive Kalman filter may refer to the enhancement of data quality before fusion or AI model inference. This may include reducing high-frequency noise, compensating for sensor drift or temporary dropouts, interpolating missing values, or aligning sensor data to a common timestamp. For example, when multiple time-stamped measurements from radar and IMU sensors are received asynchronously, the adaptive Kalman filter may be used to predict and update the system state in real time, synchronizing and denoising the data. The preprocessed output may therefore represent a reliable, temporally consistent input for subsequent fusion steps, such as those that generate fused data, or for direct use in control-oriented AI models that require smooth and high-confidence state estimates. For instance, in an autonomous robotic system, applying the adaptive Kalman filter to noisy wheel encoder and gyroscope data may yield a consistent estimate of the robot's current orientation and trajectory, which can improve downstream planning and decision making.

In some examples, a local differential privacy filter may be applied to external inputs. Noise may be injected before processing, such as graph processing, to prevent re-identification in collaborative environments (e.g., federated training).

In some examples, the processing circuitry 130 is further configured to evaluate the determined execution order of the plurality of generated control options in a virtual environment and/or digital twin of the AI-system prior to execution. In some examples, a virtual environment may be a software-based simulation framework configured to digitally model the AI-system 170 and/or the physical and operational conditions of the target system 180 or its surroundings for the purpose of testing, validating, or optimizing control behavior. A virtual environment may emulate sensor behavior, physical dynamics, actuator responses, or environmental interactions under predefined or randomly generated scenarios. The virtual environment may be configured to receive the plurality of generated control options and simulate their effects on the behavior of a modeled version of the target system 180, without affecting the real-world system. For example, the virtual environment may include physics engines, 3D spatial models, traffic or pedestrian simulators, or thermal simulation models depending on the application domain. In this context, evaluating the determined execution order in the virtual environment may refer to the simulation-based analysis of how a prioritized sequence of control options would perform in a hypothetical situation. This may allow the processing circuitry 130 to test for conflicts, failures, or unintended side effects before initiating real-world execution.

In some examples, a digital twin may be a real-time, high-fidelity virtual replica of the AI-system 170, the target system 180, or both, which continuously synchronizes its internal state with actual sensor data and system parameters. A digital twin may be used to simulate, but also to mirror the current operational status, historical trends, and predicted behavior of the actual system. The digital twin may include real-time models of the AI models 172, sensor interfaces, actuator feedback loops, and shared computing resources 174. When evaluating the determined execution order of the plurality of control options, the digital twin may process these control options in parallel to the physical system to assess potential risks, performance bottlenecks, or safety violations. For example, in a robot, a digital twin may simulate internal trajectories and energy consumption before execution, allowing the processing circuitry 130 to detect whether a control sequence would cause motor overheating or power loss. In another example, a smart city traffic management system may use a digital twin to simulate the coordinated effect of prioritized traffic light control options before applying them across intersections, ensuring synchronization and avoiding congestion.

These evaluation mechanisms may support enhanced safety, robustness, and predictive decision making. For instance, in a medical system, the determined execution order of therapy-related control options may be tested within a digital twin of a patient-monitoring setup to verify whether the sequence of actions would maintain vital parameters within safe thresholds. In an autonomous vehicle scenario, the virtual environment may simulate complex intersections or rare edge cases to verify that the chosen execution order of evasive, braking, and signaling actions avoids collisions and complies with regulatory rules before they are implemented on the physical vehicle.

In some examples, determining the execution order of the control options is performed based on at least one of nature-inspired algorithms, swarm intelligence techniques, evolutionary algorithms or spiking neural networks. In some examples, nature-inspired algorithms may be computational strategies that are designed to mimic principles and mechanisms observed in natural systems, such as biological evolution, collective animal behavior, neural activity, or physical processes. These algorithms may be characterized by adaptive behavior, distributed problem-solving, and robustness to changing environments. Nature-inspired algorithms may be particularly suitable for solving complex optimization and decision-making tasks in dynamic, uncertain, or multi-agent environments. For example, in the context of determining the execution order of the plurality of control options, nature-inspired algorithms may provide flexible and self-organizing methods for prioritizing control options based on evolving system conditions, decision data, or emergent properties of the AI-system 170 and the target system 180. In some examples, determining the execution order of the plurality of control options based on nature-inspired algorithms may comprise encoding the set of control options as candidate solutions within an adaptive optimization process. The nature-inspired algorithm may iteratively evaluate and update these solutions based on fitness metrics derived from the decision data. For example, each control option may be associated with a utility score reflecting its predicted performance, safety, or energy cost, and the algorithm may evolve or refine the prioritization order over successive steps. The output may be a dynamically adjusted sequence of control options ranked for execution, optimized for changing sensor data, computing resource data, or historical outcomes. Such methods may be especially useful in decentralized or large-scale AI-systems with competing objectives or time-varying constraints.

In some examples, swarm intelligence techniques may be methods inspired by the collective behavior of decentralized, self-organized systems such as ant colonies, bird flocks, or fish schools. These techniques may involve simple agents that locally interact and collectively produce global behavior. In the case of determining execution order, each control option may be treated as an agent that evaluates local priorities or fitness based on the decision data. A swarm optimization process such as Particle Swarm Optimization (PSO) or Ant Colony Optimization (ACO) may then be applied to converge on an optimal or near-optimal execution order. For example, control options may deposit virtual “pheromones” based on past success rates, and more promising options may be prioritized through reinforced selection.

In some examples, evolutionary algorithms may be optimization methods that simulate biological evolution mechanisms, such as selection, mutation, recombination, and survival of the fittest. These algorithms may encode potential execution orders as individual solutions in a population, and evolve this population over generations to maximize a fitness function. The fitness function may be based on the expected impact, resource feasibility, or safety of the execution order under given decision data. For instance, control options that are frequently prioritized in historically successful sequences may be favored during selection. Over time, the algorithm may yield an optimized control sequence that balances multiple objectives derived from the decision data.

In some examples, a spiking neural network (SNN) may be an event-driven artificial neural network inspired by biological neurons that communicate via discrete spikes. For example, SNNs process information in the temporal domain and respond to changes in input over time. In determining the execution order, an SNN may be trained to emit spike patterns corresponding to priority levels or execution triggers. The inputs to the SNN may include encoded decision data such as sensor activity, computing load, or past model outputs, and the network may output activation sequences representing the prioritized control options. For example, a spike from a neuron associated with a braking control option may indicate it should be executed before a neuron representing an acceleration control option if obstacle proximity spikes are detected.

In some examples, the above methods may also be combined. For example, a spiking neural network may act as the evaluation function within a swarm intelligence framework, or an evolutionary algorithm may evolve the architecture or parameters of a swarm-based decision-making process. This flexibility may enable robust and adaptive determination of execution order in dynamic or resource-constrained AI systems.

### Data Fusion

In some examples, generating the fused data further comprises modeling dependencies between sensor data from one or more sensors and computation data from one or more of the plurality of AI models using a Graph Neural Network (GNN). A GNN may be a machine learning architecture specifically designed to operate on graph-structured data, where entities are represented as nodes and relationships between them are encoded as edges. A GNN may process both the features of individual nodes and the structure of the graph, enabling the network to learn and propagate contextual information through the graph topology. The learning process within a GNN may be based on iterative message passing or neighborhood aggregation, whereby node representations are updated by integrating information from neighboring nodes and edges over multiple steps. This architecture may be particularly well suited for applications involving irregular, relational, or multimodal data structures, such as sensor networks or distributed AI-model outputs. In some examples, to generate fused data, the GNN may be used to model dependencies between sensor data from one or more sensors and computation data from one or more of the plurality of AI models by constructing a graph in which the sensor data and the computation data are encoded as node features. Edges may represent temporal, spatial, or functional relationships between data sources, such as causal links, sensor co-location, cross-modal correspondence, or prior knowledge of task-relevant dependencies. The GNN may then perform feature transformation and aggregation operations across the graph, allowing each node to enrich its internal representation based on information from related nodes. This enriched representation may then be used to produce a fused output vector, tensor, or structured graph encoding, which combines sensor and AI model information into a unified format suitable for downstream processing.

For example, the input to the GNN may be a graph in which each node corresponds to a particular data source, such as a LIDAR sensor, a temperature sensor, a trajectory prediction model, or a visual classification model. The edges may encode semantic relationships, such as “supports localization” or “correlated over time,” and the node features may include raw measurements, extracted features, or intermediate model predictions. The output of the GNN may be a set of updated node representations or a global graph embedding that summarizes all interdependent data in a compact form. For instance, a fused representation generated in this manner may reflect how LIDAR anomalies correspond with camera data inconsistencies and how both relate to path prediction confidence. This fusion may enable more robust decision-making in complex environments, where understanding the interaction between different data streams is crucial.

In some examples, generating the fused data further comprises reducing inconsistent sensor data and computation data using a GNN. In some examples, reducing inconsistent sensor data and computation data using a Graph Neural Network may comprise detecting, attenuating, and/or reconciling discrepancies among heterogeneous data by leveraging the relational modeling capabilities of the GNN. In this context, inconsistencies may refer to conflicts, contradictions, outliers, or noise among the data inputs provided by the one or more sensors and the computation data generated by the one or more of the plurality of AI models 172. The GNN may enable context-aware comparison and adjustment of the data by modeling dependencies across all sources and applying learned filtering or correction strategies during graph propagation. In some examples, the input to the GNN may be a graph in which nodes represent distinct sources of sensor data or computation data, and edges encode known or inferred correlations, dependencies, or task-specific relationships. Each node may include the current value or feature vector of the respective data source (e.g., a LIDAR point cloud, a radar velocity vector, a model prediction confidence score). During message passing, the GNN may compare these values across neighboring nodes and apply learned weights to suppress or down-weight values that appear anomalous or contradictory when viewed in the context of related nodes. The output of the GNN may be a revised graph embedding or set of corrected node features in which the influence of inconsistent or unreliable data has been reduced. For example, in a situation where a LIDAR sensor indicates a large nearby obstacle, but both the camera data and object detection model suggest an open path, the GNN may learn to suppress the LIDAR anomaly based on its historical unreliability in similar conditions or based on stronger agreement among the other sources. Similarly, if an AI model 172 generates a prediction that contradicts both sensor trends and other model outputs, the GNN may reduce its influence during fusion. This leads to a fused representation that prioritizes reliable, consistent data and supports more stable and accurate downstream decision-making.

In some examples, generating the fused data further comprises identifying conflicting sensor data and computation data using a GNN. In some examples, identifying conflicting sensor data and computation data using a GNN may comprise a trained GNN or a GNN configured to detect semantic, spatial, or temporal inconsistencies between signals originating from the one or more sensors and the outputs of the plurality of AI models. The input to the GNN may comprise a graph structure that encodes both sensor data and computation data as nodes or node attributes, while edges between these nodes may represent functional, spatial, temporal, or contextual relationships. Each node may carry features such as sensor modality, value range, timestamp, confidence level, or estimated accuracy. The GNN may process this structured input through iterative message-passing operations that aggregate and update node and edge representations based on the contextual information of their neighbors. As a result, the GNN may learn to recognize structural or statistical patterns indicative of conflict, such as mutually exclusive observations, contradictory predictions, or abnormal signal divergence. The output of the GNN may include conflict scores, node-level disagreement indicators, or classification labels that identify which data sources or model outputs are in disagreement. For example, a GNN may be used to detect conflict between a LIDAR sensor reporting a free path and an AI model predicting an obstacle in that same region. The graph input to the GNN may contain nodes for the LIDAR point cloud segments, radar detections, camera-based object recognition results, and model-inferred obstacle maps, all connected by edges reflecting spatial co-location or modality correlation. If the GNN infers that one group of signals indicates object presence while another implies absence with high certainty, it may flag this contradiction as a conflict. Another example may involve a temperature sensor reading a safe thermal range while a diagnostic AI model predicts a risk of overheating; here, the GNN may detect temporal inconsistencies or low mutual correlation and assign a high conflict likelihood to these inputs. Identifying such conflicts is valuable for downstream fusion logic, which may then resolve ambiguities by invoking fallback strategies, applying weighted confidence, or deferring execution decisions until the conflict is addressed.

In some examples, the use of the GNN may enable dynamic prioritization of fused sensor and computation data based on their relational dependencies. This facilitates a contextualized and data-aware interpretation of heterogeneous inputs, improving the accuracy and robustness of downstream decision-making processes. Unlike classical fusion techniques that treat data channels independently or equally, the GNN may leverage structural information to resolve conflicts, suppress anomalies, and enrich model input representations.

In some examples, the decision module may use a hybrid graph inference engine which may combine rule-based filters and the GNNs. For example, nodes may dynamically reroute inference paths based on anomaly scores exceeding a configurable threshold (for example >0.7). This may enable real-time context-sensitive adaptations.

In some examples, a secure update engine may be integrated that may fetch new GNN weights or rule sets from a signed repository. Updates may be verified via digital signature and only applied after integrity checks.

In some examples, federated GNN training with Secure Multi-Party Computation (SMPC) may be supported to exchange encrypted model updates across distributed nodes without exposing raw data.

In some examples, edge priorities and routing rules may be dynamically updated based on policy rules (e.g., mission-critical overrides, role-based restrictions). Policies are cryptographically signed and revocable.

In some examples, GNN models and decision graphs may be split across decentralized nodes. Each node processes a graph segment and shares intermediate activations using secure interfaces.

In some examples, intermediate GNN states may be exported via secure enclaves or TEEs (Trusted Execution Environments), allowing downstream auditing or external AI regulation.

In some examples, graph logic may be adapted based on the authenticated role of the requesting entity. For example, the same sensory input may trigger different decisions for a supervisor vs. a field agent.

In some examples, generating the fused data includes fusing the sensor data and the computation data, wherein the fusing is performed using multimodal data fusion. In some examples, multimodal data fusion may refer to the integration of data from multiple distinct modalities, such as different types of sensor data and computation results of one or more AI models, into a unified representation that enables enhanced inference, decision-making, or model coordination. Each modality may represent a different source of information, characterized by its own structure, resolution, dimensionality, noise characteristics, or semantic interpretation. The purpose of multimodal data fusion may be to exploit the complementary nature of the modalities to produce a fused output that is more informative, robust, or context-aware than any single modality alone. For example, the multimodal data fusion may comprise combining raw or preprocessed signals from the one or more sensors such as cameras, LIDAR units, radar sensors, or temperature sensors, and/or together with outputs or intermediate representations generated by the plurality of AI models 172, such as predictions, confidence maps, or feature embeddings. In some examples, the fusion process may comprise, including temporal synchronization of data streams, spatial alignment of features, normalization of scale or semantics, and learned or rule-based combination functions. The inputs to the multimodal data fusion may include time-stamped RGB image frames, point clouds, radar signal interpretations, and semantic segmentations or attention weights from perception or control-related AI models. The outputs of the fusion may be dense feature maps, unified embeddings, or structured data representations that preserve relevant aspects from each modality while eliminating redundancy or contradiction. For example, camera data may provide rich color and texture cues, LIDAR data may encode geometric depth, and an AI model output may offer object classification; fusing these may produce a 3D object map with both semantic and geometric attributes. This fused data may then serve as the common input for downstream AI models, enabling better situational understanding or decision-making.

For instance, in an autonomous vehicle scenario, multimodal data fusion may combine the camera input showing a pedestrian, LIDAR-based depth readings, radar velocity estimates, and a segmentation map generated by a neural network into a single fused representation. The fused data may include a precise object location, speed vector, and identity label (“pedestrian”) enriched with contextual indicators such as risk level or expected trajectory. This unified representation may allow another AI model, such as a path planning model, to generate control options like braking or evasive steering with greater accuracy and situational awareness.

In some examples, the multimodal data fusion is performed using a transformer-based model. For example, the transformer-based model may be a type of deep learning architecture adapted for tasks involving heterogeneous or structured data, including multimodal fusion. The transformer-based model may rely on a mechanism known as self-attention (or more generally attention mechanisms), which allows the model to dynamically weight the contribution of each part of its input relative to others. For the multimodal data fusion, a transformer-based model may be configured to receive input tokens or embeddings from different data modalities, such as sensor data from a camera, LIDAR unit, or radar sensor, and computation data from one or more of the plurality of AI models 172, and to compute contextualized representations that capture dependencies and interactions across the modalities. In some examples, the transformer-based model may be trained using supervised, unsupervised, or self-supervised learning techniques on datasets that contain temporally or spatially aligned multimodal inputs and task-specific labels or objectives. The input to the transformer-based model may be a sequence or set of modality-specific feature vectors, such as embeddings extracted from image patches, point cloud regions, radar channels, or AI-generated feature maps. The model may then apply self-attention layers, cross-attention layers, and feedforward networks to compute fused representations that capture joint information. The output may be a fused data embedding, a classification decision, or a spatial-temporal map that combines and weights relevant aspects from each input modality. This transformer-based fusion may enhance the AI-system's ability to reason across modalities, detect cross-modal inconsistencies, and produce fused data that is highly informative for downstream control or decision-making processes. For example, in a medical application, a transformer-based model may be trained to fuse visual input from an imaging sensor (e.g., ultrasound), biosignal time series (e.g., ECG data), and diagnostic computation results from AI models into a unified patient state vector. This vector may then support clinical decision-making by encoding real-time multimodal evidence in a coherent form.

In some examples, generating fused data further comprises weighting the sensor data and/or the computation data based on data quality, data reliability, and/or data relevance. In some examples, data quality may refer to characteristics of the sensor data or computation data that indicate its precision, resolution, completeness, or degree of noise. For instance, high-quality data may exhibit low signal noise, minimal missing values, and accurate timestamp alignment. In some examples, data reliability may refer to the historical consistency or trustworthiness of the data source or modality under specific operating conditions. For instance, a sensor may be considered reliable if it has consistently produced accurate outputs across varying scenarios or if its internal health status is verified. In some examples, data relevance may refer to the contextual usefulness or task-specific applicability of the data at a given time. For instance, LIDAR data may be more relevant for spatial mapping in an outdoor navigation task, while radar signals may be more relevant in low-visibility conditions.

In some examples, weighting the sensor data and/or the computation data based on such factors may comprise assigning a numerical or symbolic importance value to each data source or data modality before performing fusion. This weighting may be static, dynamic, or learned over time. In a static scheme, predetermined weights may be assigned based on design-time knowledge of sensor characteristics or model performance. In a dynamic scheme, weights may be computed in real time based on monitoring signal-to-noise ratio, confidence scores, or environmental feedback. In a learned scheme, a dedicated AI model 172 such as a neural network, may be trained to infer optimal weights from historical data and context. Weighting may be implemented, for example, by scaling input feature vectors, modifying loss functions in the fusion model, or gating the contribution of data channels during multimodal aggregation. The resulting fused data may thus reflect not only raw input values but also an adjusted synthesis that prioritizes trusted, relevant, and high-quality signals.

For example, in an autonomous vehicle, LIDAR point cloud data may be given lower weight during a rainstorm due to signal interference, while radar data may be upweighted for robustness. In another example, a manipulation model in a robot may assign greater weight to force sensor readings when grasping an object but rely more on vision data during object detection. In yet another case, if the AI-system determines that the energy consumption of a specific high-resolution sensor is too high relative to its utility under current task constraints, its data may be downweighted or ignored altogether during fusion. These weighting strategies may ensure that the generated fused data remains accurate, stable, and appropriate for downstream control decisions under changing operational conditions.

In some examples, the weighting of the sensor data and the computational data is performed by an attention-based neural network, such as a Graph Attention Network (GAT). In some examples, the GAT may be a neural network architecture that operates over graph-structured data and may utilize attention mechanisms to learn and apply differentiated importance values (attention weights) to edges or neighboring nodes during information aggregation. The GAT may extend traditional graph neural networks by allowing the model to dynamically focus on the most relevant parts of a graph, rather than treating all neighboring nodes equally. Each node in the graph may aggregate information from its neighbors using learned attention coefficients that reflect the contextual importance of each neighbor. These coefficients may be computed through trainable scoring functions based on node features and may be normalized, for example, using softmax operations. This architecture may enable the GAT to process heterogeneous, noisy, or context-dependent data more effectively than uniform-weighted models. In some examples, a GAT may be used to perform the weighting of sensor data and computational data during fused data generation by representing the available data inputs as nodes in a graph, with edges representing data dependencies, modality relations, or co-occurrence patterns. Each node may be associated with a feature vector encoding the content of a sensor measurement or a model output. The GAT may learn attention coefficients for each edge, which may act as dynamic weighting factors reflecting the relative relevance, reliability, or quality of that data input in a given context. The output of the GAT may be a new set of node embeddings or a fused graph representation in which each data input's contribution has been adjusted according to its learned weight. These outputs may then be aggregated and used by downstream models or decision logic within the AI-system.

For example, in a robot with camera, LIDAR, and proprioceptive sensors, a GAT may assign greater weight to proprioceptive data during low-light conditions, while emphasizing visual data during well-lit operation. Similarly, in a smart city infrastructure, data from traffic sensors and AI model predictions may be encoded as graph nodes, and a GAT may learn to emphasize sensor streams with low latency and high historical accuracy during real-time traffic signal adjustment. In a medical device, the GAT may downweight sensor data from a faulty or noisy channel while upweighting redundant corroborating sources. By dynamically adapting attention weights based on data characteristics and context, the GAT may enable robust and interpretable weighting during sensor-computation fusion for critical AI control systems.

### Adapt Usage of the Shared Computing Resources

For example, the processing circuitry 130 may be further configured to receive the computing resource data. Further, the processing circuitry 130 may be configured to analyze the received computing resource data regarding a resource distribution in the AI-system. In some examples, the computing resource data may be received by the processing circuitry 130 from one or more components within the AI-system 170 that monitor the internal status of the shared computing resources. The computing resource data may originate from system-level monitoring modules, hardware-level performance counters, operating system processes, embedded diagnostics of processing circuitries or memory units, software daemons tracking resource usage, or telemetry signals from distributed AI-system components. For example, dedicated sensors embedded in the AI-system 170 may monitor the real-time power consumption of AI accelerators or the bus traffic across shared communication links. The computing resource data may be communicated to the processing circuitry 130 via the interface circuitry 120, internal buses, memory-mapped registers, system interrupts, or standardized telemetry protocols, and may be structured as time-stamped logs, numerical indicators, heatmaps, or status flags depending on the source and granularity of the data. In some examples, the computing resource data may be periodically sampled or continuously streamed, enabling real-time or near-real-time access to the internal resource metrics of the AI-system 170.

In some examples, analyzing the received computing resource data regarding a resource distribution in the AI-system may comprise evaluating how the available processing, memory, communication, and/or power resources are currently utilized or allocated across the plurality of AI models 172 and subsystems. The processing circuitry 130 may perform this analysis using one or more analysis tools or algorithms, such as rule-based threshold evaluation, load-balancing heuristics, statistical modeling, clustering, or machine learning-based pattern recognition. The analysis may target key performance metrics such as processing circuitry load per model, memory saturation ratios, bus contention levels, energy distribution across components, or historical trends in task execution latency. The result of the analysis may indicate potential bottlenecks, inefficiencies, or overloads, and may form the basis for adaptive resource reallocation or prioritization. For example, the analysis may detect that one AI model 172 has consumed 80% of available shared memory. In another example, the analysis may reveal that a low-priority AI model is occupying a high-bandwidth communication channel during peak inference time of a critical model.

In some examples, adapting the usage of the shared computing resources comprises assigning respective values of processing circuitry power, memory, data bandwidth, and/or energy to the respective plurality of AI models. In some examples, to assign respective values of processing circuitry power, memory, data bandwidth, and/or energy to the respective plurality of AI models 172 may comprise a selective and dynamic distribution of discrete or continuous quantities of the shared computing resources among the AI models 172 of the AI-system 170 based on computing resource data. The values assigned to each AI model may correspond to measurable resource allocations such as clock cycles or processing threads (processing circuitry power), addressable memory blocks or buffer quotas (memory), communication channel capacity or priority levels (data bandwidth), and current or voltage levels, time slots, or energy budgets (energy). This assignment may be implemented as part of the control functionality of the processing circuitry, which evaluates the current status of the AI-system and distributes resources accordingly to maintain performance, energy efficiency, or task priority alignment.

In some examples, the assignment of resource values may be performed based on an analysis of the computing resource data. For example, if computing resource data indicates that a particular AI model is engaged in high-frequency sensor processing and produces mission-critical outputs, the processing circuitry 130 may assign an increased share of available processing circuitry power and memory to this model. Similarly, if computing resource data reveals congestion on a shared data bus, the processing circuitry 130 may throttle the data bandwidth assigned to less urgent AI models to prioritize real-time data transmission for time-sensitive models. In other examples, energy usage may be regulated by decreasing the energy budget of background AI models and allocating energy to inference models operating under strict latency constraints. The assignment may be updated continuously or periodically to reflect evolving workloads and system conditions. For example, during a peak in environmental complexity detected by sensor data, more memory may be temporarily granted to a perception model for processing high-resolution sensor streams, while a control model may receive additional processing circuitry capacity to compute time-sensitive control options.

In some examples, the processing circuitry 130 may be further configured to adapt at least one of a sampling rate of a sensor, an activity status of a sensor, or an energy consumption of an AI-system component based on received computing resource data. The sampling rate of a sensor may refer to the frequency at which sensor measurements are acquired and digitized for downstream processing. The activity status of a sensor may refer to an operational state, such as active, standby, or disabled, that defines whether the sensor is currently engaged in data acquisition. The energy consumption of an AI-system component, including sensors, may refer to the electrical power drawn during operation, which may vary with sampling frequency, sensor mode, or transmission activity. In some examples, these parameters may be adapted as part of a broader strategy to manage shared computing resources of the AI-system 170. The adaptation may take into account the current availability and load profile of the AI-system 170, as represented in the received computing resource data. For example, if the processing circuitry 130 determines from the computing resource data that the current computational load or memory usage is high, it may reduce the sampling rate of non-critical sensors to conserve processing bandwidth. Alternatively, if energy constraints are detected, the processing circuitry 130 may selectively deactivate low-priority sensors or reduce the energy-intensive operations of specific sensors.

In some examples, the AI-system 170 may be integrated into the same physical device as the target system 180, such as in a robot or medical device. For example, in this case the processing circuitry 130 may directly control embedded sensors based on internal computing constraints. In this case, sensor adaptation may involve real-time changes to hardware configurations, such as modifying analog-to-digital conversion rates or disabling internal power rails to specific sensor units. In other examples, if the target system 180 is external to the AI-system 170, such as in a smart city where distributed sensors are controlled remotely, the adaptation may involve sending configuration commands to external sensor platforms. In such cases, the processing circuitry 130 may adapt parameters such as polling intervals, resolution settings, or streaming protocols based on the computing resource data and the communication capacity available between the AI-system and the target system. For example, in an autonomous vehicle, the sampling rate of a rear-facing radar sensor may be reduced during low-speed operation if computing resources are prioritized for front-facing obstacle detection. In a smart city infrastructure, a surveillance camera may be placed into standby mode at night to conserve bandwidth and processing power, unless triggered by an event. In a medical monitoring system, the energy consumption of a wearable heart-rate sensor may be dynamically adjusted based on the available battery level and the processing load of the AI model performing anomaly detection.

In some examples, adapting the usage of the shared computing resources is performed using a constraint-solving model to optimize computing capacities among parallel AI models. In some examples, a constraint-solving model may be a computational framework configured to determine a feasible or optimal allocation of shared computing resources under one or more defined constraints. The constraint-solving model may be designed to take as input a set of variables representing the available shared computing resources of the AI-system 170, such as processing circuitry capacity, memory, bandwidth, or power supply, along with one or more constraints or rules derived from computing resource data, operational policies, or execution priorities of the plurality of AI models 172. The constraint-solving model may output a resource allocation scheme that satisfies the constraints while optimizing for predefined objectives, such as latency minimization, throughput maximization, energy efficiency, or task-specific priorities. In some examples, the constraint-solving model may employ mathematical programming techniques such as linear programming, mixed-integer programming, constraint satisfaction problem (CSP) solvers, or satisfiability modulo theories (SMT) solvers. The model may iteratively explore the solution space or use heuristics to compute feasible assignments of computing resources to each of the parallel AI models of the AI-system.

In some examples, the constraint-solving model may be used to adapt the usage of shared computing resources by generating a real-time allocation plan that balances the execution demands of the plurality of AI models 172 while observing system limitations. For example, the constraint-solving model may receive inputs comprising the real-time computing resource data, such as current memory availability, CPU load, energy consumption limits, or data bus congestion levels, and constraints such as execution deadlines, model priorities, or quality-of-service requirements. Based on these inputs, the model may compute a valid configuration in which each AI model receives a specified amount of processing circuitry cycles, memory buffer space, and energy budget. In one example, if three AI models must execute concurrently and the total available GPU capacity is limited, the constraint-solving model may assign 50%, 30%, and 20% GPU time respectively based on task criticality and latency constraints. In another example, the model may decide to delay a non-urgent AI model to ensure sufficient bandwidth for real-time sensor fusion tasks. This enables the AI-system to flexibly and formally optimize resource usage under dynamically changing workloads and constraints.

In some examples, adapting the usage of the shared computing resources is performed using a biological-inspired machine learning model. For example, a Spiking Neural Network (SNN) may be used. For example, the SNN may be a biologically inspired neural network architecture in which the individual computational units, referred to as spiking neurons, communicate by emitting discrete time-dependent spikes or events rather than continuous activation values. In SNNs information may be encoded in the timing and frequency of spikes, thereby mimicking the behavior of biological neurons. A SNN may comprise components such as synaptic weights, membrane potentials, and dynamic thresholding mechanisms. The temporal dynamics and event-driven nature of SNNs may allow them to model time-sensitive processes, react to asynchronous inputs, and operate with high energy efficiency, especially when implemented on neuromorphic hardware platforms. In some examples, the computational model of an SNN may be based on Leaky Integrate-and-Fire (LIF) neurons, Izhikevich models, or similar mathematical abstractions.

In some examples, the SNN may be used to adapt the usage of the shared computing resources of the AI-system by learning temporal patterns in resource usage, workload dynamics, or execution demand across the plurality of AI models. In this case, the SNN may be trained to detect and respond to patterns in computing resource data, such as sudden spikes in memory usage, processing bottlenecks, or energy consumption peaks. The SNN may receive time-series data or spike-encoded versions of the computing resource data as input, such as sensor utilization rates, processing circuitry load, latency traces, or power fluctuations. The output of the SNN may be a control signal or activation pattern indicating which AI models 172 should be prioritized, throttled, or reconfigured in terms of resource allocation. In some examples, the SNN may be trained using spike-timing-dependent plasticity (STDP), reward-modulated STDP, or surrogate gradient methods in a reinforcement learning framework, allowing the SNN to adapt its internal weights based on reward signals that encode resource optimization goals or system performance feedback.

For example, if the computing resource data indicates a growing memory load caused by simultaneous execution of perception and control AI models, the SNN may emit spikes triggering a reduction in the buffer size allocated to background learning models. In another example, if spike-based inputs from real-time CPU usage sensors indicate frequent contention events, the SNN may generate output spikes that activate a reassignment of processing threads from a heavily loaded model to a more idle model. In a smart city application, an SNN may adapt resource usage across distributed AI nodes by regulating energy delivery or computation rates based on detected temporal load patterns, such as traffic surges or event-driven surveillance tasks. The temporal precision and adaptive learning capability of SNNs may make them particularly suitable for continuous and low-power adaptation of computing resources in complex and resource-constrained AI-systems.

In some examples, the adaptation of the usage of the shared computing resources may comprise selectively activating or deactivating processing capacity, memory, or power allocation for at least one of the plurality of AI models 172 based on temporal spike activity within the SNN. In some examples, selectively activating or deactivating processing capacity, memory, or power allocation for at least one of the plurality of AI models 172 based on temporal spike activity within the Spiking Neural Network (SNN) may comprise a dynamic control process in which the shared computing resources of the AI-system are redistributed in real time depending on the spike-based signaling behavior of the SNN. The SNN may be trained or configured to interpret temporal patterns in computing resource data and generate temporally precise output spikes. These output spikes may serve as control triggers or gating signals that instruct the apparatus to enable or disable access to specific resource domains, such as processing circuitry cores, memory regions, or power circuits, for individual AI models 172. In this configuration, the inputs to the SNN may comprise spike-encoded representations of real-time computing resource data, such as CPU utilization events, memory access frequency, thermal readings, or latency thresholds exceeded. The internal dynamics of the SNN may integrate these spike inputs over time, allowing the network to detect temporal patterns such as sustained overload, transient bursts, or idle periods. The SNN may produce output spikes whose timing, frequency, or destination corresponds to control actions such as granting or revoking access to a processing circuitry thread, powering down a high-consumption memory module, or suspending execution of a non-critical AI model. These output spikes may be decoded by a control interface that maps them to system-level actions affecting the respective computing resources.

For example, if the SNN detects a repeated spike pattern indicating a prolonged peak in processing circuitry usage by multiple AI models 172, it may generate a high-frequency output spike targeting a load-balancing controller, which in turn may deactivate lower-priority AI models or reassign their processing circuitry capacity. In another example, a low-frequency spike burst from the SNN may signal underutilization of memory resources, triggering a reactivation of previously suspended models or an expansion of buffer memory for critical real-time models. In a vehicle system, if LIDAR and radar processing tasks exceed allowable latency thresholds, the SNN may emit temporal spikes that instruct the apparatus to deactivate a background map-learning model and reallocate its processing circuitry and power budget to the real-time perception pipeline. Through this mechanism, the SNN may enable fine-grained, low-latency adaptation of computing resource usage in response to temporal workload dynamics.

In some examples, adapting the usage of the shared computing resources is performed using Neural Evolution (NE), wherein the NE is configured to iteratively restructure at least one of a topology, activation functions, or hyperparameters of at least one AI model in the plurality of AI models, based on computing resource constraints or performance feedback. In some examples, Neural Evolution may refer to a class of biologically inspired machine learning techniques that evolve artificial neural networks over successive generations using evolutionary algorithms such as genetic algorithms, evolution strategies, or neuroevolution of augmenting topologies (NEAT). Another implementation may include HyperNEAT, which extends NEAT to evolve large-scale connectivity patterns, or evolutionary strategies integrated into frameworks like DEAP (Distributed Evolutionary Algorithms in Python) or LEAF (Learning Evolutionary AI Framework). These implementations may be particularly suitable for optimizing AI models that operate under fluctuating processing circuitry power, memory budgets, or communication bandwidth within an embedded AI-system or a distributed edge computing infrastructure. For adapting the usage of the shared computing resources, Neural Evolution may be specifically configured to iteratively optimize the internal structure or configuration of at least one AI model in the plurality of AI models 172, based on real-time or periodic computing resource constraints and/or performance feedback. The objective of Neural Evolution in this setting may be to restructure the AI model in a resource-aware manner such that it meets operational goals while operating within available computational budgets.

The input to the Neural Evolution mechanism may include computing resource data describing the current availability, utilization, and bottlenecks of shared computing resources of the AI-system 170, such as processing circuitry load, memory pressure, or energy consumption profiles, as well as performance metrics like latency, accuracy, or task success rates gathered from the AI models. The output of the Neural Evolution process may include a modified or newly instantiated AI model architecture, with one or more parameters changed in response to the input conditions. These parameters may include the topology of the neural network (i.e., the number of layers, number of nodes per layer, and connectivity patterns), activation functions (e.g., ReLU, sigmoid, tanh), and hyperparameters (e.g., learning rate, dropout rate, weight initialization strategy). The Neural Evolution model may perform crossover and mutation operations on candidate model configurations, evaluate their fitness with respect to a performance-resource trade-off, and propagate the most effective configurations to the next generation.

For example, if the computing resource data indicates limited memory and reduced processing availability, Neural Evolution may restructure a perception model by reducing the number of hidden layers or switching to a lighter activation function, such as replacing a deep convolutional layer stack with a shallower model. Alternatively, if energy consumption constraints are detected, Neural Evolution may evolve model variants that favor spiking activation functions or quantized parameters for execution on low-power AI accelerators. In an autonomous robot, if real-time performance drops due to increased sensor activity and restricted processing circuitry availability, Neural Evolution may reduce the connectivity of a navigation model's recurrent layers while increasing the weight sparsity to reduce computational complexity—thereby enabling continued operation within the constrained computing envelope. Through this process, Neural Evolution may allow the apparatus to dynamically adapt the structure and behavior of AI models to maintain functionality under changing resource conditions.

In some examples, adapting the usage of the shared computing resources comprises quantum or quantum-inspired optimization methods. For example, Quantum-Assisted Optimization (QAO) may be used. In some examples, adapting the usage of the shared computing resources may comprise QAO. QAO may be an optimization approach that leverages quantum computing techniques, such as quantum annealing or variational quantum algorithms, to solve complex combinatorial or continuous optimization problems more efficiently than classical methods in specific domains. QAO may utilize the quantum-mechanical properties of superposition and entanglement to explore multiple solution states in parallel, offering potential advantages for large-scale, high-dimensional, or constraint-heavy optimization tasks. In some examples, QAO may be used to determine an optimal or near-optimal allocation of shared computing resources among the plurality of AI models 172. The QAO process may take as input a formulated optimization problem that encodes variables representing computing resource parameters (e.g., processing circuitry shares, memory blocks, bandwidth slots, energy limits) and constraints derived from the current computing resource data. These constraints may include task urgency, AI model priority, inter-model communication needs, or energy consumption thresholds. The objective function may be defined to maximize overall system performance, maintain fairness among models, or minimize total energy consumption. The output of QAO may be an allocation scheme, represented as a vector or assignment matrix, indicating how available resources should be distributed among the AI models.

For example, the processing circuitry 130 managing the plurality of AI models 172 with fluctuating loads, QAO may be used to determine how GPU memory is split between perception and planning models, how processing cores are scheduled for latency-critical vs. batch-processing models, or how power is allocated across sensors and model inference units. The QAO problem may be expressed in a Quadratic Unconstrained Binary Optimization (QUBO) format or as an Ising model Hamiltonian and solved using quantum annealers such as those provided by D-Wave Systems. Alternatively, QAO may be implemented using Variational Quantum Eigensolvers (VQE) or the Quantum Approximate Optimization Algorithm (QAOA) on gate-based quantum processing circuitries, such as IBM Q or Rigetti's Aspen. Software frameworks such as D-Wave Ocean, PennyLane, or Qiskit may be used to model the optimization task and integrate the solution into a classical decision engine. For instance, the AI-system may use QAO to periodically reallocate resources in response to sudden changes in sensor sampling rates or spikes in computation load while satisfying task deadlines and maintaining thermal and power limits.

In some examples, the QAO is configured to solve an optimization problem representing the allocation of the shared computing resources among the plurality of AI models based on computing resource data and decision data, by embedding the optimization problem into a quantum annealing process or a variational quantum circuit executed on a quantum processing unit. In some examples, the optimization problem representing the allocation of the shared computing resources may define a constrained objective that models how a finite set of computing resources (such as processing circuitry capacity, memory, bandwidth, or energy) should be distributed among the plurality of AI models 172 to maximize operational efficiency, minimize latency, or satisfy model-specific performance requirements. The optimization problem may be constructed using one or more objective functions and constraints derived from both computing resource data and decision data. For example, the computing resource data may provide real-time metrics about the availability or load of system resources, while the decision data may encode priorities, task urgency, AI model utility, or goal-alignment requirements. The optimization variables may represent assignable resource quantities, and the constraints may limit these variables based on physical availability, timing requirements, or logical dependencies between the AI models.

To solve the defined optimization problem using QAO, the optimization task may be translated into a quantum-compatible representation and embedded into a quantum algorithm. In some examples, this may be achieved by formulating the optimization problem as a Quadratic Unconstrained Binary Optimization (QUBO) problem or an Ising model Hamiltonian. These formulations are suitable for quantum annealing processes, where the quantum system evolves from an initial quantum state to a final ground state that encodes the optimal or near-optimal solution. For example, in a D-Wave system, the QUBO matrix may be mapped onto a quantum graph topology and processed via adiabatic evolution to identify the configuration with minimum energy, corresponding to the most efficient allocation of computing resources.

In other examples, the optimization problem may be embedded into a variational quantum circuit for use on gate-based quantum processing circuitries. A variational quantum circuit may be a parameterized quantum circuit executed in conjunction with a classical optimizer, such as a gradient descent loop, to iteratively adjust circuit parameters and minimize a predefined cost function related to resource allocation. Algorithms such as the Quantum Approximate Optimization Algorithm (QAOA) or Variational Quantum Eigensolver (VQE) may be employed. These algorithms balance classical and quantum computation, enabling hybrid solvers for resource-constrained, high-dimensional allocation problems.

For example, the AI-system 170 may distribute limited GPU time and battery power among five AI models 172, each with different priority levels, deadlines, and energy demands. A QUBO representation of this problem may encode both the energy costs and utility scores of each possible allocation. A QAO process executed on a quantum annealer or variational quantum backend may then identify an optimal configuration that prioritizes time-critical models and respects energy constraints. This quantum-derived allocation may then be used by the processing circuitry to dynamically adapt the usage of the shared computing resources.

In some examples, the fallback layer may operate over post-quantum encrypted channels, ensuring that decision graphs remain secure in adversarial quantum scenarios.

In some examples, the optimized allocation generated by the QAO is recorded on a distributed ledger. In some examples, a distributed ledger may be a decentralized and tamper-resistant digital system for recording transactions or data entries across multiple nodes within a network. Each participant or node in the network may maintain a synchronized copy of the ledger, and any update or addition to the ledger may require validation by a consensus mechanism. A distributed ledger may offer transparency, auditability, and integrity by ensuring that once data is recorded, it cannot be modified retroactively without altering all subsequent entries and gaining the consensus of the majority of nodes. Distributed ledgers may be implemented using various technologies, including blockchains, Directed Acyclic Graphs (DAGs), or permissioned database systems. Examples include Hyperledger Fabric for enterprise-grade permissioned ledgers, Ethereum or other public blockchain platforms, and IOTA for IoT-based DAG ledgers. In some examples, recording the optimized allocation generated by the QAO on a distributed ledger may serve multiple purposes. It may enable secure and immutable logging of allocation decisions for later audit, compliance verification, or debugging. It may also allow distributed components of the AI-system 170 to query the current or historical resource distribution status without relying on a centralized authority. For example, in an edge computing deployment where multiple autonomous systems cooperate, each system may independently verify the most recent allocation strategy derived by QAO from the shared distributed ledger. In another example, logging allocation results onto a ledger may support rollback, reproducibility, or validation during simulation or digital twin testing phases, especially in safety-critical environments such as autonomous driving or medical AI systems.

For example, data (such as decisions, path switches, and/or fallback invocations) may be hashed and stored in a tamper-proof, append-only log (e.g., using Merkle structures or blockchain). This may enable traceability and regulatory auditing.

In some examples, the final decision may be traced back via an explainability module that logs node activation, rule matches, and confidence levels. This module may generate a compact rationale graph on demand.

For example, the application of quantum-assisted or quantum-inspired optimization methods may enable near real-time optimization of computing resource allocation, even in the presence of complex non-linear constraints and distributed AI workloads. This may allow the AI-system to adapt resource usage efficiently under rapidly changing load conditions, achieving improved responsiveness and energy efficiency compared to traditional heuristic or rule-based allocation schemes.

In some examples, the processing circuitry 130 may be further configured to record at least one of the sensor data, computation data, fused data, plurality of control options or determined execution order on a distributed ledger. The distributed ledger may serve as a secure, tamper-resistant, and traceable storage mechanism, ensuring the integrity and auditability of key data used or generated by the AI-system 170. This may support applications in safety-critical, regulatory, or multi-agent environments where trust, verification, and traceability of decision-making and system operation are essential. For example, it may be used to verify why a particular control decision was made, to reconstruct past system states for fault analysis, or to synchronize distributed components in a federated AI deployment.

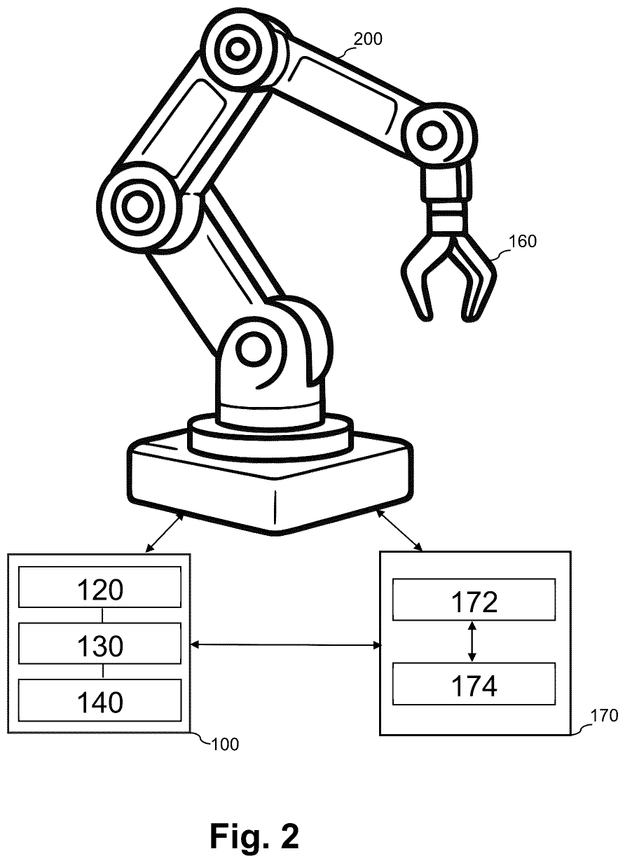

Further details and aspects are mentioned in connection with the examples described below. The example shown in FIG. 1 may include one or more optional additional features corresponding to one or more aspects mentioned in connection with the proposed concept or one or more examples described below (e.g., FIGS. 2-6).

### Example of a Robot

FIG. 2 illustrates an example of the AI-system 170 configured to control a robot 200 as target system. The robot 200 may include the one or more sensors 160 and actuators, and may be controlled by the AI-system 170 as described above. The AI-system 170 comprising the plurality of AI models 172 may be configured to control the robot's behavior by generating control options based on fused data and determining an execution order for those control options using decision data. The AI-system 170 may be implemented within the robot itself, for example as an integrated embedded computing module, or may be external to the robot, communicating with the robot via wired or wireless interfaces. The robot may comprise the one or more sensors such as cameras, LIDAR, IMUs, or tactile sensors and actuators, joint controllers, mobility platforms, and onboard computation units, all of which may participate in data acquisition, processing, and actuation.

The robot 200 may be industrial robotic arm, this is a non-limiting example. The robot may be any robotic systems. For example, the robot may be an arm for precision manufacturing, a mobile service robot for logistics or warehouse automation, an autonomous ground vehicle, a humanoid robot for interactive tasks, a medical robot such as surgical assist devices or rehabilitation platforms, or laboratory automation systems. The robot may incorporate sensors, actuators, and embedded or external processing circuitry to enable real-time interaction with its environment. Accordingly, the representation of a robotic arm in FIG. 2 is intended purely for illustrative purposes and is not limiting of the robot's physical structure, functionality, or application domain.

As described above, the apparatus 100, which comprises interface circuitry 120, processing circuitry 130, and machine-readable instructions stored in memory 140, may be implemented within the robot 200 itself or externally. For example, the AI-system 170 may be embedded in the robot 200 as an onboard computing module or located remotely, such as in an edge device or centralized server, communicating with the robot via wired or wireless interfaces. This configuration allows the AI-system 170 to operate in a distributed, centralized, or hybrid manner, depending on the deployment requirements and available infrastructure. The robot may also utilize shared computing resources such as processing capacity, memory, communication bandwidth, or energy supply, either locally or via a networked infrastructure.

In some examples, the apparatus 100 may be configured to control the robot 200 comprising a plurality of AI models adapted to perform at least one of navigation, object manipulation, and resource optimization tasks based on fused sensor data. The fused data may include spatial, visual, and proprioceptive input used by the AI models to generate control options and adjust execution strategies based on available computing resources of the robotic platform.

In some examples, the AI-system 170 with the plurality of AI models 172 is configured to control the robot. The plurality of AI models 172 comprises at least one of the following: a navigation model, a perception model, a manipulation model, a control optimization model, a reinforcement learning model, a communication model, or a fault detection model. In some examples, the navigation model may be configured to compute a movement trajectory for the robot, based on fused data that integrates spatial sensor data (e.g., LIDAR point clouds, camera feeds, IMU signals) and model outputs such as obstacle maps or localization estimates. The input to the navigation model may include graph-based fused representations or structured feature vectors describing the robot's position and surroundings. The output may include a sequence of waypoints, velocity vectors, or trajectory paths which are interpreted by motion controllers to execute robot movement. The navigation model may consider computing resource data such as available processor power or memory when adapting its path planning strategy, for instance by simplifying route geometry under resource constraints.

In some examples, the perception model may be responsible for interpreting raw or preprocessed sensor data to identify relevant objects, surfaces, or environmental features. The perception model may operate on camera data, LIDAR scans, radar signals, or temperature measurements, and may produce outputs such as object classification scores, segmentation maps, or 3D bounding boxes. These outputs may feed into the fused data generation stage or serve directly as inputs to other AI models, such as the manipulation model or fault detection model. The perception model may be based on a CNN or a transformer-based architecture and may be dynamically adjusted based on resource availability (e.g., by downsampling input images or reducing model depth).

In some examples, the manipulation model may be configured to generate control signals for robot arms, grippers, or other actuators that interact with objects in the environment. The model may receive fused perception data as input, such as object positions and shapes, along with task-specific goals (e.g., grasp location, orientation). Its outputs may include optimal grasp points, joint configurations, or actuator torque profiles. The manipulation model may use data-quality-weighted fusion (e.g., via a Graph Attention Network) to prioritize the most reliable sensor modalities under varying conditions.

In some examples, the control optimization model may be configured to fine-tune or resolve constraints in low-level control actions proposed by other AI models, such as navigation or manipulation models. This model may evaluate control options based on actuator dynamics, energy consumption profiles, or system-level constraints (e.g., joint limits or torque boundaries), and may reparametrize control signals to optimize for smoothness, responsiveness, or power efficiency. The control optimization model may access computing resource data to throttle motor commands or balance actuator load during multi-joint operations, supporting the apparatus's ability to adapt resource usage dynamically.

In some examples, the reinforcement learning model may be configured to adapt the robot's behavior over time based on feedback from task outcomes, environment interaction, or performance signals. The reinforcement learning model may observe decision data including historical success rates, real-time sensor readings, and computation load metrics, and may output adjusted control strategies, updated motion plans, or retraining signals for other AI models. The model may encode a policy function that selects actions (i.e., control options) based on the fused state vector and reward signals, thereby learning optimal behaviors under changing conditions or resource constraints.

In some examples, the communication model may manage data exchange between AI components within the robot or between the robot and external systems, such as cloud-based AI controllers or other robots in a multi-agent environment. The communication model may prioritize or encode sensor data, fused data, or control decisions for transmission based on bandwidth availability and message relevance. It may help ensure reliable coordination in distributed robotic systems, optimizing communication paths under resource-aware constraints such as bus contention or energy limits.

In some examples, the fault detection model may monitor the internal state of the robot, including sensor readings, actuator behavior, and computing resource metrics, to detect anomalies or failures. Inputs to the fault detection model may include fused sensor data, execution outcomes, and historical logs, while outputs may include alert signals, control overrides, or corrective action proposals. The fault detection model may utilize Graph Neural Networks to identify patterns of conflict or inconsistency in sensor and computation data, thereby supporting resilience and safety in robotic operation.

Each of these AI models may contribute to generating control options for the robot, which are evaluated and prioritized based on decision data, and executed with resource allocation guided by current computing resource data. This modular and coordinated use of AI models enables the AI-system to adaptively manage robotic behavior across diverse and dynamically changing operational contexts.

In some examples, the shared computing resources 174 of the AI-system 170, when applied to a robot as the target system 180, may include one or more robot-specific hardware or software components that support the concurrent execution of the plurality of AI models 172. In some examples, the shared computing resources 174 comprise at least one of the following resources of the robot: processing capacity of one or more processing circuitries of the robot, memory usage of one or more memories of the robot, usage of one or more data bus and communication interfaces of the robot, or power supply of a motor controller, an actuator, or robot sensor. These shared computing resources may be integrated into the robotic device and made accessible to the plurality of AI models 172 operating simultaneously to perform navigation, manipulation, perception, control optimization, and other robotic functions. The processing capacity may refer to the available computational throughput of one or more processing circuitries embedded in the robot, such as general-purpose CPUs, GPUs, or specialized AI accelerators mounted on the robot's control board. These processing circuitries may be time-shared or distributed among different AI models depending on real-time computational demands, as described in the general resource adaptation framework.

The memory usage may refer to the dynamic allocation and usage of volatile or non-volatile memory components of the robot, such as DRAM, SRAM, or flash memory, that are accessible to AI models for tasks such as buffering sensor data, storing intermediate model outputs, or maintaining decision-state variables. For example, both the perception and manipulation models may require access to shared memory for storing fused data representations or object maps. The usage of data bus and communication interfaces may refer to internal robot communication pathways, including I²C, SPI, CAN bus, or Ethernet interfaces, which facilitate real-time data transfer between AI models and sensor or actuator subsystems. These shared buses may become a performance bottleneck under high-frequency sensor sampling or large AI inference loads, and thus their bandwidth may be managed and allocated adaptively.

The power supply may refer to the robot's internal energy distribution system that provides electrical power to key components such as motor controllers, actuators, and sensors. This includes the ability to monitor and regulate energy flows to high-power modules (e.g., servo motors) or high-sampling-rate sensors (e.g., LIDAR units), ensuring that energy is prioritized for AI models that are actively driving mission-critical behaviors. For instance, if the robot is performing real-time manipulation, the power supply may be regulated to prioritize torque delivery to actuators while throttling less critical subsystems. In summary, the shared computing resources of the robot may be evaluated and adapted based on computing resource data in accordance with the general method described previously, enabling context-aware, efficient control of the AI-model-driven robotic system.

In some examples, the execution order of the plurality of control options is determined for controlling a robot, wherein each control option corresponds to a proposed robotic action generated by one or more of the AI models 172 of the AI-system 170. As described the above, a control option may be a fully defined or intermediate-level directive for influencing the operational behavior of the target system 180, in this case, the robot. Each control option may be derived from fused data and decision data, and may be prioritized based on contextual criteria such as safety, efficiency, or resource availability. In some examples, the execution order of the plurality of control options is determined for controlling the robot. The control options may comprise at least one of: path planning by the navigation model based on sensor data obstacle avoidance by the navigation model based on real-time proximity sensor data, environmental mapping data, and computing resource constraints, object manipulation by the manipulation model based on perception data, or force control by the control optimization model based on actuator power constraints.

Path planning may be performed by the navigation model and may involve determining an optimal or feasible movement trajectory for the robot based on spatial sensor data such as LIDAR point clouds, GPS data, or fused environmental maps. The control option in this case may specify a sequence of waypoints or a dynamic trajectory to be followed. Obstacle avoidance, also managed by the navigation model, may generate a control option to reroute or adjust motion in response to real-time proximity sensor data (e.g., ultrasonic, infrared), environmental mapping data, and computing resource constraints such as processor load or actuator availability. For example, if computing resource data indicates high system load, the navigation model may propose a simplified path with fewer abrupt turns to reduce computational effort.

Object manipulation, produced by the manipulation model, may include a control option for grasping, moving, or orienting an object, based on fused perception data. This may involve control directives specifying target positions, grip strength, or approach angles, which are adapted to the current scene understanding inferred from camera and depth sensor input. Force control, issued by the control optimization model, may include control options that regulate actuator output parameters such as torque or motor currents. These control options are generated with consideration of actuator power constraints, including real-time energy availability or motor temperature, as derived from computing resource data.

Each of these control options, though targeting distinct robotic functions, is subject to evaluation and prioritization by the processing circuitry 130 using decision data, in accordance with the general mechanism for determining execution order. This ensures that actions are performed in a context-aware and resource-optimized manner, particularly in dynamic or constrained robotic environments.

In some examples, the navigation model is configured to determine a movement trajectory of the robot based on fused sensor data, wherein determining the movement trajectory comprises adapting speed and direction. For example. fused data, generated by integrating heterogeneous sensor inputs such as LIDAR, camera, GPS, and inertial measurements, may be provided to the plurality of AI models, including the navigation model, for downstream control decision-making. For example, the movement trajectory may refer to a planned or optimized path through space that the robot is intended to follow, typically represented as a sequence of poses or waypoints over time. The fused sensor data used as input allows the navigation model to form a consistent and reliable understanding of the robot's current position, environmental features, and dynamic obstacles, thereby enabling accurate motion planning. The navigation model processes this data to compute a trajectory that satisfies task-specific goals, such as reaching a destination or covering an area, while also adapting to contextual constraints.

Adapting speed and direction within the determined movement trajectory means that the model may select a geometric path but also adjusts velocity profiles along this path based on environmental and internal conditions. For example, if proximity sensors detect nearby obstacles, the navigation model may slow down or alter the robot's course to ensure safe traversal. Similarly, if computing resource data indicates processor overload or low battery levels, the navigation model may reduce motion speed to conserve energy or minimize computation.

By leveraging fused sensor data, the navigation model can dynamically adjust both the spatial path (direction) and temporal pacing (speed) of the robot, yielding a trajectory that is efficient, safe, and contextually aware. This model behavior exemplifies how AI-driven control mechanisms translate perceptual input into actionable motion commands, while adhering to the general principles of data fusion, control option generation, and resource-aware execution as defined in the broader system architecture.

In some examples, the manipulation model is configured to determine an optimal grasping strategy based on fused perception data. This is a specific application of the general concept described in the stored description, wherein fused data, generated by combining sensor data and computation data using methods such as multimodal fusion, GNNs, or transformer-based models, is distributed to the AI models for downstream processing. Here, the manipulation model utilizes the fused perception data to infer physical properties of the environment and objects relevant to robotic manipulation. The fused perception data may comprise integrated outputs from vision sensors (e.g., RGB or depth cameras), tactile or force sensors, and computation data from upstream AI models such as object detection, segmentation, or pose estimation networks. This enriched representation provides the manipulation model with a consistent and context-aware view of the robot's surroundings, enabling it to reason about object geometry, orientation, surface properties, and constraints on available workspace.

Based on this fused input, the manipulation model is configured to generate a grasping strategy, which may include determining grasp points, approach vectors, finger or gripper configurations, and required force levels. The term optimal here implies that the grasping strategy is selected to maximize a performance criterion such as grasp stability, task success probability, energy efficiency, or execution safety, depending on the operational context and decision data available to the AI-system.

For example, if the fused perception data reveals that an object is slippery or unstable, the manipulation model may select a two-handed grasp or adjust the contact force. If computing resource data indicates motor torque limits or power constraints, the model may favor lower-effort grasps. This grasping strategy may be output as a control option to be further evaluated within the execution order determination pipeline, as described in the stored general description. For example, the manipulation model may operate within the general system architecture to transform complex, fused perceptual inputs into actionable control strategies, and how that process is tightly coupled with sensor fusion, control option generation, and resource-aware planning mechanisms.

In some examples, adapting the usage of the shared computing resources of the robot for the execution of the plurality of AI models may comprise dynamically adjusting at least one of: processor capacity allocated to AI models, memory usage assigned for sensor data processing or model execution, bandwidth distribution across data buses and communication interfaces used by the AI models, or power allocation to AI-system components of the robot, based on computing resource data of the AI-system. The computing resource data may comprise at least one of: available processing power, memory availability, communication bandwidth utilization, real-time AI-system load, or task-specific execution priority. As described above, the shared computing resources may include hardware and software components such as processing capacity, memory usage, communication interfaces, and power supply units that are accessible to two or more AI models 172 for supporting their concurrent operation. For example, these resources may be physically integrated into the robotic platform and include, for example, the processing capacity of on-board processors (e.g., embedded CPUs, GPUs, or AI accelerators), memory used for sensor data processing or inference tasks, internal data buses (e.g., CAN, SPI, or I²C) used to connect subsystems, and power supply circuits that provide energy to AI-system components embedded in the robot. The adaptation of these shared computing resources, as described above, is performed by the processing circuitry 130 based on received computing resource data and may be dynamically adjusted to support efficient and robust AI model execution within the constraints of the robot's operational context.

In some examples, adapting the usage of the shared computing resources may comprise dynamically adjusting the processor capacity allocated to AI models. This may involve distributing available processor cycles or hardware thread resources among multiple concurrently executing models such as a navigation model, a perception model, or a manipulation model. For instance, when the robot enters a complex manipulation phase, more processing power may be assigned to the manipulation model to handle real-time trajectory generation and force feedback control, while background processes may be temporarily deprioritized. The adjustment may be performed based on real-time AI-system load or priority derived from decision data, as described above.

In some examples, adapting the usage may comprise adjusting memory usage assigned for sensor data processing or model execution. For instance, during periods of high sensory input (e.g., simultaneous use of LIDAR, camera, and force sensors), the memory allocation for the perception model and sensor fusion components may be increased, allowing sufficient buffer space for preprocessing or inference. Conversely, when sensor input becomes sparse or low-frequency, memory resources may be reclaimed and redirected to support planning or learning tasks. Such dynamic allocation ensures memory efficiency and avoids overloads that could interrupt real-time control loops.

In some examples, adapting the usage may comprise adjusting bandwidth distribution across data buses and communication interfaces used by the AI models. Robots often rely on shared internal buses to transfer control data, sensor signals, and inference results between system components. When a perception model requires high-throughput data transfer from high-frame-rate cameras or depth sensors, bandwidth may be preferentially allocated to support these flows, while reducing the update rate for less critical telemetry or diagnostics. The processing circuitry 130, as described above, may monitor bus contention and allocate channel usage to maintain system responsiveness and low-latency communication for time-critical components.

In some examples, adapting the usage may comprise adjusting power allocation to AI-system components of the robot. This may include regulating power distribution to internal components of the AI-system, such as AI accelerators, embedded microcontrollers, and sensor fusion modules. In some cases, this may also involve indirectly influencing energy use by adjusting actuator-related commands issued by the AI models, especially when such actuators are powered through the same regulated power infrastructure. For example, a manipulation model may issue torque commands to a gripper motor, and the power consumption of this actuator may be modulated based on available energy or priority levels. Components such as motor controllers for wheel or arm actuation, sensors such as high-power LIDAR units, or internal fans may be selectively throttled, prioritized, or suspended to match the power budget determined by the processing circuitry. This mechanism directly connects to the earlier described concept of adaptive power allocation within the shared computing resources of the AI-system, while still enabling influence over the energy usage of critical components of the target system.

The computing resource data guiding these adaptations may include multiple indicators of the current AI-system status. Available processing power may refer to real-time CPU or accelerator load metrics, which inform how much computation can be redirected without causing latency or stalling effects. For example, if inference latency increases beyond a threshold, models may be scheduled less frequently or run with simplified configurations. Memory availability may include measurements of buffer usage, heap fragmentation, or current memory headroom, used to throttle or permit additional model instances. Communication bandwidth utilization may be tracked by monitoring data transfer rates or contention levels on internal communication buses and network interfaces, guiding adjustments to communication-heavy AI models. Real-time AI-system load may represent an aggregated view of current resource usage, integrating processing, memory, and I/O demand to support holistic decisions. Task-specific execution priority may refer to metadata or decision data indicating the current operational importance of each model—e.g., giving navigation and obstacle avoidance higher priority during motion, while suppressing learning models to conserve resources.

Each of these computing resource data points corresponds to indicators and analysis mechanisms described above in the detailed description, where the processing circuitry 130 evaluates these data streams to enable context-aware, adaptive allocation of the AI-system's computing infrastructure. In robotic systems, this allows the apparatus 100 to ensure safe, efficient, and goal-aligned operation, even under resource-constrained or rapidly changing conditions.

In some examples, the execution order of the plurality control options is determined by a reinforcement learning model which is configured to adapt the robot's behavior over time by updating motion planning and interaction strategies based on the decision data. The decision data may comprise at least one of historical performance data, task success rates, AI-system load, available processing power, energy consumption metrics, or external reinforcement signals. The reinforcement learning model may be implemented as a policy network or value function estimator that maps environmental states, including computing resource conditions, to control actions or execution sequences that maximize a cumulative reward. In the context of a robot, this reward may encode factors such as task efficiency, motion smoothness, system responsiveness, energy conservation, or mission success. The decision data serving as input to the reinforcement learning model may include various robot-specific metrics. For instance, historical performance data may represent logs of previous motion sequences, including their energy cost, success rate, or latency, allowing the model to favor control options that previously led to optimal system behavior. Task success rates may quantify how often particular actions or strategies achieved their intended outcomes, providing a statistical basis for updating the model's control preferences. AI-system load and available processing power may reflect the current computational headroom of the robot's hardware platform; for example, when load is high, the model may learn to deprioritize complex planning operations or reduce update frequencies in favor of leaner behaviors. Energy consumption metrics provide feedback about how different control options impact battery drain, actuator efficiency, or thermal stability, guiding the model to develop energy-aware policies over time.

Furthermore, external reinforcement signals may be used to encode success or failure outcomes, whether derived from human feedback, mission state monitoring, or autonomous self-evaluation modules. These signals allow the reinforcement learning model to incrementally refine its decision-making process, continuously learning which control option execution orders yield the best trade-offs between behavior quality and resource usage. For example, in a mobile robot tasked with object retrieval, the reinforcement learning model may learn that executing a grasping control option before re-localizing improves success probability when system load is high. Over time, the model may generalize these adaptations to other scenarios, producing execution orders that are not only task-effective but also resource-efficient. This approach supports long-term autonomy and robust adaptation to fluctuating internal states, in line with the architecture and optimization principles described in the general framework.

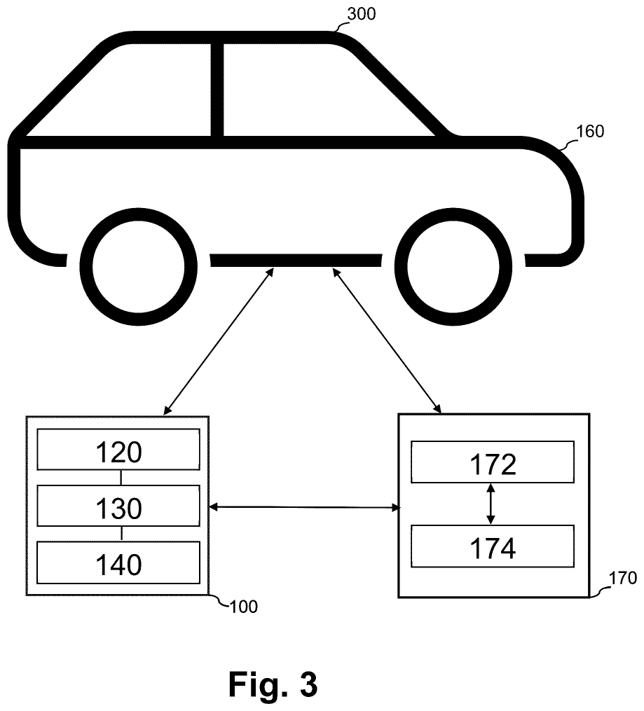

Further details and aspects are mentioned in connection with the examples described above or below. The example shown in FIG. 2 may include one or more optional additional features corresponding to one or more aspects mentioned in connection with the proposed concept or one or more examples described above (e.g., FIG. 1) or below (e.g., FIGS. 3-6).

### Example of an Autonomous Vehicle

FIG. 3 illustrates an example of the AI-system 170 configured to control a vehicle 300 as the target system. The vehicle 300 may comprise the one or more sensors 160 and actuators, and may be controlled by the AI-system 170 as described above. The AI-system 170 comprising the plurality of AI models 172 may be configured to control the vehicle's behavior by generating control options based on fused data and determining an execution order for those control options using decision data. The AI-system 170 may be implemented within the vehicle itself, for example as an embedded automotive computing platform, or may be located externally, such as in a remote supervisory unit or a cloud-based AI-service, communicating with the vehicle via wired or wireless interfaces. The vehicle may include sensors such as LIDAR, radar, cameras, GPS, IMUs, and wheel encoders, as well as actuators for throttle, braking, and steering, and Electronic Control Units (ECUs) for various subsystems. These components may participate in data acquisition, processing, and control actuation.

The vehicle 300 may be an autonomous vehicle, a robotaxi, or any other form of automated or semi-automated driving platform as. The vehicle may include but is not limited to autonomous cars, delivery robots, agricultural machinery, drones, or ground-based transport robots. The vehicle may be designed for personal transportation, industrial logistics, fleet-based operations, or other forms of autonomous or semi-autonomous navigation in indoor or outdoor environments. It may incorporate sensing and control systems configured to interpret the environment, execute motion plans, and react to dynamic scenarios. The vehicle 300 shown in FIG. 3 is therefore intended purely as an illustrative example and is not limiting of the vehicle's physical configuration or application context.

As described above, the apparatus 100, which comprises interface circuitry 120, processing circuitry 130, and machine-readable instructions stored in memory 140, may be implemented within the vehicle 300 or externally. The AI-system 170 may reside locally on the vehicle or externally in a distributed or centralized architecture, communicating via secure interfaces. This flexibility supports a wide range of deployment scenarios and enables efficient use of shared computing resources such as processor capacity, memory, communication bandwidth, or power supply, whether embedded within the vehicle or provisioned via a connected infrastructure.

The AI-system 170 comprising the plurality of AI models 172 may be configured to control the vehicle's behavior by generating control options based on fused data and determining an execution order for those control options using decision data. The AI-system 170 may be implemented within the vehicle, for example in the form of an embedded automotive computing platform, or external to the vehicle, such as in a remote supervisory control unit or cloud-based AI-service that communicates with the vehicle via wired or wireless interfaces. The vehicle may comprise the one or more sensors including but not limited to LIDAR units, radar sensors, cameras, GPS modules, and IMUs, as well as actuators for throttle, braking, and steering, and Electronic Control Units (ECUs) for subsystems such as perception, motion control, and power management. These components may participate in data acquisition, processing, control actuation, and computation offloading, and may serve as sources or targets of the control options and computing resource data within the AI-system.

In some examples, the AI-system 170 with the plurality of AI models 172 is configured to control the vehicle. The plurality of AI models 172 may comprise at least one of the following: a navigation model, a perception model, a path planning model, a trajectory control model, a reinforcement learning model, a communication model, or a fault detection model. In some examples, the navigation model is configured to determine the vehicle's high-level motion strategy based on a combination of fused sensor data and map-based context. The input to the navigation model may include real-time fused data derived from sensor modalities such as camera, LIDAR, radar, and GPS, as well as outputs from other AI models such as perception or localization modules. The output of the navigation model may include a planned route or desired driving corridor encoded as a set of waypoints, road segment selections, or semantic driving instructions (e.g., “turn left at intersection,” “merge onto highway”). The navigation model may be implemented using RNNs, transformers, or GNNs when contextual map data or dynamic environmental graphs are involved. The model may also incorporate decision data, such as traffic rules or road priority constraints, when generating navigation directives.

In some examples, the perception model may be responsible for interpreting the raw sensor data from the vehicle's sensor suite. Inputs may include camera data, LIDAR point clouds, radar reflections, and optionally infrared or ultrasonic signals. The perception model may be based on CNNs or transformer-based architectures, capable of producing a range of outputs, such as object classification (e.g., identifying vehicles, pedestrians, signs), semantic segmentation (e.g., distinguishing road boundaries, sidewalks), and depth estimation. The perception model may generate intermediate computation data, such as bounding boxes, occupancy grids, or risk maps, which are used by downstream AI models like the path planning or trajectory control models. The perception model may also adapt its processing complexity based on computing resource data, for example by downsampling input images under processor load constraints.

In some examples, the path planning model is configured to generate feasible driving paths for the vehicle within the boundaries set by the navigation model and according to real-time perception outputs. Inputs to the path planning model may include fused environmental representations (e.g., obstacle locations, road geometry), dynamic object predictions, traffic constraints, and decision data such as route goals or vehicle state. The output of the model may include a candidate path represented as a time-stamped trajectory or a sequence of spatial-temporal control directives. The path planning model may leverage graph search methods, optimization solvers, or neural network-based planners, and may operate under computing resource constraints, modifying path complexity or planning horizon based on available processor and memory capacity.

In some examples, the trajectory control model translates planned paths into actionable control commands by computing vehicle dynamics such as steering angle, acceleration, braking, and throttle. The model receives as input the path generated by the path planning model, along with fused sensor data (e.g., vehicle pose, speed, road curvature) and real-time actuator feedback. The output comprises low-level control signals sent to the vehicle's Electronic Control Units (ECUs), such as wheel torque, steering motor commands, or brake pressure settings. The trajectory control model may also monitor vehicle-specific constraints, such as wheel slip, maximum curvature, or actuator latency, and adjust control signals accordingly to ensure safe execution. Reinforcement learning or control optimization techniques may be used to minimize energy consumption, enhance stability, or improve passenger comfort.

In some examples, a reinforcement learning model may be configured to adapt the vehicle's control policies over time by learning from interaction with the environment or from performance feedback. The input to the model may include historical decision outcomes, driving task success rates, real-time fused state representations, and computing resource data such as system load or actuator constraints. The reinforcement learning model may output adjusted parameters for path planning or control models, behavioral strategies (e.g., lane selection under congestion), or retraining signals to improve long-term policy effectiveness. This model may encode a policy function mapping fused environmental states to control actions, with the objective of maximizing a cumulative reward signal incorporating safety, efficiency, comfort, and energy use.

In some examples, the communication model may manage the transmission of data between the vehicle and external systems, including cloud-based traffic services, infrastructure nodes, or other nearby vehicles in a Vehicle-to-Everything (V2X) context. Inputs may include sensor data, control decisions, or fused data marked as relevant for transmission. The communication model may prioritize data packets based on urgency, available bandwidth, or system relevance, and may encode messages to optimize latency and reliability. For example, in a scenario involving multi-agent coordination (e.g., platooning), the model may determine which control options or perceptions should be broadcast to other vehicles. The communication model may also handle data reception from external sources and integrate them into the fused data pipeline.

In some examples, the fault detection model may monitor the health and consistency of the vehicle's internal subsystems, including sensors, actuators, and computing components. The model receives fused sensor data, actuator feedback, and computation data from other AI models as input. Outputs may include diagnostic alerts, fault codes, or mitigation control options such as mode switching or safe stopping. The fault detection model may be implemented using statistical methods, anomaly detection algorithms, or GNN-based architectures that identify inconsistent or abnormal patterns in multi-modal data streams. This model supports fail-operational behavior by ensuring that faults are detected early and responded to in a structured, safety-aware manner.

Each of these models may contribute computation data to the fused data generation process, participate in the formation of control options, and utilize shared computing resources 174 in alignment with the general architecture described above. The models operate cooperatively within the AI-system 170 to enable real-time, robust, and adaptive control of the vehicle as the target system 180.

In some examples, the shared computing resources may comprise at least one of the following resources of the vehicle: processing capacity of one or more processing circuitries of the vehicle, memory usage of one or more memories of the vehicle, usage of one or more data bus and communication interfaces of the vehicle, or power supply of a sensor suite, an electronic control unit (ECU) or an actuator. For example, when the target system 180 is a vehicle, the shared computing resources 174 of the AI-system 170 may be implemented using one or more components of the vehicle's onboard infrastructure that support the concurrent or coordinated execution of the plurality of AI models 172. The computing resources 174 may be accessible to two or more of the AI models 172 and may be dynamically allocated or adapted based on computing resource data, as described above. In some examples, the shared computing resources may comprise the processing capacity of one or more processing circuitries embedded within the vehicle. These may include general-purpose CPUs, dedicated GPUs, digital signal processors (DSPs), or specialized AI accelerators integrated into the vehicle's central computing platform or distributed across Electronic Control Units (ECUs). These processing units may be time-shared among the plurality of AI models 172, enabling the navigation model, perception model, path planning model, or other models to execute in parallel or according to a prioritized schedule. As described in the stored detailed description, shared processor capacity may be adapted in response to computing resource data such as processor load, execution deadlines, or model importance, to ensure efficient and responsive AI behavior.

In some examples, the shared computing resources may comprise memory usage of one or more memory modules installed in the vehicle. These may include volatile memory such as DRAM or SRAM used for runtime inference buffers and intermediate representations, and non-volatile memory such as flash storage for model parameters or fused data logs. Multiple AI models may access common memory regions to read fused sensor data, write computation data, or exchange intermediate results. For example, the perception model and path planning model may both use a shared memory buffer to store semantic maps or object localization grids. The memory usage may be monitored and adapted based on computing resource data indicating saturation levels, buffer overflows, or access contention, ensuring memory efficiency across all concurrently operating AI models.

In some examples, the shared computing resources may include usage of the vehicle's internal data communication infrastructure, such as CAN bus, FlexRay, Automotive Ethernet, or SPI/I²C interfaces. These interfaces enable data transfer between sensor units, processing nodes, actuators, and AI models. For instance, fused data generated by the processing circuitry 130 may be transmitted via an internal data bus to AI models running on separate ECUs. As detailed in the general description, the communication bandwidth of such buses is a limited shared resource and may be subject to congestion under high data throughput scenarios (e.g., during simultaneous high-resolution image and LIDAR stream processing). The AI-system 170 may adapt usage of these communication channels by throttling message frequency, compressing data, or adjusting model scheduling based on communication-related computing resource data.

In some examples, the shared computing resources 174 may include the vehicle's internal power supply infrastructure that delivers electrical energy to various components including the sensor suite (e.g., LIDAR, radar, cameras), ECUs, and actuators (e.g., steering motors, brake controllers, throttle modules). These components may draw power from common regulated sources such as a vehicle battery or energy distribution bus. Since energy consumption is a critical constraint in electric vehicles or autonomous platforms, power allocation may be managed across subsystems based on computing resource data such as battery state, power usage trends, or actuator constraints. For example, the AI-system may reduce power delivered to a rear camera during idle driving conditions or prioritize actuator power delivery to support emergency braking. These adaptation mechanisms align with the general architecture for computing resource-aware control described previously.

In some examples, the execution order of the plurality of control options may be determined for controlling the vehicle. The control options may comprise at least one of: path planning by the navigation model based on perception data, obstacle avoidance by the navigation model based on real-time LIDAR, radar, and camera sensor data; adaptive speed control by the trajectory control model based on traffic conditions and computing resource constraints, or braking control by the control optimization model based on vehicle dynamics and actuator constraints. As described above, the control option may be a proposed action or system directive generated by one or more of the AI models 172, based on fused data and decision data, which is intended to influence the behavior of the target system, that is the vehicle. For example, the control options may be vehicular functions such as movement, navigation, obstacle avoidance, or speed regulation, and may be generated by AI models such as the navigation model, trajectory control model, or control optimization model.

The execution order of the control options may be determined by the processing circuitry 130, based on criteria derived from decision data, which may include task priority, predicted outcomes, safety constraints, or computing resource data such as actuator limits or processor availability. As detailed above, this prioritization mechanism allows the AI-system 170 to select and sequence actions that are optimal for the vehicle's current operational context, ensuring safe and efficient control even under dynamically changing conditions.

In some examples, the navigation model may be configured to perform path planning, which involves computing a route or trajectory that the vehicle should follow to reach a destination. The perception data, which may be part of the fused data, includes processed outputs from vision systems, LIDAR, and radar sensors, such as object detections, free space estimations, and semantic segmentation maps. The navigation model may generate a control option that defines a sequence of waypoints, lane change strategies, or global path layouts that conform to road rules, traffic flow, and dynamic obstacles. The generated control option may include metadata such as predicted traversal time, energy cost, or confidence level, which can be used during execution order determination. If traffic congestion is detected via perception inputs, the navigation model may generate an alternative route with adjusted priority, allowing the processing circuitry to select the most context-appropriate path plan for execution.

In some examples, the navigation model may also be configured to generate obstacle avoidance control options based on real-time sensor input from multiple modalities, including LIDAR, radar, and camera data. These control options may involve local motion adjustments, lane shifts, or temporary slowdowns to prevent collisions with dynamic or static obstacles. The control options are typically generated in short time intervals and are highly latency-sensitive. Given the real-time nature of the sensor inputs, these control options may be prioritized in the execution order if immediate threats are detected (e.g., pedestrian crossing or sudden appearance of debris). The decision data used to evaluate this control option may include proximity metrics, sensor confidence scores, or risk estimation values. Additionally, computing resource data such as sensor interface bus bandwidth or real-time AI-system load may influence whether the obstacle avoidance option can be executed with full sensor resolution or with approximate estimations.

In some examples, the trajectory control model may generate a control option related to adaptive speed control, wherein the vehicle's velocity is modulated in response to detected traffic conditions, such as congestion, following distance, speed limits, and anticipated stops. These inputs may be part of the fused data, integrating sensor readings, external infrastructure signals, or predictions from reinforcement learning models. This control option may be adapted based on computing resource constraints. For example, when processor load is high or energy budgets are limited (as identified through computing resource data), the trajectory control model may simplify its predictions or reduce control update frequency. The processing circuitry 130 may evaluate the adaptive speed control option based on resource-aware feasibility, and assign it lower or higher execution priority depending on system load, urgency, and safety impact.

In some examples, the control optimization model may generate braking control options based on dynamic parameters such as vehicle speed, mass, road gradient, and curvature, as well as actuator constraints, including braking system power limits, wear status, or thermal conditions. This model may refine or adjust braking directives originally proposed by higher-level planning models, ensuring they are executable within physical and safety limits. These control options may be assigned high execution priority if the decision data indicates a need for rapid deceleration (e.g., approaching obstacle, stop sign, or pedestrian zone). At the same time, computing resource data such as actuator status, battery availability, or sensor sampling rates may determine whether full braking capacity can be safely applied or whether a graduated braking profile should be selected. The control optimization model may generate alternative braking trajectories accordingly, enabling the processing circuitry 130 to evaluate the trade-offs and finalize the execution order.

In some examples, the navigation model may be configured to determine a driving trajectory of the vehicle based on fused sensor data. Determining the driving trajectory may comprise dynamically adjusting speed, acceleration, and lane positioning based on environmental conditions and traffic flow. The fused sensor data may comprise an integrated representation of environmental perception obtained by combining data from multiple vehicle-mounted sensors, such as LIDAR units, radar sensors, optical or infrared cameras, GPS receivers, and inertial measurement units (IMUs). The generation and distribution of this fused sensor data have been described above, and may involve the use of multimodal fusion techniques, transformer-based models, or GNNs, which allow the AI-system to capture spatial, temporal, and semantic dependencies across diverse data sources.

The navigation model may receive this fused data as input, structured for example as a tensor-based environmental map, a graph-based situational model, or a sequence of time-aligned feature vectors. The model may use this information to infer the current position and orientation of the vehicle, recognize road geometry, detect drivable areas, and identify dynamic elements such as other vehicles, pedestrians, or lane markings. Based on this contextual input, the navigation model may compute a driving trajectory, which refers to a time-parametrized sequence of planned positions and orientations that the vehicle should follow to reach a goal location while complying with traffic rules and ensuring safety.

Determining the driving trajectory may comprise dynamically adjusting vehicle speed, acceleration, and lane positioning. For example, if the fused data reveals congestion ahead through radar-based velocity vectors of nearby vehicles and vision-based lane occupancy detection, the navigation model may reduce the target speed and trigger a lane change. If LIDAR and camera fusion indicates a static obstacle in the lane, the trajectory may be curved around the object. Adjustments in acceleration profiles may also be made in response to downhill or uphill gradients inferred from fused IMU and GPS data. Similarly, lateral positioning within a lane may be adapted based on road curvature and real-time lane boundary confidence derived from camera-based perception.

The output of the navigation model may include a set of waypoints, each annotated with expected speed, orientation, and acceleration values, or a trajectory polynomial that can be passed to the trajectory control model or vehicle actuation layer. This output may be provided as one control option among a plurality of generated control options, as described above. The execution order of such control options may then be determined based on decision data, including traffic priority, passenger comfort requirements, and real-time computing resource constraints.

In some examples, adapting the usage of the shared computing resources for the execution of the plurality of AI models in the vehicle may comprise dynamically adjusting at least one of: processing capacity of one or more processing circuitries of the vehicle allocated to AI model execution, memory usage of one or more memories of the vehicle used for sensor fusion or model inference, bandwidth usage of one or more data bus and communication interfaces of the vehicle used by the AI models, or power supply allocation to a sensor suite, an electronic control unit (ECU), or an actuator controlled by the AI-system, based on computing resource data of the AI-system. The computing resource data may comprise at least one of: available processing power, memory availability, communication bandwidth utilization, real-time AI-system load, or task-specific execution priority. In some examples, dynamically adjusting the processing capacity of one or more processing circuitries of the vehicle allocated to AI model execution may refer to redistributing or throttling processor workloads to manage the real-time execution of AI models, such as perception or path planning models. For instance, if traffic scene complexity increases and the perception model requires more computational throughput, additional processing threads or core affinity may be reallocated from non-critical models to support timely inference. This adaptation ensures that high-priority AI models maintain performance even under constrained computing conditions, as described above.

In some examples, adjusting the memory usage of one or more memories of the vehicle used for sensor fusion or model inference may involve allocating additional RAM or cache to specific AI models that process large data volumes, such as fused LIDAR-camera inputs. For example, when an AI model fuses real-time LIDAR and radar data for obstacle detection, the memory requirements may spike. The apparatus may respond by reallocating memory from idle or background models to the fusion module, supporting uninterrupted and efficient inference, in accordance with the mechanisms outlined above for dynamic memory allocation among AI models.

In some examples, bandwidth usage of one or more data bus and communication interfaces of the vehicle used by the AI models may be dynamically adapted to prioritize transmission of critical data between AI modules and vehicle components. For example, sensor data from a front-facing camera used for adaptive cruise control may be prioritized over lower-frequency data streams such as rear parking sensors. This adjustment of communication bandwidth, also described above, enables efficient use of shared vehicular communication interfaces under bandwidth constraints, ensuring responsiveness for time-sensitive tasks.

In some examples, adapting the power supply allocation to components such as a sensor suite, an electronic control unit (ECU), or an actuator controlled by the AI-system may involve selectively regulating the energy provided to AI-relevant subsystems. For instance, the AI-system may increase power to a high-resolution LIDAR sensor or camera suite during complex traffic scenes to enhance situational awareness, while simultaneously reducing power to non-critical ECUs. Similarly, in an energy-constrained state, power to actuators involved in lane-keeping assistance (e.g., steering motors) may be maintained, while less urgent systems such as cabin climate control ECUs are downregulated. This behavior, as described above in relation to power supply adaptation, supports power-aware AI operation within the vehicle.

The adaptation of these computing resources may be based on the computing resource data of the AI-system 170. In some examples, available processing power refers to real-time information about the computational headroom of processors used by the AI-system, such as CPU utilization, GPU load, or idle core availability. For instance, if available processing power drops below a threshold, the system may offload lower-priority model computations or reassign core usage, as described above.

Memory availability may refer to dynamic metrics on the free or reserved memory capacity accessible to the AI models, such as heap space or cache size. If memory availability is constrained due to concurrent AI model execution, the system may reduce memory buffer sizes for background models, or serialize input data for memory-efficient processing.

Communication bandwidth utilization may refer to the current usage level of vehicular communication interfaces, such as CAN or automotive Ethernet, and may influence which AI models are permitted to transmit data or synchronize across buses. If bandwidth utilization approaches saturation, models transmitting low-urgency or redundant information may be rate-limited, as described in the general framework.

Real-time AI-system load may capture the combined operational demands placed on the AI-system at a given time, including inference latency, parallel model execution, and data fusion throughput. Based on this data, the system may delay the execution of non-urgent models or deactivate optional modules until load conditions stabilize.

Task-specific execution priority may refer to an assigned importance level for a given AI model or control function under current operational goals. For instance, under emergency braking, perception and control models may be given higher execution priority than mapping or logging models. These priorities may inform how processor time, memory, and power are allocated across the system.

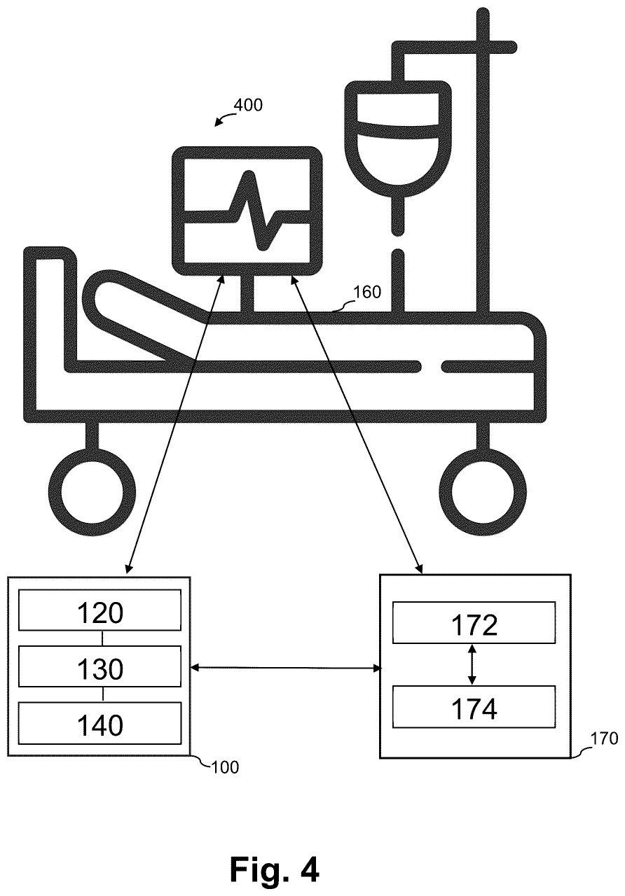

Further details and aspects are mentioned in connection with the examples described above or below. The example shown in FIG. 3 may include one or more optional additional features corresponding to one or more aspects mentioned in connection with the proposed concept or one or more examples described above (e.g., FIGS. 1-2) or below (e.g., FIG. 4-6).

### Example of a Medical System

FIG. 4 illustrates an example of the AI-system 170 configured to control a medical system 400 as the target system, such as an intensive care unit (ICU) or a mobile diagnostic platform. The medical system 400 may include one or more sensors 160 and actuators, and may be controlled by the AI-system 170 as described above. The AI-system 170 comprising the plurality of AI models 172 may be configured to control medical system behavior by generating control options based on fused data and determining an execution order for those control options using decision data. The AI-system 170 may be implemented within the medical system itself, for example as an embedded diagnostic controller or patient monitoring module, or it may be located externally, such as in a hospital server, cloud platform, or clinical AI backend, communicating with the medical system via wired or wireless interfaces. The medical system may include sensors such as ECG electrodes, blood pressure monitors, pulse oximeters, temperature sensors, or infusion pump telemetry, and actuators such as automatic drug dispensers or ventilator settings adjusters. These components may participate in continuous patient monitoring, data processing, alert triggering, and therapeutic actuation.

The medical system 400 shown in FIG. 4 represents a non-limiting example of such healthcare-related applications. For example, the medical system may be a patient monitoring system, a diagnostic imaging suite, a mobile diagnostic unit, or an integrated therapeutic platform deployed in clinical, ambulatory, or emergency response environments. The medical system may, for example, be a hospital-based intensive care unit (ICU) equipped with real-time monitoring and alerting infrastructure, a radiology workstation used for interpreting imaging studies such as CT, MRI, or ultrasound scans, or a portable diagnostic kit used in field medicine, home-based care, or paramedic vehicles. The AI-system 170 comprising the plurality of AI models 172 may be configured to control the behavior of the medical system by generating control options based on fused data and determining an execution order for those control options using decision data. The AI-system 170 may be implemented within the medical system, for example as part of an embedded medical AI module integrated into imaging or monitoring equipment, or external to the medical system, such as in a centralized hospital server or cloud-based medical inference engine that communicates with the system via wired or wireless medical communication interfaces. The medical system may comprise one or more sensors, including but not limited to electrocardiogram (ECG) sensors, blood pressure monitors, pulse oximeters, capnography sensors, laboratory analyzers, and imaging devices such as MRI or CT scanners, as well as actuators for infusion pumps, ventilation systems, neuromodulation devices, or robotic-assisted therapy systems. These components may participate in data acquisition, physiological signal interpretation, image processing, therapy execution, and computation offloading, and may serve as sources or recipients of fused data, decision data, or computing resource data within the AI-system.

The illustrated configuration in FIG. 4 is provided merely for illustrative purposes and does not limit the physical design, scope, or domain of the medical system controlled by the AI-system 170.

As described above, the apparatus 100, which comprises interface circuitry 120, processing circuitry 130, and machine-readable instructions stored in memory 140, may be implemented either within the medical system 400 or externally. The AI-system 170 may reside in an onboard module embedded in a bedside monitoring device, or it may be hosted remotely in a networked clinical decision support system, with secure connectivity to patient-side components. This flexible configuration supports real-time analytics, remote diagnostics, and adaptive therapy, and allows for efficient use of shared computing resources such as processor capacity, memory, bandwidth, or power, whether deployed in centralized hospital infrastructures or distributed edge environments.

In some examples, the apparatus 100 may be applied within a medical system 400 comprising a plurality of AI models configured to process fused physiological and environmental data to perform diagnostics, continuous patient monitoring, or dynamic therapy adaptation. The AI models may operate locally or remotely and may use decision data to determine execution order of control actions such as alarm generation, dosage regulation, or system prioritization.

In some examples, the AI-system with the plurality of AI models may be configured to control a medical system. The plurality of AI models may comprise at least one of the following: a diagnostic model, a patient monitoring model, a medical image processing model, a therapy planning model, a communication model, or a fault detection model. In some examples, the AI-system 170 with the plurality of AI models 172 may be configured to control a medical system by processing sensor data and computation data to generate control options, which may be evaluated based on decision data to prioritize execution under varying medical and computational conditions. The medical system may comprise a variety of components such as monitoring sensors, imaging devices, therapeutic actuators, or mobile diagnostic units, and the AI models may be configured to handle domain-specific tasks using the computing infrastructure and resource adaptation strategies described above.

The diagnostic model may be configured to analyze fused data derived from heterogeneous sensor inputs and AI model outputs to identify the presence or likelihood of a medical condition. The input to the diagnostic model may include fused sensor data comprising physiological measurements such as ECG, blood pressure, or temperature, as well as image features from diagnostic imaging modalities like CT, MRI, or ultrasound, potentially fused using a Graph Neural Network (GNN) or transformer-based model. Computation data from other models, such as anomaly flags or prior risk scores, may also serve as input. The output of the diagnostic model may be a classification or probabilistic prediction of one or more medical conditions, optionally annotated with confidence scores or priority levels for follow-up actions. The model may utilize convolutional neural networks (CNNs) for imaging features or transformer-based fusion mechanisms to combine signal and image data into a unified representation for diagnostic inference.

The patient monitoring model may be responsible for continuously interpreting real-time sensor data streams to track physiological status, detect anomalies, and maintain situational awareness. The input to this model may include streaming time-series data from sensors such as pulse oximeters, capnography sensors, temperature probes, and other vital sign monitors. The output may comprise alert triggers, physiological trend assessments, or state vectors summarizing current patient health. In some examples, the model may include a threshold-crossing mechanism or neural network-based anomaly detector capable of prioritizing critical deviations in monitored values. This model may rely on adaptive Kalman filters for preprocessing to remove noise and may interact with the fault detection model to escalate emergencies. The patient monitoring model may also provide decision data reflecting patient urgency, which is used in execution order determination and shared resource prioritization.

The medical image processing model may process image data obtained from medical imaging devices such as MRI scanners, CT machines, ultrasound probes, or portable X-ray systems. Its input may include raw or preprocessed images, as well as metadata about the imaging modality or acquisition protocol. The output may include segmentation maps, object detection overlays, image enhancement outputs, or quantitative measurements (e.g., lesion size or organ volume). These outputs may be used to generate fused data or support downstream diagnostic or therapy planning decisions. The model may utilize CNNs or transformer-based vision architectures and may include quality assessment components that evaluate image sharpness or contrast, helping prioritize images based on diagnostic utility or resource constraints.

The therapy planning model may be configured to determine and recommend therapeutic interventions based on patient status, diagnosis, and operational constraints of the medical system. Its input may include fused data describing the patient condition, diagnostic model outputs, historical treatment records, and real-time sensor values. The output may comprise therapy control options such as medication dosage recommendations, stimulation profiles for neuromodulation devices, infusion pump settings, or robotic-assisted therapy parameters. This model may operate under constraints such as drug compatibility, actuator availability, or patient-specific limits, and may utilize reinforcement learning or optimization-based architectures to generate individualized treatment plans. Its outputs may be accompanied by confidence scores and time-sensitivity indicators used in execution order ranking.

The communication model may manage data exchange within the AI-system and between the AI-system and external components of the medical system, including clinicians, monitoring stations, cloud services, or mobile units. The input to the communication model may include sensor data, fused data, control options, and decision data, while its output may consist of prioritized and compressed messages, alerts, or update packets. The communication model may determine which information to transmit, when, and how, based on available bandwidth, task urgency, or message relevance, implementing adaptive prioritization and encoding schemes. In line with the general architecture, the communication model may interact with shared communication interfaces and adapt message scheduling based on computing resource data reflecting bus congestion or energy usage.

The fault detection model may monitor the operational integrity of the medical system and the AI-system by analyzing fused sensor data, model outputs, execution feedback, and historical logs to detect anomalies or failures. Its input may include computation data from other models, control execution feedback, or sensor readings indicating abnormal device behavior. The output may include fault alerts, system degradation scores, or control overrides designed to initiate fallback procedures or request human intervention. The model may use Graph Neural Networks (GNNs) to reason over interdependencies between sensors, actuators, and software components, detecting conflicts or inconsistencies indicative of faults. This model contributes to system robustness and ensures that AI-based medical decision-making operates within safe and verifiable boundaries.

Each of these AI models may contribute to the broader AI-system by generating task-specific outputs that influence the control options and the prioritization of their execution. These models operate on fused data derived from both sensor data and computation data, leveraging shared computing resources such as processor capacity, memory, communication interfaces, and power supply. Their coordination is enabled by the mechanisms described above for decision data processing, computing resource adaptation, and control option evaluation, forming a cohesive system capable of intelligent medical system control.

In some examples, the shared computing resources may comprise at least one of the following resources of the medical system: processing capacity of one or more processing circuitries of the medical system, memory usage of one or more memories of the medical system, usage of one or more data bus and communication interfaces of the medical system, or power supply of imaging devices, monitoring equipment, or mobile diagnostic units. These shared computing resources may be implemented as hardware and/or software-based components, and may include processor capacity, memory, communication interfaces, or energy distribution systems within the medical system. Each of these resources may be dynamically monitored and allocated according to real-time system needs and computing resource data, as described above.

The processing capacity of one or more processing circuitries of the medical system may refer to the aggregate computational throughput made available to the AI-system for executing AI models and associated tasks. This may include general-purpose CPUs embedded in diagnostic equipment, GPUs used for image reconstruction or neural inference, or AI accelerators integrated into wearable monitors or bedside devices. The processing circuitry may be physically distributed across multiple components of the medical system, such as portable diagnostic units, imaging consoles, or real-time monitoring platforms, but made logically available to the AI-system through shared resource management. For example, a diagnostic model and a medical image processing model may share access to the same on-device GPU, executing their respective inference tasks in a time-sliced or priority-based fashion, depending on real-time computational demand and task urgency as reflected in the computing resource data.

The memory usage of one or more memories of the medical system may refer to the allocation and access to volatile or non-volatile memory that is used by the AI models for storing intermediate results, model parameters, data buffers, or fused data representations. Shared memory may reside in local DRAM of an imaging console, embedded SRAM of a mobile diagnostic unit, or centralized RAM of a patient monitoring hub. For example, if a patient monitoring model and a therapy planning model both operate on high-resolution physiological signal data and annotated imaging features, their memory requirements may vary depending on current patient complexity. The processing circuitry 130 may adapt the usage of this memory by assigning buffer space based on memory availability and memory usage metrics in the computing resource data. Efficient sharing of memory resources may prevent overflow, enable low-latency access to shared data, and support parallel inference across multiple AI models.

The usage of one or more data bus and communication interfaces of the medical system may refer to the internal communication infrastructure used to transfer sensor data, model outputs, fused data, and control options between components of the AI-system and the medical system. These communication resources may include shared buses such as CAN, SPI, or I²C in embedded monitoring systems, Ethernet or Wi-Fi interfaces in hospital networks, or wireless protocols used by mobile diagnostic platforms. For example, if a diagnostic model is transmitting a high-resolution segmentation map to a therapy planning unit over a shared network, and simultaneously the patient monitoring model is pushing vital sign updates for real-time alerting, contention may occur on the communication bus. The usage of these shared communication interfaces may therefore be adapted dynamically by prioritizing or rate-limiting messages according to bandwidth utilization and latency indicators within the computing resource data. This enables critical information to be delivered reliably and on time, especially under constrained network conditions.

The power supply of imaging devices, monitoring equipment, or mobile diagnostic units may refer to the electrical energy available to key components of the medical system, which may also be shared by the AI-system for model execution. This includes internal batteries of mobile equipment, centralized power distribution units of stationary diagnostic installations, or regulated supply circuits powering sensors and processors. For example, if the therapy planning model relies on real-time imaging data from an ultrasound probe and high-frequency heart rate data from a wearable monitor, the power demand on both sensors and processing units may spike. In such cases, the processing circuitry 130 may adapt the power allocation among these components, for instance by reducing frame rates of the imaging device or lowering the sampling frequency of less critical sensors, thereby extending operational runtime or avoiding thermal limits. This power adaptation is based on computing resource data such as energy consumption trends, battery state, or real-time AI-system load.

In some examples, the execution order of the plurality of control options may be determined for the medical system, wherein the control options may comprise at least one of: diagnosis suggestion by the diagnostic model based on fused sensor data, anomaly detection by the patient monitoring model based on real-time physiological parameters and computing resource constraints, image enhancement by the medical image processing model based on modality-specific quality indicators, or therapy recommendation by the therapy planning model based on patient status and energy consumption of medical system components. The control options may refer to candidate actions proposed by the plurality of AI models 172 based on fused data, which are then evaluated and prioritized for execution based on decision data and computing resource data. As outlined above, fused data may be generated by the processing circuitry 130 by combining sensor data from one or more sensors and computation data from one or more AI models using statistical, learned, or graph-based fusion techniques. This fused data represents a unified, enriched view of the system state and patient condition and is distributed to the AI models via shared computing resources to inform decision-making. Each AI model may generate control options based on this fused data, and these control options may be executed in a context-sensitive sequence determined by the processing circuitry 130 according to clinical urgency, safety, or resource availability.

In the case of the diagnostic model, the control option may comprise the diagnosis suggestion, which refers to an output indicating a likely medical condition or disease classification derived from the analysis of fused sensor data. This fused data may combine inputs from patient monitoring sensors (e.g., heart rate, temperature, blood oxygen saturation) with outputs from imaging devices (e.g., CT or MRI scans), and may be processed using multimodal data fusion techniques such as transformer-based models or Graph Neural Networks. The resulting fused representation may capture both physiological trends and structural abnormalities, enabling the diagnostic model to generate a control option such as a differential diagnosis, a risk score, or a proposed diagnostic category. This diagnosis suggestion is a control option that may be subject to prioritization, especially in cases where multiple diagnostic possibilities are generated in parallel.

For example, for the patient monitoring model, the control option may comprise anomaly detection, which refers to identifying abnormal or potentially life-threatening changes in real-time physiological parameters. These parameters may include ECG signals, respiratory rate, or blood pressure, and may be acquired from high-frequency sensors connected to the medical system. The fused data used by the patient monitoring model may combine current sensor measurements, temporal trends, and prior outputs from other AI models such as diagnostic predictions. The model may incorporate computing resource constraints into its decision-making by evaluating whether sufficient processing power and communication bandwidth are available to escalate alerts. The resulting control option may be an alert signal, an emergency escalation command, or a request to activate predefined intervention protocols. The execution of this control option may be prioritized based on urgency and resource feasibility, as determined from the decision data.

For example, for the medical image processing model, the control option may be image enhancement, which refers to the transformation or refinement of medical imaging data to improve interpretability, resolution, or signal-to-noise ratio. The fused data input to the image processing model may include raw imaging data from modalities such as X-ray, ultrasound, or MRI, along with metadata about image quality, modality settings, and task-specific requirements. This fused input may be used to produce an enhanced image output (e.g., a contrast-optimized CT slice or a denoised ultrasound scan) which is made available to other AI models such as diagnostic or therapy planning modules. The control option in this case may represent an image post-processing directive (e.g., apply segmentation, upsample scan) and may be prioritized for execution based on modality-specific quality indicators and clinical relevance.

For example, for the therapy planning model, the control option may be a therapy recommendation based on the patient's status and energy consumption of medical system components. The fused data input may include real-time monitoring information, diagnostic model outputs, and system-level resource metrics such as battery state of mobile units or availability of therapeutic devices. Based on this input, the therapy planning model may generate a control option in the form of a treatment suggestion, dosing adjustment, or device activation command. For example, if the system determines that a mobile infusion pump is operating under constrained energy conditions, the model may recommend a modified therapy schedule that optimizes both medical outcomes and resource usage. The processing circuitry may evaluate this control option against others in the control option queue and determine its execution order based on task-specific medical priority and resource constraints.

In some examples, the diagnostic model may be configured to identify a medical condition based on fused data from patient monitoring sensors and imaging devices. As described above in the context of claim 51, The diagnostic model may be one of the plurality of AI models 172 operated within the AI-system 170, and it receives as input fused data generated by the processing circuitry 130. This fused data is created by combining heterogeneous sensor data and computation data using fusion techniques such as statistical data fusion, transformer-based architectures, or Graph Neural Networks (GNNs), as detailed in the general description. The goal of this fusion is to form a unified, context-rich representation of the patient's physiological and diagnostic state that can be effectively used for medical inference.

The patient monitoring sensors may include electrocardiograms (ECG), pulse oximeters, temperature sensors, respiration monitors, and blood pressure sensors, each generating time-series physiological data. Imaging devices may include X-ray machines, ultrasound probes, MRI scanners, or CT scanners that provide high-dimensional spatial or anatomical data. These raw or preprocessed sensor streams are integrated into a fused representation that preserves temporal, spatial, and semantic relationships between the data sources. For example, a transformer-based model may be used to align the time-series signals from physiological monitors with annotated image features extracted from MRI slices, or a GNN may model the interactions between regions of interest in the imaging data and anomalies detected in real-time vital signs.

Once the fused data is constructed and distributed via the shared computing resources 174, the diagnostic model may process this input using an architecture suitable for medical classification or inference, such as a convolutional network for spatial pattern recognition, a recurrent network for temporal correlation analysis, or a multimodal fusion transformer for joint reasoning across modalities. The output of the diagnostic model may comprise a diagnosis suggestion, a probability distribution over diagnostic categories, or confidence-weighted hypotheses related to a specific medical condition. This output constitutes a control option as described above and may be evaluated for execution priority based on decision data and computing resource availability.

The use of fused data from both patient monitoring sensors and imaging devices enables the diagnostic model to detect complex conditions that manifest across different physiological and anatomical dimensions. For example, fused elevated heart rate and temperature readings alongside chest X-ray anomalies may lead to the detection of a pulmonary infection. By leveraging this integrated data view, the diagnostic model supports high-accuracy, resource-aware, and real-time diagnosis, fully aligned with the general mechanisms for control option generation and execution order determination described in the detailed description.

In some examples, the patient monitoring model may be configured to trigger an emergency protocol if a physiological parameter crosses a threshold and sufficient computing resources for alert processing and communication are available. As described above, the patient monitoring model is one of the plurality of AI models 172 operated by the AI-system 170 and may be responsible for continuously analyzing real-time physiological parameters derived from various medical sensors, such as electrocardiograms (ECG), pulse oximeters, blood pressure monitors, and temperature sensors. These sensors generate time-stamped data streams that may be subject to preprocessing steps such as noise reduction or temporal alignment, for instance via an adaptive Kalman filter as discussed in the detailed description. This preprocessed data may then be used to generate fused data that combines multiple sensor readings into a comprehensive representation of the patient's physiological state. The fused data may include correlated signals across different modalities, such as synchronized heart rate variability and oxygen saturation, or integrated patterns indicating emerging medical risks. The patient monitoring model processes this fused data using a machine learning architecture suited for temporal monitoring and anomaly detection, such as a Recurrent Neural Network (RNN), Long Short-Term Memory (LSTM) network, or a transformer-based time-series model.

Based on this input, the patient monitoring model is configured to detect anomalies or threshold-crossing events, such as critically low oxygen levels, rapid changes in blood pressure, or sustained elevated body temperature. When such a physiological threshold is crossed, the model generates a control option representing a recommended emergency response, such as activating an alert protocol, notifying medical staff, or triggering an automatic system-level action like repositioning the patient or activating a backup monitoring system. The processing circuitry 130 evaluates the current computing resource data of the AI-system 170 before authorizing the control option. This includes assessing the availability of processing capacity, communication bandwidth, and memory, all of which are required to execute the alert, transmit messages, and possibly reallocate monitoring priorities. For example, if the communication bus is congested or the processing load is high due to concurrent diagnostic operations, the patient monitoring model's control option may be temporarily deferred or rerouted through a prioritized channel. This ensures that emergency actions are executed only when system-level constraints permit reliable and timely response, aligning with the adaptive resource management strategies described above.

Thus, the behavior of the patient monitoring model integrates fused sensor data analysis with real-time computing resource evaluation, and its control output is subject to dynamic prioritization based on system constraints. This reflects the overarching design of the AI-system 170, where execution order and model behavior are closely linked to resource-aware decision-making mechanisms as detailed in the stored description.

In some examples, adapting the usage of the shared computing resources may comprise dynamically prioritizing AI models based on at least one of patient risk level, sensor criticality, or task urgency. As described above, the processing circuitry 130 may be configured to adapt a usage of the shared computing resources of the AI-system 170 for the execution of the plurality of AI models based on received computing resource data. This adaptation may involve selectively adjusting how much processing capacity, memory, communication bandwidth, or power is allocated to individual AI models depending on current system conditions and operational goals. Dynamically prioritizing AI models may be implemented through resource allocation policies that assign relative importance or execution precedence to different AI models depending on real-time evaluation of system and patient states. For instance, if multiple AI models are concurrently requesting shared computing resources, such as the diagnostic model, the patient monitoring model, and the therapy planning model, the processing circuitry 130 may allocate more CPU cycles, buffer memory, or communication bandwidth to the AI model that has been prioritized according to one or more of the aforementioned criteria. This prioritization can be encoded in scheduling weights, task queues, or gating logic controlling access to hardware accelerators or shared memory pools.

Patient risk level may refer to an assessment of the severity, acuity, or instability of the patient's current condition, as inferred from fused data produced by the AI-system 170. For example, a patient experiencing arrhythmia, rapid blood pressure fluctuation, or suspected sepsis may be assigned a high-risk score. Based on this score, the AI-system may prioritize execution of the patient monitoring model and the diagnostic model by allocating more processing capacity and ensuring their inference steps are performed with minimal latency. This allows the system to respond quickly to life-threatening situations and maintain situational awareness under high-risk conditions.

Sensor criticality may refer to the importance of the sensor modality for ensuring accurate and timely monitoring of the patient's physiological state. For example, sensors such as ECG, blood oxygen monitors, or continuous glucose monitors may be deemed critical in intensive care environments. If computing resources are limited, the AI-system may prioritize models that depend on these critical sensors for inference—such as the patient monitoring model—by allocating sufficient memory for buffering and bandwidth for real-time communication. Less critical modalities, such as environmental sensors or low-resolution video feeds, may be deprioritized, and models using those inputs may be throttled.

Task urgency may refer to the temporal importance or deadline sensitivity of a specific inference or control task requested by an AI model. For example, detecting a respiratory arrest or computing a therapy plan for a rapidly deteriorating patient may require immediate attention, whereas background analysis of historical trends or calibration of an imaging device may tolerate delay. Based on the urgency of the requested task, the processing circuitry 130 may adapt the usage of the shared computing resources by granting higher scheduling priority, increasing energy allocation to high-performance computing cores, or expediting memory access for the involved AI model. This ensures that urgent and time-sensitive tasks are completed without delay, even under constrained resource conditions.

Altogether, this adaptation mechanism enables the AI-system 170 to maintain safe, responsive, and efficient operation in dynamic clinical settings by adjusting internal resource allocation in accordance with patient-specific and task-specific priorities, consistent with the general principles outlined in the detailed description.

In some examples, adapting the usage of the shared computing resources for the execution of the plurality of AI models in the medical system may comprise dynamically adjusting at least one of: processing capacity of one or more processing circuitries of the medical system allocated to AI model execution, memory usage of one or more memories of the medical system used for physiological signal processing or medical image interpretation, bandwidth usage of one or more data bus and communication interfaces of the medical system used by the AI models, or power supply allocation to an imaging device, a monitoring system, or a mobile diagnostic unit controlled by the AI-system, based on computing resource data of the AI-system. The computing resource data may comprise at least one of: available processing power, memory availability, communication bandwidth utilization, real-time AI-system load, or task-specific medical priority. As described above, the processing circuitry 130 may be configured to adapt a usage of the shared computing resources of the AI-system 170 for the execution of the AI models based on received computing resource data. The adaptation may include continuous or event-driven adjustments of hardware or software resource availability across the plurality of AI models 172, ensuring efficient operation of the medical system even under constraints such as limited energy, memory, or processing capacity. In the case of a medical application, such adaptation is critical to guarantee timely, reliable support for monitoring, diagnosis, and therapy control, especially in high-risk clinical settings.

The AI-system may include general-purpose CPUs, GPUs, or specialized medical AI accelerators embedded within medical diagnostic or monitoring equipment. Based on the computing resource data, the processing circuitry 130 may reallocate CPU cycles or thread availability to prioritize time-critical AI models such as a diagnostic model during image interpretation or a patient monitoring model during the detection of physiological anomalies. If computing resource data indicates high utilization, lower-priority AI models, such as those used for background analytics or offline therapy planning, may be throttled to prevent overload.

The shared memory may be used by multiple AI models to buffer sensor streams, store intermediate features, or cache fused data. If memory availability is low, the processing circuitry 130 may reduce resolution of medical images, shrink temporal signal windows, or compress intermediate tensors, especially for non-urgent tasks. Meanwhile, AI models responsible for real-time ECG processing or emergency diagnostics may receive increased buffer sizes to ensure uninterrupted inference execution and avoid latency spikes.

Communication interfaces may include internal buses between AI components, network interfaces for cloud or edge coordination, or inter-module communication paths in a modular medical device. When communication bandwidth utilization exceeds safe thresholds, the processing circuitry 130 may prioritize transmission of urgent data—such as physiological alerts or critical image segments—while postponing or rate-limiting the communication of background data, log files, or redundant model outputs. For instance, control options related to patient stabilization may be granted high-speed transfer over the shared bus, while model training updates may be deferred.

In medical systems, power supply units may be shared across AI components and physical subsystems. If energy constraints are detected in the computing resource data—such as low battery in a portable unit or peak energy draw across modules—the processing circuitry 130 may shift power distribution accordingly. For example, power may be prioritized to keep a mobile ultrasound scanner or wearable ECG active, while temporarily disabling less critical sensors or AI models used for remote data syncing. Likewise, energy-hungry image reconstruction models may be downscaled or migrated to edge/cloud units if power availability drops.

The decision to adapt any of these shared computing resources is based on computing resource data of the AI-system. One such parameter is available processing power, which refers to the unallocated or idle capacity of processing circuitries in the system. If available processing power is low, AI models with lower priority or longer acceptable latency may be suspended or delayed. Another parameter is memory availability, reflecting the amount of free memory in the shared memory modules. This may trigger adaptation strategies like model compression, resolution downscaling, or selective memory deallocation.

Communication bandwidth utilization refers to the current level of occupancy or congestion in the internal or external communication interfaces. High utilization may cause data transfer delays or priority inversion. The processing circuitry 130 may respond by adjusting which data packets are transmitted and which AI models are permitted to exchange fused data or computation outputs at full bandwidth. Real-time AI-system load refers to the overall computational activity across all AI models, including inference operations, sensor fusion, and control option generation. When this load approaches system limits, task scheduling or model activation may be reprioritized.

The task-specific medical priority refers to metadata or control parameters indicating the urgency or clinical importance of a given AI model's current operation. For instance, tasks flagged as life-critical, such as stroke detection or cardiac monitoring, may override memory or processing restrictions. This allows the AI-system to adapt resource usage dynamically in favor of models that directly influence patient safety and timely diagnosis.

In some examples, the execution order of the plurality of control options is determined by a reinforcement learning model configured to optimize medical outcomes over time by adapting prioritization strategies of diagnostic and monitoring actions based on computing resource data, historical patient data, alert statistics, and clinical feedback. As described above, the execution order refers to a prioritized sequence in which control options, generated by the plurality of AI models 172 within the AI-system 170, are evaluated and selected for execution by the circuitry 130 based on fused sensor and computation data and decision data. In the context of a medical system, these control options may correspond to diagnostic proposals, anomaly alerts, imaging tasks, or therapy recommendations, each of which may vary in urgency, resource requirements, and patient impact. The use of reinforcement learning enables the AI-system 170 to adaptively and autonomously refine its decision-making over time by learning which execution priorities lead to the best clinical outcomes under dynamic computing constraints and patient conditions.

The reinforcement learning model may be implemented using a policy-based, value-based, or actor-critic architecture trained to select an optimal execution order given a defined state space and reward function. The input state for the RL model may include computing resource data (such as available processing power, memory availability, or system load), historical patient data (such as recent diagnoses, treatment paths, or physiological trends), alert statistics (such as frequency, severity, or resolution times of past anomalies), and clinical feedback (such as physician-confirmed outcomes, system overrides, or manually annotated performance metrics). The RL model may process this multi-source input—potentially as a fused representation generated via multimodal data fusion or attention-based mechanisms—and generate a control signal representing a recommended execution priority for each pending control option. The RL model may be trained to maximize a cumulative reward that reflects the quality of medical outcomes. For example, rewards may be positively associated with timely and accurate diagnoses, early detection of critical events, successful therapy outcomes, and energy-efficient execution, while penalties may be applied for delayed alerts, missed anomalies, or resource overuse. Through iterative interaction with the medical system, either in a real-time deployment or simulated digital twin environment, the RL model may learn which prioritization strategies yield higher rewards over time, thereby improving the responsiveness and effectiveness of the AI-system.

For instance, when multiple control options are available simultaneously, such as a pending diagnosis from the diagnostic model, a real-time anomaly alert from the patient monitoring model, and a therapy planning update, the RL model may determine that prioritizing the anomaly alert yields higher reward due to its urgent nature and potential to avert a critical event. Conversely, if historical data indicates frequent false positives in similar anomaly alerts under certain resource constraints, the model may learn to deprioritize such options in favor of more robust diagnostic actions. By continuously refining its execution policy, the reinforcement learning model enables the AI-system to balance task urgency, patient risk, system performance, and resource efficiency in a clinically adaptive manner. This mechanism is consistent with the general approach described above, wherein the execution order of control options is determined based on decision data and dynamic optimization strategies tailored to the domain of application.

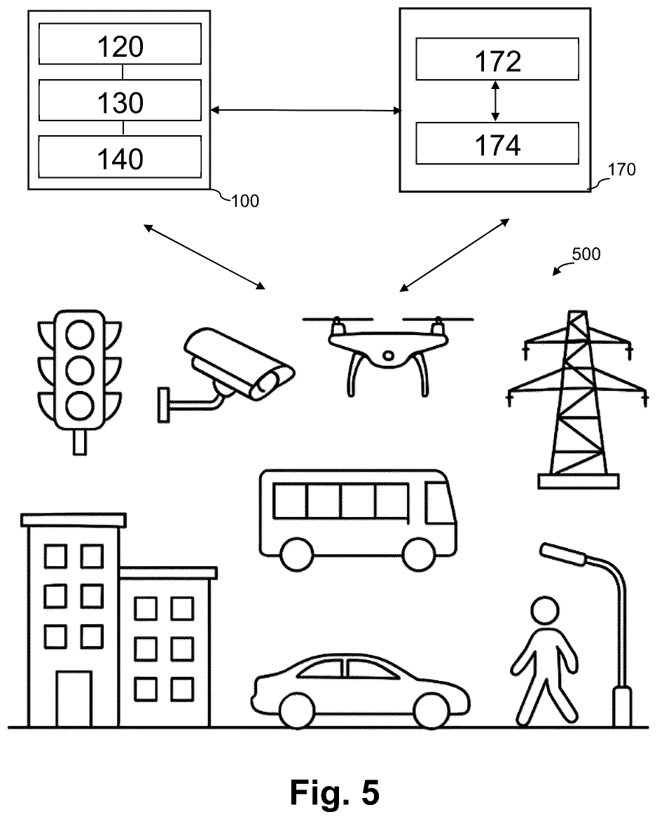

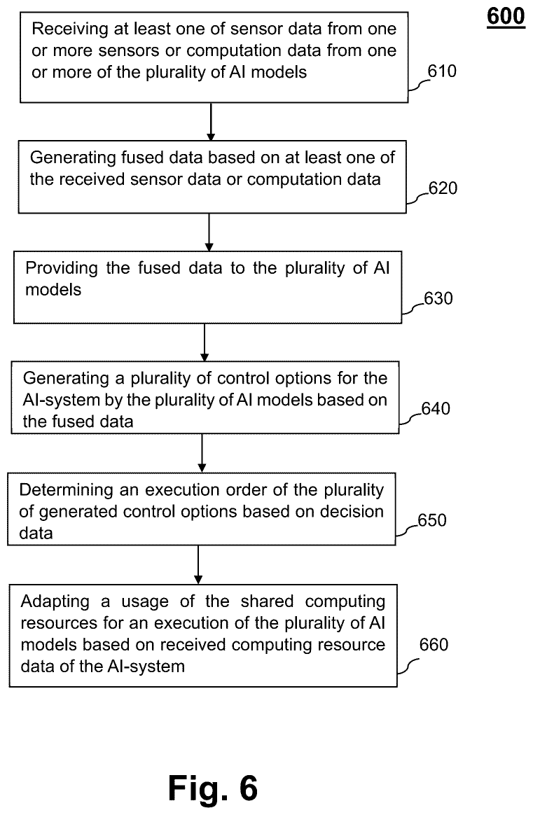

Further details and aspects are mentioned in connection with the examples described above or below. The example shown in FIG. 5 may include one or more optional additional features corresponding to one or more aspects mentioned in connection with the proposed concept or one or more examples described above (e.g., FIGS. 1-4) or below (e.g., FIG. 6).

### Example of a Smart City

FIG. 5 illustrates an example of the AI-system 170 configured to control a smart city 500 as the target system. In some examples, smart city 500 may comprise a plurality of interconnected agents distributed across an urban environment and configured to support real-time monitoring, control, and optimization of urban infrastructure and services. A smart city may refer to a complex urban environment that integrates digital technologies, distributed sensors, connected devices, and intelligent control systems to optimize the operation, sustainability, and quality of life within a metropolitan area. The agents of a smart city may include, but are not limited to, traffic signal units, public transport vehicles and stations, unmanned aerial vehicles (drones), street-level surveillance systems, environmental monitoring devices, public lighting systems, and distributed energy resources such as local power generators or storage units. These agents may operate as autonomous subsystems or may be interconnected through shared data and control interfaces, enabling coordinated behavior across diverse domains such as mobility, safety, energy, and environmental management. These agents may include the one or more sensors 160, such as image sensors, environmental sensors, traffic flow detectors, or GPS modules, and actuators such as signal controllers, drone motors, lighting dimmers, or energy switches. The AI-system may receive sensor data and computation data from these agents, generate fused data representations, and execute control options tailored to specific urban tasks or optimization goals. The AI-system 170 comprising the plurality of AI models 172 may be configured to control the behavior of the smart city by generating control options based on fused data and determining an execution order for those control options using decision data. The AI-system 170 may be implemented within a centralized urban computing hub, distributed across edge computing nodes deployed throughout the city, or external to the smart city infrastructure, such as in a cloud-based AI-service that communicates with the agents via network interfaces.

The AI-system 170 may be implemented within local infrastructure nodes (e.g., in traffic control cabinets, surveillance hubs, or substations), or may be hosted in an edge server, centralized municipal data center, or cloud-based platform, communicating with the smart city components via wired or wireless networks.

The smart city 500 shown in FIG. 5 is a non-limiting example. The apparatus 100, which includes interface circuitry 120, processing circuitry 130, and machine-readable instructions stored in memory 140, may reside within these edge components or be centralized. This flexible configuration allows the AI-system 170 to adapt to varying urban conditions, ensure scalable performance, and optimize shared computing resources such as bandwidth, memory, processing capacity, and energy supply across the entire smart city infrastructure.

In some examples, the apparatus 100 may be used to control smart city infrastructure 500 using a plurality of AI models configured to generate and prioritize control options for traffic management, power grid optimization, or public surveillance systems. The control options may be based on fused sensor data obtained from traffic cameras, environmental sensors, or connected public transport systems, and their execution may be adapted based on the AI-system's computing resource data.

In some examples, the AI-system 170 with the plurality of AI models 172 may be configured to control agents of a smart city. The plurality of AI models comprises at least one of the following: a traffic control model, a surveillance model, a fleet coordination model, a public transport optimization model, a drone management model, or a power grid optimization model. The agents may be distributed physical or digital entities within the urban infrastructure that are capable of receiving sensor data, executing control commands, and participating in coordinated operations. Each of the AI models may be configured to process fused data generated by the processing circuitry 130 of the apparatus 100 and to output control options that target specific agents or subsystems of the smart city. In some examples, a traffic control model may be configured to optimize vehicular and pedestrian flow through the city by controlling adaptive traffic signals and signage systems. The input to the traffic control model may comprise fused data derived from sensor data such as camera footage, radar-based vehicle counts, and pedestrian detection sensors, as well as computation data including vehicle trajectory predictions and congestion level estimates. The output of the traffic control model may include prioritized control options such as signal phase adjustments, duration changes, or real-time rerouting instructions to connected vehicles. These control options may be transmitted to roadside controllers or traffic management systems to dynamically regulate flow and reduce congestion.

In some examples, a surveillance model may be configured to monitor public spaces, detect abnormal behavior, or support public safety operations. The input to the surveillance model may include fused data generated from video streams, thermal imagery, sound sensors, and incident detection models. The surveillance model may produce control options such as tracking commands for pan-tilt-zoom (PTZ) cameras, alert triggers to law enforcement interfaces, or event flags for human review. These outputs may be directed to surveillance camera networks or emergency response platforms to enhance situational awareness and response coordination.

In some examples, a fleet coordination model may be used to manage the routing and task distribution among a fleet of city-operated vehicles, such as maintenance vans, autonomous taxis, or logistics robots. The input to the fleet coordination model may include real-time location data, traffic flow information, task priority levels, and energy status from the individual vehicles. The output may comprise optimized vehicle assignments, route plans, and schedule adjustments, which may be transmitted to vehicle control units or dispatch centers to implement coordinated actions that reduce travel time and fuel usage.

In some examples, a public transport optimization model may be configured to adjust the frequency, timing, and routing of public buses, trains, or shuttles in response to demand and operating conditions. The input to this model may include fused data comprising passenger count trends, traffic conditions, and historical usage statistics. The output may include dynamic timetable updates, platform assignments, and routing changes that are communicated to transport operators or onboard control systems to enhance service efficiency and passenger experience.

In some examples, a drone management model may coordinate the operation of surveillance, delivery, or inspection drones within the urban airspace. The model may receive fused data including air quality readings, weather forecasts, GPS signals, camera feeds, and no-fly zone data. Based on this input, the drone management model may output control options such as takeoff schedules, flight paths, hover points, and emergency reroute instructions. These control options may be transmitted to the drone's onboard controllers or to a centralized drone traffic management platform for execution.

In some examples, a power grid optimization model may be configured to balance energy supply and demand across distributed energy resources within the city. The input to the power grid optimization model may include fused data representing real-time energy consumption from smart meters, availability of renewable sources such as solar and wind, and predictive demand curves derived from historical patterns and external conditions. The model may output control options such as load shedding commands, storage unit charge/discharge schedules, or grid reconfiguration instructions. These options may be sent to energy management systems or directly to distributed infrastructure such as substations, energy storage modules, and smart meters.

Each of these AI models may utilize shared computing resources 174 of the AI-system 170, including processor power, memory, communication interfaces, and power supply, to perform their inference and decision-making tasks. Control options generated by the AI models may be prioritized, ordered, and executed based on decision data in a manner consistent with the general principles described above, ensuring efficient and coordinated operation of the smart city.

In some examples, the shared computing resources 174 of the AI-system 170 may comprise resources of the smart city infrastructure that are accessible by, and at least partially utilized by, the AI-system 170 and its plurality of AI models 172. These resources may be co-located with, embedded in, or communicatively linked to the AI-system, enabling their shared use for executing AI tasks such as sensor data processing, fused data generation, model inference, and control decision-making. In some examples, the shared computing resources may comprise at least one of the following resources of the smart city: processing capacity of one or more processing circuitries, memory usage of one or more memories of the AI-system used for storing sensor data, fused data, or model parameters, usage of one or more data bus and communication interfaces of the smart city used for transmitting sensor data, control options, or decision data between the AI-system and components of the target system, or power supply of traffic signal unit, a public lighting system, or an environmental monitoring device of the smart city co-located with the AI-system.

In some examples, the processing capacity of one or more processing circuitries may refer to computational hardware distributed within the smart city and at least partially allocated to the AI-system 170 for executing AI model operations. This may include processors embedded in edge computing nodes near traffic intersections, drone control towers, environmental monitoring units, or public infrastructure hubs. These processing circuitries may be shared by multiple city subsystems but are also utilized by the AI-system for tasks such as fusing sensor inputs, running traffic prediction models, or computing optimized energy distribution plans. For example, a high-performance edge processor located at a traffic junction may simultaneously serve a local control unit and execute inference passes of a traffic control model within the AI-system.

In some examples, the memory usage of one or more memories of the AI-system may comprise memory resources used to store sensor data, fused data, intermediate representations, or AI model parameters. These memory components may be part of distributed memory architectures that are accessible to various agents of the smart city but are actively used by the AI-system 170 for buffering real-time data streams, caching fused scene representations, and maintaining parameter sets for the deployed AI models. For instance, shared memory units in public transport depots or energy substations may be used to persist time-series inputs and learned weights of a public transport optimization model or a power grid prediction model.

In some examples, the usage of one or more data bus and communication interfaces of the smart city may refer to shared communication infrastructure used to transmit sensor data, control options, or decision data between the AI-system 170 and other components of the target system 180. These communication interfaces may include wired or wireless networks connecting street-level sensors, centralized controllers, traffic lights, surveillance nodes, and public data servers. The AI-system may utilize this infrastructure to receive input signals from distributed sensors (e.g., vehicle counts, pollution levels), transmit control commands (e.g., light phase changes, drone flight paths), or exchange decision data with other systems. For example, a city-wide mesh network may be jointly used by environmental monitoring devices and the AI-system for bi-directional data transfer during dynamic air quality control operations.

In some examples, the power supply of a traffic signal unit, a public lighting system, or an environmental monitoring device of the smart city may be partially shared with the AI-system, especially when the AI-system is co-located with these components. These power supply units may energize both the operational circuitry of the respective infrastructure component and the embedded AI modules performing data collection, fusion, and control decision-making. For example, an AI-enabled traffic light controller may draw power from the same source as the traffic signal it controls, enabling it to perform local inference using a traffic control model without relying on external power infrastructure. Similarly, a streetlight-integrated air quality monitoring unit may power an embedded AI subsystem used to forecast pollution trends and initiate control options like activating fans or issuing public alerts.

In all these cases, the shared computing resources are accessible and at least partially utilized by the AI-system 170 to support the concurrent or coordinated execution of its plurality of AI models 172. The dynamic allocation and adaptation of these resources may be performed as described above to meet changing urban demands, ensure efficient model performance, and maintain quality of service across the smart city environment.

In some examples, the execution order of the plurality of control options may be determined by the AI-system 170 for the smart city, wherein the control options are generated by the plurality of AI models 172 based on the fused data provided by the processing circuitry 130. The fused data may represent an enriched, context-aware integration of heterogeneous sensor data and computation data, as described above, and may be used by each AI model to generate domain-specific control options for urban agents. The execution order of these control options may be prioritized and dynamically adjusted based on decision data reflecting system goals, resource constraints, safety margins, or predicted outcomes, ensuring coordinated and efficient behavior across the smart city. The control options may comprise at least one of: traffic signal adaptation by the traffic control model based on real-time vehicle flow data and pedestrian movement patterns, automated drone dispatch by the drone management model based on environmental data, dynamic public transport scheduling by the public transport optimization model based on passenger demand forecasts and/or traffic congestion data, vehicle coordination by the fleet coordination model to optimize routing based on lane usage, and interaction with smart infrastructure, energy distribution adjustment by the power grid optimization model based on electricity demand fluctuations and renewable energy availability.

In some examples, the control options may include traffic signal adaptation by the traffic control model based on real-time vehicle flow data and pedestrian movement patterns. The fused data provided to the traffic control model may combine sensor data from road-embedded vehicle detectors, traffic surveillance cameras, and pedestrian movement sensors with computation data such as predicted traffic congestion maps or travel time estimates generated by other AI models. Based on this fused input, the traffic control model may generate control options such as adjusting signal phases, altering green light durations, or initiating pedestrian crosswalk prioritization. The execution order for these options may prioritize actions that minimize overall delay, reduce vehicle idling, or accommodate peak pedestrian demand near schools or transit hubs.

In some examples, the control options may include automated drone dispatch by the drone management model based on environmental data. The fused data in this case may be derived from a combination of weather sensors (e.g., wind speed, precipitation), air quality monitors, GPS location data, and drone fleet telemetry reports. Computation data from previous missions or no-fly zone models may also be included. The drone management model may use this fused data to generate control options such as launch approval, optimized flight routing, area surveillance instructions, or emergency landing protocols. The execution order may be determined based on urgency, risk factors, or airspace availability, ensuring safe and efficient drone operation over city districts.

In some examples, the control options may include dynamic public transport scheduling by the public transport optimization model based on passenger demand forecasts and/or traffic congestion data. The fused data for this model may comprise real-time bus occupancy data, smart card tap-ins, platform crowd sensor readings, and computation data from predictive models estimating near-future passenger loads and travel delays. The model may output control options such as dynamic dispatching of additional buses, rescheduling of routes, or alteration of stop frequencies. The execution order may be based on forecasted service gaps, congestion propagation patterns, or priority events (e.g., public gatherings), enabling proactive adjustment of public transport services to optimize accessibility and reduce wait times.

In some examples, the control options may include vehicle coordination by the fleet coordination model to optimize routing based on lane usage and interaction with smart infrastructure. The fused data may include road occupancy levels from embedded lane sensors, GPS-based vehicle positions, traffic signal timing information, and AI model predictions of road segment saturation or incident likelihoods. Based on this fused input, the fleet coordination model may generate control options such as rerouting of autonomous fleet vehicles, reservation of dynamic lanes, or scheduling of intersection crossings. The execution order may prioritize routes that minimize overall travel time, balance lane utilization, or comply with traffic flow regulations, while accounting for real-time updates from city-wide traffic systems.

In some examples, the control options may include energy distribution adjustment by the power grid optimization model based on electricity demand fluctuations and renewable energy availability. The fused data in this case may include sensor data from distributed smart meters, solar panel output statistics, battery storage levels, and computation data predicting short-term demand spikes and supply variability. The model may generate control options such as modifying substation switch states, redistributing load between neighborhoods, or adjusting charge/discharge cycles for grid-connected storage. The execution order may be prioritized based on criteria such as load balancing efficiency, grid stability, or preferential supply to critical services (e.g., hospitals, public transport infrastructure).

Across all these examples, the execution order of the control options is determined by the AI-system 170 based on decision data, which may be derived from expected impact, resource availability, or projected system outcomes. The order determination may involve simulation within a virtual environment, evaluation in a digital twin, or ranking by nature-inspired or machine learning-based optimization algorithms, ensuring that the most critical and impactful actions are executed with appropriate timing and resource allocation.

In some examples, adapting the usage of the shared computing resources for the execution of the plurality of AI models in the smart city may comprise dynamically adjusting at least one of: processing capacity of one or more processing circuitries, memory usage of one or more memories of the AI-system used for sensor data aggregation or fused data storage, bandwidth usage of one or more data bus and communication interfaces of the smart city used by the AI models for interconnecting infrastructure components, or power supply allocation of a traffic signal unit, a public lighting system, or an environmental monitoring device co-located with the AI-system, based on computing resource data of the AI-system. The computing resource data may comprise at least one of: available processing power, memory availability, communication bandwidth utilization, real-time AI-system load, or task-specific execution priority.

For example, adapting the processing capacity may comprise increasing or decreasing the allocation of processor threads, CPU time slices, or AI accelerator slots to specific AI models depending on available processing power and task urgency. When the computing resource data indicates that high available processing power is present, additional resources may be granted to a traffic control model during peak congestion. Conversely, if real-time AI-system load is elevated, the execution of non-critical models such as a background map-learning component may be deferred to preserve computational stability.

Similarly, memory usage may be adapted by expanding or contracting memory buffers used to temporarily store high-volume sensor inputs or intermediate fused data representations. If memory availability drops due to concurrent high-resolution image streams from multiple surveillance nodes, the memory allocated to the surveillance model may be reduced, or older data may be offloaded, compressed, or deprioritized. This ensures that memory usage remains within safe bounds while maintaining responsiveness for high-priority models.

Bandwidth usage of communication interfaces may also be regulated to prioritize data exchange for latency-sensitive models. If communication bandwidth utilization rises, for example due to a city-wide emergency broadcast or large-scale event coverage, the AI-system may throttle non-urgent data transmissions between AI models managing energy forecasting or long-term traffic pattern learning. Prioritization may be applied to models coordinating real-time traffic or emergency drone dispatch.

The power supply allocation to co-located infrastructure components may be dynamically adjusted based on energy constraints and AI-model priority. For example, during periods of limited electricity availability or grid instability, the system may reduce the brightness of public lighting systems or place non-critical environmental sensors into standby mode. This allows the available energy to be redirected toward AI models executing time-sensitive public safety or infrastructure coordination tasks, such as those involved in emergency routing or drone surveillance.

The computing resource data used to inform these adaptations may include at least one of: available processing power, memory availability, communication bandwidth utilization, real-time AI-system load, or task-specific execution priority. Available processing power may be measured using system-level telemetry from processors embedded in edge nodes or control hubs. Memory availability may be derived from monitoring RAM, VRAM, or cache usage across distributed AI-system components. Communication bandwidth utilization may be assessed by tracking throughput, congestion, and latency metrics across data buses or wireless links used for inter-model communication. Real-time AI-system load may reflect a composite view of computational and memory demands across all currently active models. Task-specific execution priority may be determined based on external scheduling constraints, safety rules, or policy mandates, and may be updated dynamically in response to contextual signals such as incident alerts or civic events.

By evaluating this computing resource data, the AI-system 170 may adapt the use of shared computing resources in real time to maintain safe and efficient operation, optimize system performance, and support prioritization under constrained or fluctuating conditions in the smart city environment.

In some examples, the execution order of the smart city control actions is determined by a reinforcement learning (RL) model. The reinforcement learning model may be configured to adaptively prioritize and sequence control options across diverse operational domains of the smart city. For example, the RL model may be configured to adapt at least one of traffic control, public transport scheduling, drone dispatch, or energy allocation based on at least one of historical smart city data, real-time AI-system load, or external environmental conditions. The reinforcement learning model may continuously learn and refine a policy that determines which control actions should be executed, and in what order, to optimize a set of predefined or dynamically evolving objectives. These objectives may include reducing city-wide congestion, minimizing energy consumption, maximizing service efficiency, or responding effectively to real-time events and environmental changes.

The RL model may be trained using a reward-driven framework in which the smart city is treated as an environment that provides feedback in response to action sequences taken by the AI-system. During training, the RL model may observe state representations derived from fused data, such as current traffic density maps, vehicle occupancy levels, drone positions, or energy supply-demand forecasts. Based on this state, the model selects one or more control options to be executed. These control options may include changing a traffic light schedule, rerouting a bus, launching a surveillance drone, or reconfiguring an energy distribution node. Once the control options are executed, either in a simulation environment or live deployment, the environment provides a reward signal that quantifies the impact of those actions. The reward may be based on measurable outcomes such as travel time reduction, energy efficiency gains, safety incident avoidance, or task success rates. The RL model then uses this reward to update its policy and value function, improving its decision-making over time through exploration and exploitation.

The RL model may be implemented using well-established frameworks such as Q-learning, Deep Q-Networks (DQN), Policy Gradient methods, Actor-Critic architectures, or Proximal Policy Optimization (PPO). It may use neural networks to approximate value functions or action policies, mapping high-dimensional input states to control actions with learned weights. The input to the RL model may include historical smart city data, such as logs of previous control decisions and outcomes, as well as real-time AI-system load metrics and external environmental conditions. For example, historical data may reveal that early signal changes reduce congestion in specific intersections during rush hour, while real-time load metrics may indicate that public transport models are currently computationally saturated. External conditions such as weather reports, accident alerts, or festival schedules may also influence the decision process.

By incorporating this multidimensional input, the RL model can adaptively weigh not only the operational benefit of each control option but also the feasibility of executing it within current resource constraints. For instance, if a drone dispatch action has a high expected utility but available energy resources are low, the RL model may postpone it in favor of a more power-efficient action, such as a traffic signal adjustment. If the public transport system is predicted to face peak load in ten minutes, the RL model may prioritize early dispatch of additional buses and defer energy reallocation tasks until critical mobility actions have completed. This context-aware prioritization enables the RL model to operate as an adaptive execution orchestrator within the AI-system 170.

The training of the reinforcement learning model may occur initially in a simulated digital twin of the smart city, which mirrors real-world interactions with sufficient fidelity to evaluate the effects of different control sequences without risking service disruption. Once trained, the model may be deployed within the live AI-system 170 and continuously fine-tuned using online learning or episodic batch updates. This continuous adaptation allows the model to remain responsive to long-term trends, system drift, and emerging urban behaviors.

By determining the execution order of smart city control actions based on learned policies, the reinforcement learning model enables the AI-system 170 to dynamically prioritize high-impact decisions, coordinate across domains, and maintain robust operation even in the presence of uncertainty, resource constraints, or unexpected events. This reinforcement learning-based control strategy complements other decision models within the AI-system and supports scalable, autonomous governance of complex urban environments.

Further details and aspects are mentioned in connection with the examples described above or below. The example shown in FIG. 5 may include one or more optional additional features corresponding to one or more aspects mentioned in connection with the proposed concept or one or more examples described above (e.g., FIGS. 1-4) or below (e.g., FIG. 6).

FIG. 6 illustrates a flowchart of an example of a method 600 for controlling a plurality of AI models of an AI-system. The method 600 may, for instance, be performed by an apparatus as described herein, such as apparatus 100. The method 600 comprises receiving 610 at least one of sensor data from one or more sensors or computation data from one or more of the plurality of AI models, wherein the plurality of AI models are operated within the AI-system and at least partially utilize shared computing resources of the AI-system. The method 600 further comprises generating 620 fused data based on at least one of the received sensor data or computation data. The method 600 further comprises providing 630 the fused data to the plurality of AI models. The method 600 further comprises generating 640 a plurality of control options for the AI-system by the plurality of AI models based on the fused data. The method 600 further comprises determining 650 an execution order of the plurality of generated control options based on decision data. The method 600 further comprises adapting 660 a usage of the shared computing resources for an execution of the plurality of AI models based on received computing resource data of the AI-system.

Further details and aspects are mentioned in connection with the examples described above. The example shown in FIG. 6 may include one or more optional additional features corresponding to one or more aspects mentioned in connection with the proposed concept or one or more examples described above (e.g., FIGS. 1-5) .

In the following, some examples of the proposed concept are presented:

An example (e.g., example 1) relates to an apparatus for controlling a plurality of AI models of an AI-system, comprising interface circuitry, machine-readable instructions and processing circuitry to execute the machine-readable instructions to receive at least one of sensor data from one or more sensors or computation data from one or more of the plurality of AI models, wherein the plurality of AI models are operated within the AI-system and at least partially utilize shared computing resources of the AI-system, generate fused data based on at least one of the received sensor data or computation data, provide the fused data to the plurality of AI models, generate a plurality of control options for the AI-system by the plurality of AI models based on the fused data, determine an execution order of the plurality of generated control options based on decision data, and adapt a usage of the shared computing resources for an execution of the plurality of AI models based on received computing resource data of the AI-system.

Another example (e.g., example 2) relates to a previous example (e.g., example 1) or to any other example, further comprising that the decision data comprises at least one of the following data sensor data, computing resource data, historical data from plurality of AI models or predetermined preference data.

Another example (e.g., example 3) relates to a previous example (e.g., one of the examples 1 to 2) or to any other example, further comprising that the shared computing resources comprise at least one of the following resources processing circuitry capacity of one or more processing circuitries of the AI-system, memory usage of one or more memories of the AI-system, usage of one or more data bus and communication interfaces of the AI-system, or power supply of AI-system components.

Another example (e.g., example 4) relates to a previous example (e.g., one of the examples 1 to 3) or to any other example, further comprising that the sensor data comprises at least one of camera data, LIDAR data, radar signals, or temperature sensor data.

Another example (e.g., example 5) relates to a previous example (e.g., one of the examples 1 to 4) or to any other example, further comprising that the computing resource data comprises at least one of available processing power, current computational load, memory usage, latency, a sampling rate of a sensor of the AI-system, a data processing rate, a sensor utilization rate, or an energy consumption of an AI-system component.

Another example (e.g., example 6) relates to a previous example (e.g., one of the examples 1 to 5) or to any other example, further comprising that determining the execution order of the plurality control options comprises determining a probability of future events based on the decision data.

Another example (e.g., example 7) relates to a previous example (e.g., one of the examples 1 to 6) or to any other example, further comprising that determining the execution order of the plurality of control options comprises determining an expected impact of an execution of at least one control option on the AI-system behavior based on the decision data.

Another example (e.g., example 8) relates to a previous example (e.g., one of the examples 1 to 7) or to any other example, further comprising that the execution order of the plurality control options is determined by a reinforcement learning model and/or a Bayesian network.

Another example (e.g., example 9) relates to a previous example (e.g., one of the examples 1 to 8) or to any other example, further comprising that determining the execution order of the control options further comprises allocating respective computing resources of the AI-system for executing the respective control options of the plurality of AI models.

Another example (e.g., example 10) relates to a previous example (e.g., one of the examples 1 to 9) or to any other example, further comprising that the processing circuitry is further to execute the machine-readable instructions to perform preprocessing of the received at least one of sensor data using an adaptive Kalman filter.

Another example (e.g., example 11) relates to a previous example (e.g., one of the examples 1 to 10) or to any other example, further comprising that the processing circuitry is further to execute the machine-readable instructions to evaluate the determined execution order of the plurality of generated control options in a virtual environment and/or digital twin of the AI-system prior to execution.

Another example (e.g., example 12) relates to a previous example (e.g., one of the examples 1 to 8) or to any other example, further comprising that determining the execution order of the control options is performed based on at least one of nature-inspired algorithms, swarm intelligence techniques, evolutionary algorithms or spiking neural networks.

Another example (e.g., example 13) relates to a previous example (e.g., one of the examples 1 to 12) or to any other example, further comprising that generating the fused data further comprises modeling dependencies between sensor data from one or more sensors and computation data from one or more of the plurality of AI models using a Graph Neural Network, GNN.

Another example (e.g., example 14) relates to a previous example (e.g., one of the examples 1 to 13) or to any other example, further comprising that generating the fused data further comprises reducing inconsistent sensor data and computation data using a Graph Neural Network, GNN.

Another example (e.g., example 15) relates to a previous example (e.g., one of the examples 1 to 14) or to any other example, further comprising that generating the fused data further comprises identifying conflicting sensor data and computation data using a Graph Neural Network, GNN.

Another example (e.g., example 16) relates to a previous example (e.g., one of the examples 1 to 15) or to any other example, further comprising that generating the fused data includes fusing the sensor data and the computation data, wherein the fusing is performed using multimodal data fusion.

Another example (e.g., example 17) relates to a previous example (e.g., example 16) or to any other example, further comprising that the multimodal data fusion is performed using a transformer-based model.

Another example (e.g., example 18) relates to a previous example (e.g., one of the examples 1 to 17) or to any other example, further comprising that generating fused data further comprises weighting the sensor data and/or the computation data based on data quality, data reliability, and/or data relevance.

Another example (e.g., example 19) relates to a previous example (e.g., example 18) or to any other example, further comprising that the weighting of the sensor data and the computational data is performed by a Graph Attention Network, GAT.

Another example (e.g., example 20) relates to a previous example (e.g., one of the examples 1 to 19) or to any other example, further comprising that the processing circuitry is further to execute the machine-readable instructions to receive computing resource data, and analyze the received computing resource data regarding a resource distribution in the AI-system.

Another example (e.g., example 21) relates to a previous example (e.g., one of the examples 1 to 20) or to any other example, further comprising that adapting the usage of the shared computing resources comprises assigning respective values of processing circuitry power, memory, data bandwidth, and/or energy to the respective plurality of AI models.

Another example (e.g., example 22) relates to a previous example (e.g., one of the examples 1 to 21) or to any other example, further comprising that the processing circuitry is further to execute the machine-readable instructions to adapt at least one of a sampling rate of a sensor, an activity status of a sensor, or an energy consumption of an AI-system component based on received computing resource data.

Another example (e.g., example 23) relates to a previous example (e.g., one of the examples 1 to 22) or to any other example, further comprising that adapting the usage of the shared computing resources is performed using a constraint-solving model to optimize computing capacities among parallel AI models.

Another example (e.g., example 24) relates to a previous example (e.g., one of the examples 1 to 23) or to any other example, further comprising that adapting the usage of the shared computing resources is performed using a Spiking Neural Network, SNN.

Another example (e.g., example 25) relates to a previous example (e.g., example 24) or to any other example, further comprising that the adaptation of the usage of the shared computing resources comprises selectively activating or deactivating processing capacity, memory, or power allocation for at least one of the plurality of AI models based on temporal spike activity within the SNN.

Another example (e.g., example 26) relates to a previous example (e.g., example 25) or to any other example, further comprising that adapting the usage of the shared computing resources is performed using Neural Evolution, NE, wherein the NE is configured to iteratively restructure at least one of a topology, activation functions, or hyperparameters of at least one AI model in the plurality of AI models, based on computing resource constraints or performance feedback.

Another example (e.g., example 27) relates to a previous example (e.g., one of the examples 1 to 26) or to any other example, further comprising that adapting the usage of the shared computing resources comprises Quantum-Assisted Optimization, QAO.

Another example (e.g., example 28) relates to a previous example (e.g., example 27) or to any other example, further comprising that the QAO is configured to solve an optimization problem representing the allocation of the shared computing resources among the plurality of AI models based on computing resource data and decision data, by embedding the optimization problem into a quantum annealing process or a variational quantum circuit executed on a quantum processing unit.

Another example (e.g., example 29) relates to a previous example (e.g., example 28) or to any other example, further comprising that the optimized allocation generated by the QAO is recorded on a distributed ledger.

Another example (e.g., example 30) relates to a previous example (e.g., one of the examples 1 to 29) or to any other example, further comprising that the processing circuitry is further to execute the machine-readable instructions to record at least one of the sensor data, computation data, fused data, plurality of control options or determined execution order on a distributed ledger.

Another example (e.g., example 31) relates to a previous example (e.g., one of the examples 1 to 30) or to any other example, further comprising that the AI-system is distributed across a hybrid cloud-edge infrastructure.

Another example (e.g., example 31) relates to a previous example (e.g., one of the examples 1 to 31) or to any other example, further comprising that the AI-system with the plurality of AI models is configured to control a robot, wherein the plurality of AI models comprises at least one of the following a navigation model, a perception model, a manipulation model, a control optimization model, a reinforcement learning model, a communication model, or a fault detection model.

Another example (e.g., example 32) relates to a previous example (e.g., example 31) or to any other example, further comprising that the shared computing resources comprise at least one of the following resources of the robot processing capacity of one or more processing circuitries of the robot, memory usage of one or more memories of the robot, usage of one or more data bus and communication interfaces of the robot, or power supply of a motor controller, an actuator, or robot sensor.

Another example (e.g., example 33) relates to a previous example (e.g., one of the examples 31 to 32) or to any other example, further comprising that the execution order of the plurality of control options is determined for controlling the robot, wherein the control options comprise at least one of path planning by the navigation model based on sensor data, obstacle avoidance by the navigation model based on real-time proximity sensor data, environmental mapping data, and computing resource constraints, object manipulation by the manipulation model based on perception data, or force control by the control optimization model based on actuator power constraints.

Another example (e.g., example 34) relates to a previous example (e.g., one of the examples 31 to 33) or to any other example, further comprising that the navigation model is configured to determine a movement trajectory of the robot based on fused sensor data, wherein determining the movement trajectory comprises adapting speed and direction.

Another example (e.g., example 35) relates to a previous example (e.g., one of the examples 31 to 34) or to any other example, further comprising that the manipulation model is configured to determine an optimal grasping strategy based on fused perception data.

Another example (e.g., example 36) relates to a previous example (e.g., one of the examples 31 to 35) or to any other example, further comprising that adapting the usage of the shared computing resources of the robot for the execution of the plurality of AI models comprises dynamically adjusting at least one of processor capacity allocated to AI models, memory usage assigned for sensor data processing or model execution, bandwidth distribution across data buses and communication interfaces used by the AI models, or power allocation to AI-system components of the robot, based on computing resource data of the AI-system, the computing resource data comprising at least one of available processing power, memory availability, communication bandwidth utilization, real-time AI-system load, or task-specific execution priority.

Another example (e.g., example 37) relates to a previous example (e.g., one of the examples 31 to 36) or to any other example, further comprising that the execution order of the plurality control options is determined by a reinforcement learning model which is configured to adapt the robot's behavior over time by updating motion planning and interaction strategies based on the decision data.

Another example (e.g., example 38) relates to a previous example (e.g., example 37) or to any other example, further comprising that the decision data comprising at least one of historical performance data, task success rates, AI-system load, available processing power, energy consumption metrics, or external reinforcement signals.

Another example (e.g., example 39) relates to a previous example (e.g., one of the examples 1 to 38) or to any other example, further comprising that the AI-system with the plurality of AI models is configured to control a vehicle, wherein the plurality of AI models comprises at least one of the following a navigation model, a perception model, a path planning model, a trajectory control model, a reinforcement learning model, a communication model, or a fault detection model.

Another example (e.g., example 40) relates to a previous example (e.g., example 39) or to any other example, further comprising that the shared computing resources comprise at least one of the following resources of the vehicle processing capacity of one or more processing circuitries of the vehicle, memory usage of one or more memories of the vehicle, usage of one or more data bus and communication interfaces of the vehicle, or power supply of a sensor suite, an electronic control unit, ECU, or an actuator.

Another example (e.g., example 41) relates to a previous example (e.g., one of the examples 39 to 41) or to any other example, further comprising that the execution order of the plurality of control options is determined for controlling the vehicle, wherein the control options comprise at least one of path planning by the navigation model based on perception data, obstacle avoidance by the navigation model based on real-time LIDAR, radar, and camera sensor data, adaptive speed control by the trajectory control model based on traffic conditions and computing resource constraints, or braking control by the control optimization model based on vehicle dynamics and actuator constraints.

Another example (e.g., example 42) relates to a previous example (e.g., one of the examples 39 to 41) or to any other example, further comprising that the navigation model is configured to determine a driving trajectory of the vehicle based on fused sensor data, wherein determining the driving trajectory comprises dynamically adjusting speed, acceleration, and lane positioning based on environmental conditions and traffic flow.

Another example (e.g., example 43) relates to a previous example (e.g., one of the examples 39 to 42) or to any other example, further comprising that adapting the usage of the shared computing resources for the execution of the plurality of AI models in the vehicle comprises dynamically adjusting at least one of processing capacity of one or more processing circuitries of the vehicle allocated to AI model execution, memory usage of one or more memories of the vehicle used for sensor fusion or model inference, bandwidth usage of one or more data bus and communication interfaces of the vehicle used by the AI models, or power supply allocation to a sensor suite, an electronic control unit, ECU, or an actuator controlled by the AI-system, based on computing resource data of the AI-system, the computing resource data comprising at least one of available processing power, memory availability, communication bandwidth utilization, real-time AI-system load, or task-specific execution priority.

Another example (e.g., example 44) relates to a previous example (e.g., one of the examples 1 to 43) or to any other example, further comprising that the AI-system with the plurality of AI models is configured to control agents of a smart city, wherein the plurality of AI models comprises at least one of the following a traffic control model, a surveillance model, a fleet coordination model, a public transport optimization model, a drone management model, or a power grid optimization model. 45. The apparatus according to example 44, wherein the shared computing resources comprise at least one of the following resources of the smart city processing capacity of one or more processing circuitries, memory usage of one or more memories of the AI-system used for storing sensor data, fused data, or model parameters, usage of one or more data bus and communication interfaces of the smart city used for transmitting sensor data, control options, or decision data between the AI-system and components of the target system, or power supply of traffic signal unit, a public lighting system, or an environmental monitoring device of the smart city co-located with the AI-system.

Another example (e.g., example 46) relates to a previous example (e.g., one of the examples 43 to 45) or to any other example, further comprising that the execution order of the plurality of control options is determined for the smart city, wherein the control options comprise at least one of traffic signal adaptation by the traffic control model based on real-time vehicle flow data and pedestrian movement patterns, automated drone dispatch by the drone management model based on environmental data, dynamic public transport scheduling by the public transport optimization model based on passenger demand forecasts and/or traffic congestion data, vehicle coordination by the fleet coordination model to optimize routing based on lane usage, and interaction with smart infrastructure, energy distribution adjustment by the power grid optimization model based on electricity demand fluctuations and renewable energy availability.

Another example (e.g., example 47) relates to a previous example (e.g., one of the examples 43 to 46) or to any other example, further comprising that adapting the usage of the shared computing resources for the execution of the plurality of AI models in the smart city comprises dynamically adjusting at least one of processing capacity of one or more processing circuitries, memory usage of one or more memories of the AI-system used for sensor data aggregation or fused data storage, bandwidth usage of one or more data bus and communication interfaces of the smart city used by the AI models for interconnecting infrastructure components, or power supply allocation of a traffic signal unit, a public lighting system, or an environmental monitoring device co-located with the AI-system, based on computing resource data of the AI-system, the computing resource data comprising at least one of available processing power, memory availability, communication bandwidth utilization, real-time AI-system load, or task-specific execution priority.

Another example (e.g., example 48) relates to a previous example (e.g., one of the examples 43 to 47) or to any other example, further comprising that the execution order of smart city control actions is determined by a reinforcement learning model, wherein the reinforcement learning model is configured to adapt at least one of traffic control, public transport scheduling, drone dispatch, or energy allocation based on at least one of historical smart city data, real-time AI-system load, or external environmental conditions.

Another example (e.g., example 49) relates to a previous example (e.g., one of the examples 1 to 48) or to any other example, further comprising that the AI-system with the plurality of AI models is configured to control a medical system, wherein the plurality of AI models comprises at least one of the following a diagnostic model, a patient monitoring model, a medical image processing model, a therapy planning model, a communication model, or a fault detection model.

Another example (e.g., example 50) relates to a previous example (e.g., example 49) or to any other example, further comprising that the shared computing resources comprise at least one of the following resources of the medical system processing capacity of one or more processing circuitries of the medical system, memory usage of one or more memories of the medical system, usage of one or more data bus and communication interfaces of the medical system, or power supply of imaging devices, monitoring equipment, or mobile diagnostic units.

Another example (e.g., example 51) relates to a previous example (e.g., one of the examples 49 to 50) or to any other example, further comprising that the execution order of the plurality of control options is determined for the medical system, wherein the control options comprise at least one of diagnosis suggestion by the diagnostic model based on fused sensor data, anomaly detection by the patient monitoring model based on real-time physiological parameters and computing resource constraints, image enhancement by the medical image processing model based on modality-specific quality indicators, or therapy recommendation by the therapy planning model based on patient status and energy consumption of medical system components.

Another example (e.g., example 52) relates to a previous example (e.g., one of the examples 49 to 51) or to any other example, further comprising that the diagnostic model is configured to identify a medical condition based on fused data from patient monitoring sensors and imaging devices.

Another example (e.g., example 53) relates to a previous example (e.g., one of the examples 49 to 52) or to any other example, further comprising that the patient monitoring model is configured to trigger an emergency protocol if a physiological parameter crosses a threshold and sufficient computing resources for alert processing and communication are available.

Another example (e.g., example 54) relates to a previous example (e.g., one of the examples 49 to 53) or to any other example, further comprising that adapting the usage of the shared computing resources comprises dynamically prioritizing AI models based on at least one of patient risk level, sensor criticality, or task urgency.

Another example (e.g., example 56) relates to a previous example (e.g., one of the examples 49 to 55) or to any other example, further comprising that the execution order of the plurality of control options is determined by a reinforcement learning model configured to optimize medical outcomes over time by adapting prioritization strategies of diagnostic and monitoring actions based on computing resource data, historical patient data, alert statistics, and clinical feedback.

An example (e.g., example 57) relates to a method for controlling a plurality of AI models of an AI-system, comprising receiving at least one of sensor data from one or more sensors or computation data from one or more of the plurality of AI models, wherein the plurality of AI models are operated within the AI-system and at least partially utilize shared computing resources of the AI-system, generating fused data based on at least one of the received sensor data or computation data, providing the fused data to the plurality of AI models, generating a plurality of control options for the AI-system by the plurality of AI models based on the fused data, determining an execution order of the plurality of generated control options based on decision data, and adapting a usage of the shared computing resources for an execution of the plurality of AI models based on received computing resource data of the AI-system.

Another example (e.g., example 58) relates to a non-transitory machine-readable storage medium including program code, when executed, to cause a machine to perform the method of example 57.

An example (e.g., example 59) relates to a device comprising means for processing for receiving at least one of sensor data from one or more sensors or computation data from one or more of the plurality of AI models, wherein the plurality of AI models are operated within the AI-system and at least partially utilize shared computing resources of the AI-system, generating fused data based on at least one of the received sensor data or computation data, providing the fused data to the plurality of AI models, generating a plurality of control options for the AI-system by the plurality of AI models based on the fused data, determining an execution order of the plurality of generated control options based on decision data, and adapting a usage of the shared computing resources for an execution of the plurality of AI models based on received computing resource data of the AI-system.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor-or computer-readable and encode and/or contain machine-executable, processor-executable or computer-executable programs and instructions.

Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for controlling a plurality of AI models of an AI-system, comprising interface circuitry, machine-readable instructions and processing circuitry to execute the machine-readable instructions to:
receive at least one of sensor data from one or more sensors or computation data from one or more of the plurality of AI models, wherein the plurality of AI models are operated within the AI-system and at least partially utilize shared computing resources of the AI-system;
generate fused data based on at least one of the received sensor data or computation data;
provide the fused data to the plurality of AI models;
generate a plurality of control options for the AI-system by the plurality of AI models based on the fused data;
determine an execution order of the plurality of generated control options based on decision data; and
adapt a usage of the shared computing resources for an execution of the plurality of AI models based on received computing resource data of the AI-system.

2. The apparatus according to claim 1, wherein the decision data comprises at least one of the following data: sensor data, computing resource data, historical data from plurality of AI models or predetermined preference data.

3. The apparatus according to claim 1, wherein the shared computing resources comprise at least one of the following resources: processing circuitry capacity of one or more processing circuitries of the AI-system, memory usage of one or more memories of the AI-system, usage of one or more data bus and communication interfaces of the AI-system, or power supply of AI-system components.

4. The apparatus according to claim 1, wherein the sensor data comprises at least one of camera data, LIDAR data, radar signals, or temperature sensor data.

5. The apparatus according to claim 1, wherein the computing resource data comprises at least one of available processing power, current computational load, memory usage, latency, a sampling rate of a sensor of the AI-system, a data processing rate, a sensor utilization rate, or an energy consumption of an AI-system component.

6. The apparatus according to claim 1, wherein determining the execution order of the plurality control options comprises determining a probability of future events based on the decision data.

7. The apparatus according to claim 1, wherein determining the execution order of the plurality of control options comprises determining an expected impact of an execution of at least one control option on the AI-system behavior based on the decision data.

8. The apparatus according to claim 1, wherein the execution order of the plurality control options is determined by a reinforcement learning model and/or a Bayesian network.

9. The apparatus according to claim 1, wherein determining the execution order of the control options further comprises allocating respective computing resources of the AI-system for executing the respective control options of the plurality of AI models.

10. The apparatus according to claim 1, wherein determining the execution order of the control options is performed based on at least one of nature-inspired algorithms, swarm intelligence techniques, evolutionary algorithms or spiking neural networks.

11. The apparatus according to claim 1, wherein generating fused data further comprises weighting the sensor data and/or the computation data based on data quality, data reliability, and/or data relevance.

12. The apparatus according to claim 1, wherein the processing circuitry is further to execute the machine-readable instructions to receive computing resource data;
and analyze the received computing resource data regarding a resource distribution in the AI-system.

13. The apparatus according to claim 1, wherein adapting the usage of the shared computing resources comprises assigning respective values of processing circuitry power, memory, data bandwidth, and/or energy to the respective plurality of AI models.

14. The apparatus according to claim 1, wherein the processing circuitry is further to execute the machine-readable instructions to adapt at least one of a sampling rate of a sensor, an activity status of a sensor, or an energy consumption of an AI-system component based on received computing resource data.

15. The apparatus according to claim 1, wherein adapting the usage of the shared computing resources comprises Quantum-Assisted Optimization, QAO.

16. The apparatus according to claim 1, wherein the AI-system with the plurality of AI models is configured to control a robot, wherein the plurality of AI models comprises at least one of the following: a navigation model, a perception model, a manipulation model, a control optimization model, a reinforcement learning model, a communication model, or a fault detection model.

17. The apparatus according to claim 1, wherein the AI-system with the plurality of AI models is configured to control a vehicle, wherein the plurality of AI models comprises at least one of the following: a navigation model, a perception model, a path planning model, a trajectory control model, a reinforcement learning model, a communication model, or a fault detection model.

18. The apparatus according to claim 1, wherein the AI-system with the plurality of AI models is configured to control agents of a smart city, wherein the plurality of AI models comprises at least one of the following: a traffic control model, a surveillance model, a fleet coordination model, a public transport optimization model, a drone management model, or a power grid optimization model.

19. The apparatus according to claim 1, wherein the AI-system with the plurality of AI models is configured to control a medical system, wherein the plurality of AI models comprises at least one of the following: a diagnostic model, a patient monitoring model, a medical image processing model, a therapy planning model, a communication model, or a fault detection model.

20. A method for controlling a plurality of AI models of an AI-system, comprising:
receiving at least one of sensor data from one or more sensors or computation data from one or more of the plurality of AI models, wherein the plurality of AI models are operated within the AI-system and at least partially utilize shared computing resources of the AI-system;
generating fused data based on at least one of the received sensor data or computation data;
providing the fused data to the plurality of AI models;
generating a plurality of control options for the AI-system by the plurality of AI models based on the fused data;
determining an execution order of the plurality of generated control options based on decision data; and
adapting a usage of the shared computing resources for an execution of the plurality of AI models based on received computing resource data of the AI-system.
